(19) United States
(12) Patent Application Publication
(10) Pub. No.: US 2026/0265510 A1
(43) Pub. Date: Sep. 10, 2026

(54) REACTOR BLEND ETHYLENE POLYMER COMPOSITIONS AND FILMS

(71) Applicant: NOVA Chemicals (International) S.A., Fribourg (CH)

(72) Inventors: Marcelo Yamane, Calgary (CA); Marcia Pires Fortes Ferreira, Calgary (CA); Mehrnaz Rahimi, Calgary (CA); Rosiane Rowlette, Englewood, FL (US)

(73) Assignee: NOVA Chemicals (International) S.A., Fribourg (CH)

(21) Appl. No.: 19/166,609

(22) PCT Filed: Mar. 19, 2024
(86) PCT No.: PCT/IB2024/052654

§ 371 Date: Sep. 18, 2025

Related U.S. Application Data
(60) Provisional application No. 63/491,497, filed on Mar. 21, 2023.

(51) Int. Cl. C08L 23/0807; B32B 27/08; B32B 27/32; C08J 5/18

(52) U.S. Cl. CPC C08L 23/0815; B32B 27/08; B32B 27/32; C08J 5/18; B32B 2307/31; B32B 2307/72; B32B 2553/00; B32B 2581/00; C08J 2323/08; C08J 2423/06; C08J 2423/08; C08L 2203/162; C08L 2205/025; C08L 2205/03; C08L 2314/06

(57) ABSTRACT

Provided herein is a reactor blend ethylene polymer composition comprising at least two identifiable components with distinct structural and compositional characteristics; namely: a first ethylene polymer and a second ethylene interpolymer. The ethylene polymer composition is produced in a continuous solution polymerization process in which the first ethylene polymer is formed in a first solution polymerization reactor by polymerizing ethylene and optionally at least one α-olefin with a first homogenous catalyst formulation; and the second ethylene interpolymer is formed in a second solution polymerization reactor by polymerizing ethylene and at least one α-olefin with a second homogeneous catalyst formulation. The provided ethylene polymer compositions can advantageously be used in applications where easy-opening, mono-material packaging systems are desired.

### TECHNICAL FIELD

The present disclosure provides reactor blend ethylene polymer compositions and films prepared therefrom. The ethylene polymer compositions includes at least two distinguishable ethylene polymer components with defined architectural characteristics.

### BACKGROUND ART

A heat sealable film structure is a mono or multilayer structure which is capable of forming a bond when, in a partially molten state, brought into intimate contact with itself or a substrate (e.g., another film structure or a rigid/semirigid structure). Based on the functional requirements, heat sealing process variables and heat sealable film structures can be designed to yield two types of bonds; namely: lock-up seals and peelable seals.

Lock-up seals are preferred in hermetic sealing applications and peelable seals are preferable in applications involving easy-to-open packaging systems. Commonly known technologies for easy-to-open seals include cohesive peels, adhesive peels and delamination peels. Regardless of the technology employed, heat sealable, easy-to-open film structures incorporate one or more than one non-polyethylene thermoplastic polymer, non-limiting examples of which include polypropylene resins, polybutene-1 resins, ethylene-vinyl acetate copolymers, ethylene-acrylic acid copolymers, ethylene-methyl acrylate copolymers, and ionomers. Multilayered films that contains greater than 10% by weight of non-polyethylene materials are known to pose challenges in polyethylene mechanical recycling processes. Thus, there remains a need for polyethylene compositions for applications where easy-to-open, mono-material packaging systems are desired.

### SUMMARY OF INVENTION

Provided in a first aspect is a reactor blend ethylene polymer composition, comprising from 30 to 70 weight percent of a first ethylene polymer, the first ethylene polymer comprising ethylene and optionally at least one α-olefin, the first ethylene polymer having a weight-average molecular weight M_{w} of from 70 kg/mol to 250 kg/mol, a number of short chain branches per thousand carbon atoms of from 0 to 6, and a polydispersity index M_{w}/Mₙ of from 1.7 to 2.3; and from 30 to 70 weight percent of a second ethylene interpolymer, the second ethylene interpolymer comprising ethylene and at least one α-olefin, the second ethylene interpolymer having a weight-average molecular weight M_{w} of from 20 kg/mol to 75 kg/mol, a number of short chain branches per thousand carbon atoms of from 25 to 55, and a polydispersity index M_{w}/Mₙ of from 1.7 to 2.3; wherein the weight-average molecular weight of the second ethylene interpolymer is less than the weight-average molecular weight of the first ethylene polymer; and wherein the ethylene polymer composition is produced in a continuous solution polymerization process, the continuous solution polymerization process comprising: forming the first ethylene polymer in a first solution polymerization reactor by polymerizing ethylene and optionally at least one α-olefin with a first homogenous catalyst formulation; and forming the second ethylene interpolymer in a second solution polymerization reactor by polymerizing ethylene and at least one α-olefin with a second homogeneous catalyst formulation.

In some embodiments, the ethylene polymer composition has a comonomer distribution profile in a GPC-FTIR analysis, wherein the comonomer distribution profile has a secant slope of greater than or equal to −55 short chain branches per 1000 carbons and less than or equal to −20 short chain branches per 1000 carbons, wherein the secant slope is defined as the number of short chain branches per 1000 carbons at a molecular weight of 300 kg/mol minus the number of short chain branches per 1000 carbons at a molecular weight of 30 kg/mol.

In some embodiments, the comonomer distribution profile is a normal comonomer distribution profile.

In some embodiments, one or both of the first homogenous catalyst formulation and the second homogenous catalyst formulation comprises a bridged metallocene catalyst having the Formula (I):

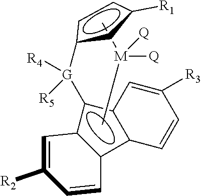

wherein M is a group 4 metal selected from titanium, zirconium or hafnium; G is a group 14 element selected from carbon, silicon, germanium, tin or lead; R₁ is a hydrogen atom, a C₁₋₂₀ hydrocarbyl radical, a C₁₋₂₀ alkoxy radical or a C₆₋₁₀ aryl oxide radical; R₂ and R₃ are independently selected from a hydrogen atom, a C₁₋₂₀ hydrocarbyl radical, a C₁₋₂₀ alkoxy radical or a C₆₋₁₀ aryl oxide radical; R₄ and R₅ are independently selected from a hydrogen atom, an unsubstituted C₁₋₂₀ hydrocarbyl radical, a substituted C₁₋₂₀ hydrocarbyl radical, a C₁₋₂₀ alkoxy radical or a C₆₋₁₀ aryl oxide radical; and Q is independently an activatable leaving group ligand.

In some embodiments, one or both of the first homogenous catalyst and the second homogenous catalyst comprises a phosphinimine catalyst.

In some embodiments, the first ethylene polymer is a first ethylene homopolymer.

In some embodiments, the ethylene polymer composition has a density of from 0.880 g/cm³ to 0.920 g/cm³, as determined according to ASTM D792-13.

In some embodiments, the ethylene polymer composition has a density of from 0.900 g/cm³ to 0.920 g/cm³, as determined according to ASTM D792-13.

In some embodiments, the ethylene polymer composition has a melt index I₂ of from 2 dg/min to 10 dg/min, as determined according to ASTM D1238-13 at 190° C. using a weight of 2.16 kg.

In some embodiments, the ethylene polymer composition has a molecular weight distribution with a polydispersity index M_{w}/Mₙ of from 2.3 to 6.0.

In some embodiments, the ethylene polymer composition has a molecular weight distribution with a polydispersity index M_{w}/Mₙ of from 2.3 to 4.5.

In some embodiments, the ethylene polymer composition has a unimodal molecular weight distribution.

In some embodiments, a ratio of the weight-average molecular weight of the first ethylene polymer and the weight-average molecular weight of the second ethylene interpolymer is greater than or equal to 1.5 and less than or equal to 6.

In some embodiments, a ratio of the weight-average molecular weight of the first ethylene polymer and the weight-average molecular weight of the second ethylene interpolymer is greater than or equal to 2 and less than or equal to 4.

In some embodiments, the ethylene polymer composition contains detectable levels of long-chain branches as characterized according to a long chain branching factor, LCBF, of greater than or equal to 0.001.

In some embodiments, the second ethylene interpolymer is present in the ethylene polymer composition in an amount of from 50 to 65 weight percent.

In some embodiments, the first ethylene polymer is present in the ethylene polymer composition in an amount of from 35 to 50 weight percent.

In some embodiments, the ethylene polymer composition has a number-average molecular weight Mₙ of from 10 kg/mol to 35 kg/mol.

In some embodiments, the ethylene polymer composition has a number-average molecular weight Mₙ of from 15 kg/mol to 30 kg/mol.

In some embodiments, the ethylene polymer composition has a weight-average molecular weight M_{w} of from 65 kg/mol to 100 kg/mol.

In some embodiments, the ethylene polymer composition has a weight-average molecular weight molecular weight M_{w} of from 70 kg/mol to 95 kg/mol.

In some embodiments, the second ethylene interpolymer has a number-average molecular weight of from 10 kg/mol to 38 kg/mol.

In some embodiments, the second ethylene interpolymer has a number-average molecular weight of from 15 kg/mol to 34 kg/mol.

In some embodiments, the second ethylene interpolymer has a weight-average molecular weight of from 30 kg/mol to 65 kg/mol.

In some embodiments, the second ethylene interpolymer has a number of short chain branches per thousand carbon atoms of from 27 to 48.

Ins some embodiments, the first ethylene polymer has a weight-average molecular weight of from 70 kg/mol to 160 kg/mol.

In some embodiments, the first ethylene polymer has a weight-average molecular weight of from 100 kg/mol to 160 kg/mol.

In some embodiments, the ethylene polymer composition has a melt flow ratio I₂₁/I₂ of from 15 to 40, as determined according to ASTM D1238-13 at 190° C. using weights of 2.16 kg and 21.6 kg.

In some embodiments, the ethylene polymer composition further comprises from greater than 0 to 20 weight percent of a third ethylene interpolymer comprising ethylene and at least one α-olefin, the third ethylene interpolymer having a polydispersity index M_{w}/Mₙ of from 1.7 to 2.3 and a weight-average molecular weight less than the weight-average molecular weight of the first ethylene polymer and the weight-average molecular weight of the second ethylene interpolymer.

In some embodiments, the third ethylene interpolymer has a weight-average molecular weight of from 20 kg/mol to 50 kg/mol and a number of short chain branches per 1000 carbon atoms of from 25 to 50.

In some embodiments, the continuous solution polymerization process further comprises a step of forming the third ethylene interpolymer in a third solution polymerization reactor by polymerizing ethylene and at least one α-olefin with a third homogenous catalyst formulation, wherein the first, second and third solution phase polymerization reactors are configured in series with one another.

In some embodiments, the third homogeneous catalyst formulation comprises a bridged metallocene catalyst having the Formula (I):

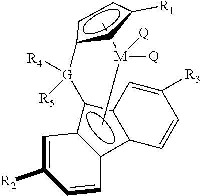

wherein M is a group 4 metal selected from titanium, zirconium or hafnium; G is a group 14 element selected from carbon, silicon, germanium, tin or lead; R₁ is a hydrogen atom, a C₁₋₂₀ hydrocarbyl radical, a C₁₋₂₀ alkoxy radical or a C₆₋₁₀ aryl oxide radical; R₂ and R₃ are independently selected from a hydrogen atom, a C₁₋₂₀ hydrocarbyl radical, a C₁₋₂₀ alkoxy radical or a C₆₋₁₀ aryl oxide radical; R₄ and R₅ are independently selected from a hydrogen atom, an unsubstituted C₁₋₂₀ hydrocarbyl radical, a substituted C₁₋₂₀ hydrocarbyl radical, a C₁₋₂₀ alkoxy radical or a C₆₋₁₀ aryl oxide radical; and Q is independently an activatable leaving group ligand.

In some embodiments, the third homogeneous catalyst comprises a phosphinimine catalyst.

In some embodiments, the at least one α-olefin is selected from the group consisting of C₃ to C₁₀ α-olefins.

In some embodiments, the at least one-olefin is selected from the group consisting of hexene-1, octene-1, and a mixture of hexene-1 and octene-1.

In some embodiments, the at least one-olefin is octene-1.

Provided in a second aspect is an all polyethylene film layer comprising the ethylene polymer composition as defined in the first aspect.

In some embodiments, the film layer is a blown film.

In some embodiments, the film layer is a cast film.

In some embodiments, the film layer further comprises a linear low density polyethylene LLDPE having a density of from 0.910 g/cm³ to 0.940 g/cm³ and a melt index I₂ of from 0.1 to 10 dg/min.

In some embodiments, the film layer comprises from 10 to 40 weight percent of the LLDPE and from 60 to 90 weight percent of the ethylene polymer composition of any one of claims 1-32.

Provided in a third aspect is an all polyethylene multilayer film structure, wherein the film structure has at least one skin layer comprising the ethylene polymer composition as defined in the first aspect.

In some embodiments, the film structure has a sublayer adjacent to the at least one skin layer; the sublayer comprising a high density polyethylene HDPE having a density of at least 0.945 g/cm³ and a melt index I₂ of from 0.1 to 10 dg/min.

In some embodiments, the HDPE is a blend of at least two ethylene homopolymer blend components; the blend comprising: from 30 to 95 weight percent of a first ethylene homopolymer blend component having a density of from 0.950 to 0.975 g/cm³; and from 5 to 70 weight parent of a second ethylene homopolymer blend component having a density of from 0.950 to 0.975 g/cm³; wherein the ratio of the melt index I₂ of the second ethylene homopolymer blend component to the melt index I₂ of the first ethylene homopolymer blend component is at least 10.

In some embodiments, the HDPE comprises from 100 to 3000 parts per million of a nucleating agent or a mixture of nucleating agents.

In some embodiments, the HDPE has a polydispersity index M_{w}/Mₙ of from 7 to 18.

In some embodiments, the at least one skin layer further comprises a linear low density polyethylene LLDPE having a density of from 0.910 g/cm³ to 0.940 g/cm³ and a melt index I₂ of from 0.1 to 10.0 dg/min.

In some embodiments, the at least one skin layer comprises from 10 to 40 weight percent of the LLDPE and from 60 to 90 weight percent of the ethylene polymer composition as defined in the first aspect.

In some embodiments, the film structure comprises at least three layers.

In some embodiments, the film structure comprises between three and nine layers.

In some embodiments, the at least one skin layer is a sealant layer.

In some embodiments, the film structure has a seal initiation temperature of from greater than or equal to 70° C. to 115° C., wherein the seal initiation temperature is the minimum sealing temperature at which the film structure has a seal strength of greater than 3.4 N per 25.4 mm of seal width.

In some embodiments, the film structure has a seal strength of from 3.4 to 15.0 N per 25.4 mm of seal width at a sealing temperature of from SIT to SIT+40° C.

In some embodiments, the film structure has a seal strength of from 3.4 to 15.0 N per 25.4 mm of seal width at a sealing temperature of from SIT to SIT+25° C.

### BRIEF DESCRIPTION OF DRAWINGS

FIG. 1a shows the gel permeation chromatogram with Fourier transform infrared (GPC-FTIR) detection obtained for the ethylene polymer composition made in Example 1. The comonomer content is shown on the secondary y-axis as the number of short chain branches per 1000 carbon atoms as a function of molecular weight.

FIG. 1b shows the melting endotherms obtained during the second heating cycle for Example 1. The dotted line is an imaginary baseline drawn from 20° C. to end of melting.

FIG. 2a shows the gel permeation chromatogram with Fourier transform infrared (GPC-FTIR) detection obtained for the ethylene polymer composition made in Example 2. The comonomer content is shown on the secondary y-axis as the number of short chain branches per 1000 carbon atoms as a function of molecular weight.

FIG. 2b shows the melting endotherms obtained during the second heating cycle for Example 2. The dotted line is an imaginary baseline drawn from 20° C. to end of melting.

FIG. 3a shows the gel permeation chromatogram with Fourier transform infrared (GPC-FTIR) detection obtained for the ethylene polymer composition made in Example 3. The comonomer content is shown on the secondary y-axis as the number of short chain branches per 1000 carbon atoms as a function of molecular weight.

FIG. 3b shows the melting endotherms obtained during the second heating cycle for Example 3. The dotted line is an imaginary baseline drawn from 20° C. to end of melting.

FIG. 4a, FIG. 4b and FIG. 4c illustrate the seal strength of multilayer film structures prepared in Examples 1F-3F and Example 1FB-2FB, and Comparative Examples 1F and 3F-6F as a function of sealing temperature. Dotted horizontal lines represent the upper and lower limits of the seal strength range of from 3.4 to 15 N/25 mm. Error bars indicate the ±standard deviation range for five seal strength measurements at each sealing temperature.

FIG. 5 illustrate the seal strength of multilayer film structures prepared in Examples 4F-6F as a function of sealing temperature. Dotted horizontal lines represent the upper and lower limits of the seal strength range of from 3.4 to 15 N/25 mm. Error bars indicate the =standard deviation range for five seal strength measurements at each sealing temperature.

### DEFINITION OF TERMS

Other than in the examples or where otherwise indicated, all numbers or expressions referring to quantities of ingredients, extrusion conditions, etc., used in the specification and claims are to be understood as modified in all instances by the term “about”. Accordingly, unless indicated to the contrary, the numerical parameters set forth in the following specification and attached claims are approximations that can vary depending upon the desired properties that the various embodiments desire to obtain. At the very least, and not as an attempt to limit the application of the doctrine of equivalents to the scope of the claims, each numerical parameter should at least be construed in light of the number of reported significant digits and by applying ordinary rounding techniques. The numerical values set forth in the specific examples are reported as precisely as possible. Any numerical values, however, inherently contain certain errors necessarily resulting from the standard deviation found in their respective testing measurements.

It should be understood that any numerical range recited herein is intended to include all sub-ranges subsumed therein. For example, a range of “1 to 10” is intended to include all sub-ranges between and including the recited minimum value of 1 and the recited maximum value of 10; that is, having a minimum value equal to or greater than 1 and a maximum value of equal to or less than 10. Because the disclosed numerical ranges are continuous, they include every value between the minimum and maximum values. Unless expressly indicated otherwise, the various numerical ranges specified in this application are approximations.

All compositional ranges expressed herein are limited in total to and do not exceed 100 percent (volume percent or weight percent) in practice. Where multiple components can be present in a composition, the sum of the maximum amounts of each component can exceed 100 percent, with the understanding that, and as those skilled in the art readily understand, that the amounts of the components actually used will conform to the maximum of 100 percent.

In order to form a more complete understanding of this disclosure the following terms are defined and should be used with the accompanying figures and the description of the various embodiments throughout.

As used herein, the term “monomer” refers to a small molecule that may chemically react and become chemically bonded with itself or other monomers to form a polymer. As used herein, the term “α-olefin” or “alpha-olefin” is used to describe a monomer having a linear hydrocarbon chain having a double bond at one end of the chain and containing from n=3 to 20 carbon atoms with a chemical formula CₙH₂ₙ; an equivalent term is “linear α-olefin”.

As used herein, the terms “polyethylene”, “polyethylene polymer” or “ethylene polymer”, refers to macromolecules produced from ethylene monomer and optionally at least one α-olefin monomer; regardless of the specific catalyst or specific process used to make the ethylene polymer. An ethylene polymer in its polymerized form will include greater than 50 weight percent (based on the weight of the ethylene polymer) of ethylene monomeric units. Common polyethylenes include high density polyethylene (HDPE), medium density polyethylene (MDPE), linear low density polyethylene (LLDPE), very low density polyethylene (VLDPE), ultralow density polyethylene (ULDPE), plastomer and elastomers. The term polyethylene also includes combinations of, or blends of, the polyethylenes described above.

As used herein, the term “ethylene homopolymer” refers to a subset of polymers within the “ethylene polymer” group that are produced using only ethylene as a polymerizable monomer.

The term “ethylene interpolymer” refers to a subset of polymers within the “ethylene polymer” group that are produced from ethylene and at least one α-olefin. Thus, as used herein, the term “ethylene interpolymer” includes ethylene polymers prepared from two polymerizable monomeric units (i.e., ethylene and one α-olefin) and ethylene polymers prepared from more than two polymerizable monomeric units (i.e., ethylene and two or more than two α-olefins).

The term “heterogeneously branched ethylene interpolymer” refers to a subset of ethylene interpolymers that are produced using a heterogeneous catalyst system; non-limiting examples of which include Ziegler-Natta or chromium catalysts, both of which are well known in the art.

The term “homogeneously branched ethylene interpolymer” refers to a subset of ethylene interpolymers group that are produced using single-site catalysts; non-limiting examples of which include metallocene catalysts, phosphinimine catalysts, and constrained geometry catalysts all of which are well known in the art.

Typically, homogeneously branched ethylene interpolymers have narrow molecular weight distributions, for example gel permeation chromatography (GPC) M_{w}/Mₙ values of less than about 2.8, especially less than about 2.3, although exceptions may arise; M_{w} and Mₙ refer to weight and number average molecular weights, respectively. In contrast, the M_{w}/Mₙ of heterogeneously branched ethylene interpolymers are typically greater than the M_{w}/Mₙ of homogeneously branched ethylene interpolymers. In general, homogeneously branched ethylene interpolymers also have a narrow composition distribution, i.e., each macromolecule within the molecular weight distribution has a similar α-olefinic comonomer content.

A blend of two or more homogeneously branched ethylene interpolymers, that differ in weight average molecular weight (M_{w}), may have a M_{w}/Mₙ of greater than or equal to 2.8; in this disclosure such a blend was defined as a homogeneous blend or homogeneous composition.

The term “thermoplastic polymer” refers to a polymer that becomes liquid when heated, will flow under pressure and solidify when cooled. Thermoplastic polymers include ethylene polymers as well as other polymers used in the plastic industry; non-limiting examples of other polymers commonly used in film applications include barrier resins (e.g., EVOH), tie resins, polyethylene terephthalate (PET), polyamides, ethylene-vinyl acetate copolymers (EVA) and the like.

As used herein the term “monolayer film” refers to a film containing a single layer of one or more than one thermoplastic polymer.

As used herein the term “multilayer film” or “multilayer film structure” refers to a film composed of more than one thermoplastic layer, or optionally non-thermoplastic layers. Non-limiting examples of non-thermoplastic materials include metals (foil) or cellulosic (paper) products. One or more of the thermoplastic layers within a multilayer film (or film structure) may be comprised of more than one thermoplastic.

As used herein, the term “all polyethylene film layer” refers to a monolayer film containing greater than or equal to 90% of one or more than one ethylene polymer based on the total weight of the film layer.

As used herein, the term “all polyethylene multilayer film structure” refers to a multilayer film structure containing greater than or equal to 90% of one or more than one ethylene polymer based on the total weight of the multilayer film structure excluding the non-thermoplastic layers (if present).

As used herein, the term “tie resin” refers to a thermoplastic that when formed into an intermediate layer, or a “tie layer” within a multilayer film structure, promotes adhesion between adjacent film layers that are dissimilar in chemical composition.

As used herein, the term “sealant layer” refers to a layer of thermoplastic film that is capable of being attached to a second substrate, forming a leak proof seal. A “sealant layer” may be a skin layer or the innermost layer in a multilayer film structure. As used herein, the term “adhesive lamination” and the term “extrusion lamination” describes continuous processes through which two or more substrates, or webs of material, are combined to form a multilayer product or sheet; wherein the two or more webs are joined using an adhesive or a molten thermoplastic film, respectively.

As used herein, the term “extrusion coating” describes a continuous process through which a molten thermoplastic layer is combined with, or deposited on, a moving solid web or substrate. Non-limiting examples of substrates include paper, paperboard, foil, monolayer plastic film, multilayer plastic film or fabric. The molten thermoplastic layer could be monolayer or multilayer.

As used herein, the terms “hydrocarbyl”, “hydrocarbyl radical” or “hydrocarbyl group” refers to linear or cyclic, aliphatic, olefinic, acetylenic and aryl (aromatic) radicals comprising hydrogen and carbon that are deficient by one hydrogen.

As used herein, an “alkyl radical” includes linear, branched and cyclic paraffin radicals that are deficient by one hydrogen radical; non-limiting examples include methyl (—CH₃) and ethyl (—CH₂CH₃) radicals. The term “alkenyl radical” refers to linear, branched and cyclic hydrocarbons containing at least one carbon-carbon double bond that is deficient by one hydrogen radical.

As used herein, the term “aryl” group includes phenyl, naphthyl, pyridyl and other radicals whose molecules have an aromatic ring structure; non-limiting examples include naphthylene, phenanthrene and anthracene. An “arylalkyl” group is an alkyl group having an aryl group pendant there from; non-limiting examples include benzyl, phenethyl and tolylmethyl; an “alkylaryl” is an aryl group having one or more alkyl groups pendant there from; non-limiting examples include tolyl, xylyl, mesityl and cumyl.

As used herein, the phrase “heteroatom” includes any atom other than carbon and hydrogen that can be bound to carbon. A “heteroatom-containing group” is a hydrocarbon radical that contains a heteroatom and may contain one or more of the same or different heteroatoms. In one embodiment, a heteroatom-containing group is a hydrocarbyl group containing from 1 to 3 atoms selected from the group consisting of boron, aluminum, silicon, germanium, nitrogen, phosphorous, oxygen and sulfur. Non-limiting examples of heteroatom-containing groups include radicals of imines, amines, oxides, phosphines, ethers, ketones, oxoazolines heterocyclics, oxazolines, thioethers, and the like. The term “heterocyclic” refers to ring systems having a carbon backbone that comprise from 1 to 3 atoms selected from the group consisting of boron, aluminum, silicon, germanium, nitrogen, phosphorous, oxygen and sulfur.

As used herein the term “unsubstituted” means that hydrogen radicals are bounded to the molecular group that follows the term unsubstituted. The term “substituted” means that the group following this term possesses one or more moieties (non-hydrogen radicals) that have replaced one or more hydrogen radicals in any position within the group; non-limiting examples of moieties include halogen radicals (F, Cl, Br), hydroxyl groups, carbonyl groups, carboxyl groups, silyl groups, amine groups, phosphine groups, alkoxy groups, phenyl groups, naphthyl groups, C₁ to C₃₀ alkyl groups, C₂ to C₃₀ alkenyl groups, and combinations thereof. Non-limiting examples of substituted alkyls and aryls include: acyl radicals, alkyl silyl radicals, alkylamino radicals, alkoxy radicals, aryloxy radicals, alkylthio radicals, dialkylamino radicals, alkoxycarbonyl radicals, aryloxycarbonyl radicals, carbomoyl radicals, alkyl- and dialkyl-carbamoyl radicals, acyloxy radicals, acylamino radicals, arylamino radicals and combinations thereof.

### DESCRIPTION OF EMBODIMENTS

In the present disclosure, a reactor blend ethylene polymer composition will comprise at least two identifiable components; namely: a first ethylene polymer which has a defined weight-average molecular weight M_{w}, a defined short chain branching content and a defined polydispersity index M_{w}/Mₙ; and a second ethylene interpolymer which has a defined weight-average molecular weight M_{w}, a defined short chain branching content and a defined polydispersity index M_{w}/Mₙ. In some embodiments, the ethylene polymer composition further includes a third ethylene interpolymer.

The first ethylene polymer, the second ethylene interpolymer and the optional third ethylene interpolymer are identifiable using known fractionation techniques (e.g., thermal fractionation) and/or using deconvolution through reaction simulation. Each of the first ethylene polymer, the second ethylene interpolymer and the optional third ethylene interpolymer and the ethylene polymer composition of which they are a part are further described below.

### First Ethylene Polymer

The first ethylene polymer comprises ethylene and optionally at least one α-olefin. In embodiments of the disclosure, the optional at least one α-olefin which may be polymerized with ethylene to make the first ethylene polymer may be selected from the group comprising propene-1, butene-1, pentene-1, hexene-1 and octene-1 and mixtures thereof.

In an embodiment of the disclosure, the first ethylene polymer is a first ethylene homopolymer.

In an embodiment of the disclosure, the first ethylene polymer is a first ethylene interpolymer.

In an embodiment of the disclosure, the first ethylene polymer is a first ethylene/octene-1 interpolymer.

In an embodiment of the disclosure, the first ethylene interpolymer is a first homogeneously branched ethylene interpolymer.

In an embodiment of the disclosure, the first ethylene polymer is made with a first homogeneous catalyst, non-limiting examples of which include phosphinimine catalysts and bridged metallocene catalysts, all of which are well known in the art.

In an embodiment of the disclosure, the first ethylene polymer is made with a first homogeneous catalyst, having hafnium, Hf, as the active metal center (i.e., the catalyst is a hafnocene catalyst).

In an embodiment of the disclosure, the first ethylene polymer is made with a bridged metallocene catalyst.

In an embodiment of the disclosure, the first ethylene polymer is made with a bridged metallocene catalyst having the Formula (I):

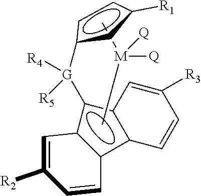

In Formula (I): M is a group 4 metal selected from titanium, zirconium or hafnium; G is a group 14 element selected from carbon, silicon, germanium, tin or lead; R₁ is a hydrogen atom, a C₁₋₂₀ hydrocarbyl radical, a C₁₋₂₀ alkoxy radical or a C₆₋₁₀ aryl oxide radical; R₂ and R₃ are independently selected from a hydrogen atom, a C₁₋₂₀ hydrocarbyl radical, a C₁₋₂₀ alkoxy radical or a C₆₋₁₀ aryl oxide radical; R₄ and R₅ are independently selected from a hydrogen atom, an unsubstituted C₁₋₂₀ hydrocarbyl radical, a substituted C₁₋₂₀ hydrocarbyl radical, a C₁₋₂₀ alkoxy radical or a C₆₋₁₀ aryl oxide radical; and Q is independently an activatable leaving group ligand.

In an embodiment, R₄ and R₅ are independently an aryl group.

In an embodiment, R₄ and R₅ are independently a phenyl group or a substituted phenyl group.

In an embodiment, R₄ and R₅ are a phenyl group.

In an embodiment, R₄ and R₅ are independently a substituted phenyl group.

In an embodiment, R₄ and R₅ are a substituted phenyl group, wherein the phenyl group is substituted with a substituted silyl group.

In an embodiment, R₄ and R₅ are a substituted phenyl group, wherein the phenyl group is substituted with a trialkyl silyl group.

In an embodiment, R₄ and R₅ are a substituted phenyl group, wherein the phenyl group is substituted at the para position with a trialkylsilyl group. In an embodiment, R₁ and R₂ are a substituted phenyl group, wherein the phenyl group is substituted at the para position with a trimethylsilyl group. In an embodiment, R₁ and R₂ are a substituted phenyl group, wherein the phenyl group is substituted at the para position with a triethylsilyl group.

In an embodiment, R₄ and R₅ are independently an alkyl group.

In an embodiment, R₄ and R₅ are independently an alkenyl group.

In an embodiment, R₁ is hydrogen.

In an embodiment, R₁ is an alkyl group.

In an embodiment, R₁ is an aryl group.

In an embodiment, R₁ is an alkenyl group.

In an embodiment, R₂ and R₃ are independently a hydrocarbyl group having from 1 to 30 carbon atoms.

In an embodiment, R₂ and R₃ are independently an aryl group.

In an embodiment, R₂ and R₃ are independently an alkyl group.

In an embodiment, R₂ and R₃ are independently an alkyl group having from 1 to 20 carbon atoms.

In an embodiment, R₂ and R₃ are independently a phenyl group or a substituted phenyl group.

In an embodiment, R₂ and R₃ are a tert-butyl group.

In an embodiment, R₂ and R₃ are hydrogen.

In an embodiment, M is hafnium, Hf.

In an embodiment of the disclosure, the first ethylene polymer is made with a bridged metallocene catalyst having the Formula (Ia):

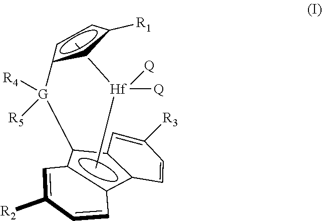

In Formula (Ia): G is a group 14 element selected from carbon, silicon, germanium, tin or lead; R₁ is a hydrogen atom, a C₁₋₂₀ hydrocarbyl radical, a C₁₋₂₀ alkoxy radical or a C₆₋₁₀ aryl oxide radical; R₂ and R₃ are independently selected from a hydrogen atom, a C₁₋₂₀ hydrocarbyl radical, a C₁₋₂₀ alkoxy radical or a C₆₋₁₀ aryl oxide radical; R₄ and R₅ are independently selected from a hydrogen atom, an unsubstituted C₁₋₂₀ hydrocarbyl radical, a substituted C₁₋₂₀ hydrocarbyl radical, a C₁₋₂₀ alkoxy radical or a C₆₋₁₀ aryl oxide radical; and Q is independently an activatable leaving group ligand.

In the current disclosure, the term “activatable”, means that the ligand Q may be cleaved from the metal center M via a protonolysis reaction or abstracted from the metal center M by suitable acidic or electrophilic catalyst activator compounds (also known as “co-catalyst” compounds) respectively, examples of which are described below. The activatable ligand Q may also be transformed into another ligand which is cleaved or abstracted from the metal center M (e.g., a halide may be converted to an alkyl group). Without wishing to be bound by any single theory, protonolysis or abstraction reactions generate an active “cationic” metal center which can polymerize olefins.

In embodiments of the present disclosure, the activatable ligand, Q is independently selected from the group consisting of a hydrogen atom; a halogen atom; a C₁₋₂₀ hydrocarbyl radical, a C₁₋₂₀ alkoxy radical, and a C₆₋₁₀ aryl or aryloxy radical, where each of the hydrocarbyl, alkoxy, aryl, or aryl oxide radicals may be un-substituted or further substituted by one or more halogen or other group; a C₁₋₈ alkyl; a C₁₋₈ alkoxy; a C₆₋₁₀ aryl or aryloxy; an amido or a phosphido radical, but where Q is not a cyclopentadienyl. Two Q ligands may also be joined to one another and form for example, a substituted or unsubstituted diene ligand (e.g., 1,3-butadiene); or a delocalized heteroatom containing group such as an acetate or acetamidinate group. In a convenient embodiment of the disclosure, each Q is independently selected from the group consisting of a halide atom, a C₁₋₄ alkyl radical and a benzyl radical. Particularly suitable activatable ligands Q are monoanionic such as a halide (e.g., chloride) or a hydrocarbyl (e.g., methyl, benzyl).

In an embodiment of the disclosure, the first homogeneous catalyst used to make the first ethylene polymer is diphenylmethylene(cyclopentadienyl)(2,7-di-t-butylfluorenyl)hafnium dichloride having the molecular formula:

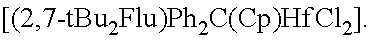

In an embodiment of the disclosure the first homogenous catalyst used to make the first ethylene polymer is diphenylmethylene(cyclopentadienyl)(2,7-di-t-butylfluorenyl)hafnium dimethyl having the molecular formula:

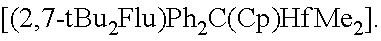

In an embodiment of the disclosure, the first homogeneous catalyst is a phosphinimine catalyst represented by formula (II):

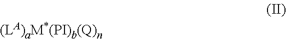

wherein (L^{A}) represents a bulky ligand; M* represents a metal atom; PI represents a phosphinimine ligand; Q is independently an activatable leaving group ligand; a is 0 or 1; bis 1 or 2; (a+b)=2; n is 1 or 2; and the sum of (a+b+n) equals the valance of the metal M*.

In an embodiment of the disclosure, L^{A} is selected from the group consisting of unsubstituted cyclopentadienyl, substituted cyclopentadienyl, unsubstituted indenyl, substituted indenyl, unsubstituted fluorenyl and substituted fluorenyl.

In an embodiment of the disclosure, M* is a metal selected from the group consisting of titanium, hafnium and zirconium.

In further non-limiting embodiments of the disclosure, the bulky ligand L^{A} in formula (II) includes unsubstituted or substituted cyclopentadienyl ligands or cyclopentadienyl-type ligands, heteroatom substituted and/or heteroatom containing cyclopentadienyl-type ligands. In additional non-limiting embodiments, the bulky ligand L^{A} in formula (II) includes cyclopentaphenanthreneyl ligands, unsubstituted or substituted indenyl ligands, benzindenyl ligands, unsubstituted or substituted fluorenyl ligands, octahydrofluorenyl ligands, cyclooctatetraendiyl ligands, cyclopentacyclododecene ligands, azenyl ligands, azulene ligands, pentalene ligands, phosphoyl ligands, phosphinimine, pyrrolyl ligands, pyrozolyl ligands, carbazolyl ligands, borabenzene ligands and the like, including hydrogenated versions thereof, for example tetrahydroindenyl ligands. In other embodiments, L^{A} may be any other ligand structure capable of η-bonding to the metal M*, such embodiments include both η³-bonding and η⁵-bonding to the metal M*. In other embodiments, L^{A} may comprise one or more heteroatoms, for example, nitrogen, silicon, boron, germanium, sulfur and phosphorous, in combination with carbon atoms to form an open, acyclic, or a fused ring, or ring system, for example, a heterocyclopentadienyl ancillary ligand. Other non-limiting embodiments for L^{A} include bulky amides, phosphides, alkoxides, aryloxides, imides, carbolides, borollides, porphyrins, phthalocyanines, corrins and other polyazomacrocycles.

In an embodiment of the disclosure, the metal M* is titanium, Ti.

The phosphinimine ligand, PI, is defined by formula (III):

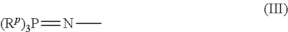

wherein the R^{p} groups are independently selected from: a hydrogen atom; a halogen atom; C₁₋₂₀ hydrocarbyl radicals which are unsubstituted or substituted with one or more halogen atom(s); a C₁₋₈ alkoxy radical; a C₆₋₁₀ aryl radical; a C₆₋₁₀ aryloxy radical; an amido radical; a silyl radical of formula —Si(R^{s})₃, wherein the R^{s} groups are independently selected from, a hydrogen atom, a C₁₋₈ alkyl or alkoxy radical, a C₆₋₁₀ aryl radical, a C₆₋₁₀ aryloxy radical, or a germanyl radical of formula —Ge(R^{G})₃, wherein the R^{G} groups are defined as R^{s} is defined in this paragraph.

In addition to the first homogeneous catalyst molecule per se, an active homogeneous catalyst system may further comprise one or more of the following: an alkylaluminoxane co-catalyst and an ionic activator. The homogenous catalyst system may also optionally comprise a hindered phenol.

Although the exact structure of alkylaluminoxane is uncertain, subject matter experts generally agree that it is an oligomeric species that contain repeating units of the general formula:

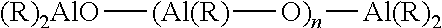

where the R groups may be the same or different linear, branched or cyclic hydrocarbyl radicals containing 1 to 20 carbon atoms and n is from 0 to about 50. A non-limiting example of an alkylaluminoxane is methylaluminoxane (or MAO) wherein each R group is a methyl radical.

In an embodiment of the disclosure, R of the alkylaluminoxane, is a methyl radical and m is from 10 to 40.

In an embodiment of the disclosure, the co-catalyst is modified methylaluminoxane (MMAO).

It is well known in the art, that the alkylaluminoxane can serve dual roles as both an alkylator and an activator. Hence, an alkylaluminoxane co-catalyst is often used in combination with activatable ligands such as halogens.

In general, ionic activators are comprised of a cation and a bulky anion; wherein the latter is substantially non-coordinating. Non-limiting examples of ionic activators are boron ionic activators that are four coordinate with four ligands bonded to the boron atom. Non-limiting examples of boron ionic activators include the following formulas shown below:

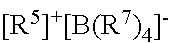

where B represents a boron atom, R₅ is an aromatic hydrocarbyl (e.g., triphenyl methyl cation) and each R₇ is independently selected from phenyl radicals which are unsubstituted or substituted with from 3 to 5 substituents selected from fluorine atoms, C₁₋₄ alkyl or alkoxy radicals which are unsubstituted or substituted by fluorine atoms; and a silyl radical of formula —Si(R₉)₃, where each R₉ is independently selected from hydrogen atoms and C₁₋₄ alkyl radicals, and

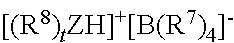

where B is a boron atom, H is a hydrogen atom, Z is a nitrogen or phosphorus atom, t is 2 or 3 and R₈ is selected from C₁₋₈ alkyl radicals, phenyl radicals which are unsubstituted or substituted by up to three C₁₋₄ alkyl radicals, or one R₈ taken together with the nitrogen atom may form an anilinium radical and R₇ is as defined above.

In both formula, a non-limiting example of R₇ is a pentafluorophenyl radical. In general, boron ionic activators may be described as salts of tetra(perfluorophenyl)boron; non-limiting examples include anilinium, carbonium, oxonium, phosphonium and sulfonium salts of tetra(perfluorophenyl)boron with anilinium and trityl (or triphenylmethylium). Additional non-limiting examples of ionic activators include: triethylammonium tetra(phenyl)boron, tripropylammonium tetra(phenyl)boron, tri(n-butyl)ammonium tetra(phenyl)boron, trimethylammonium tetra(p-tolyl)boron, trimethylammonium tetra(o-tolyl)boron, tributylammonium tetra(pentafluorophenyl)boron, tripropylammonium tetra(o,p-dimethylphenyl)boron, tributylammonium tetra(m,m-dimethylphenyl)boron, tributylammonium tetra(p-trifluoromethylphenyl)boron, tributylammonium tetra(pentafluorophenyl)boron, tri(n-butyl)ammonium tetra(o-tolyl)boron, N,N-dimethylanilinium tetra(phenyl)boron, N,N-diethylanilinium tetra(phenyl)boron, N,N-diethylanilinium tetra(phenyl) n-butylboron, N,N-2,4,6-pentamethylanilinium tetra(phenyl)boron, di-(isopropyl) ammonium tetra(pentafluorophenyl)boron, dicyclohexylammonium tetra(phenyl)boron, triphenylphosphonium tetra(phenyl)boron, tri(methylphenyl)phosphonium tetra(phenyl)boron, tri(dimethylphenyl)phosphonium tetra(phenyl)boron, tropillium tetrakispentafluorophenyl borate, triphenylmethylium tetrakispentafluorophenyl borate, benzene(diazonium)tetrakispentafluorophenyl borate, tropillium tetrakis(2,3,5,6-tetrafluorophenyl)borate, triphenylmethylium tetrakis(2,3,5,6-tetrafluorophenyl)borate, benzene(diazonium) tetrakis(3,4,5-trifluorophenyl)borate, tropillium tetrakis(3,4,5-trifluorophenyl)borate, benzene(diazonium) tetrakis(3,4,5-trifluorophenyl)borate, tropillium tetrakis(1,2,2-trifluoroethenyl)borate, triphenylmethylium tetrakis(1,2,2-trifluoroethenyl)borate, benzene(diazonium) tetrakis(1,2,2-trifluoroethenyl)borate, tropillium tetrakis(2,3,4,5-tetrafluorophenyl)borate, triphenylmethylium tetrakis(2,3,4,5-tetrafluorophenyl)borate, and benzene(diazonium) tetrakis(2,3,4,5 tetrafluorophenyl)borate. Readily available commercial ionic activators include N,N-dimethylanilinium tetrakispentafluorophenyl borate, and triphenylmethylium tetrakispentafluorophenyl borate.

Non-limiting example of hindered phenols include butylated phenolic antioxidants, butylated hydroxytoluene, 2,6-di-tertiarybutyl-4-ethyl phenol, 4,4′-methylenebis(2,6-di-tertiary-butylphenol), 1,3, 5-trimethyl-2,4,6-tris(3,5-di-tert-butyl-4-hydroxybenzyl)benzene and octadecyl-3-(3′,5′-di-tert-butyl-4′-hydroxyphenyl) propionate.

To produce an active homogeneous catalyst system the quantity and mole ratios of the three or four components: the first homogenous catalyst, the alkylaluminoxane, the ionic activator, and the optional hindered phenol are optimized.

In an embodiment of the disclosure, the first homogeneous catalyst used to make the first ethylene polymer produces no long chain branches, and/or the first ethylene polymer will contain no measurable amounts of long chain branches.

In an embodiment of the disclosure, the first homogeneous catalyst used to make the first ethylene polymer produces long chain branches, and the first ethylene polymer will contain long chain branches, hereinafter “LCB”. LCB is a well-known structural phenomenon in ethylene polymers and well known to those of ordinary skill in the art.

In an embodiment of the disclosure, the first ethylene polymer contains long chain branching characterized by the LCBF disclosed herein. In embodiments of the disclosure, the upper limit on the LCBF of the first ethylene polymer may be about 0.5, in other cases about 0.4 and in still other cases about 0.3 (dimensionless). In embodiments of the disclosure, the lower limit on the LCBF of the first ethylene polymer may be about 0.001, in other cases about 0.0015 and in still other cases about 0.002 (dimensionless).

In some embodiments of the disclosure, the upper limit of the molecular weight distribution (M_{w}/Mₙ) of the first ethylene polymer is about 2.3, or about 2.2, or about 2.1, or about 2.0. In some embodiments of the disclosure, the lower limit of the molecular weight distribution (M_{w}/Mₙ) of the first ethylene polymer is about 1.7, or about 1.8, or about 1.9.

In some embodiments of the disclosure, the first ethylene polymer has a molecular weight distribution (M_{w}/Mₙ) of ≤2.3, or <2.3, or ≤2.2, or <2.2, or ≤2.1, or <2.1. In some embodiments of the disclosure, the first ethylene polymer has a molecular weight distribution (M_{w}/Mₙ) of from about 1.7 to about 2.3, or from about 1.8 to about 2.3, or from about 1.8 to about 2.2.

In an embodiment, the first ethylene polymer has a number of short chain branches per thousand carbon atoms of from 0 to 10. In further embodiments, the first ethylene polymer has from greater than (>) 0 to 10 short chain branches per thousand carbon atoms, or from 0 to 6 short chain branches per thousand carbon atoms, or greater than (>) 0 to 6 short chain branches per thousand carbon atoms, or from 0 to 5 short chain branches per thousand carbon atoms, or from greater than (>) 0 to 5 short chain branches per thousand carbon atoms, or from 0.005 to 6 short chain branches per thousand carbon atoms. In still further embodiments, the first ethylene polymer has from 0.01 to 6 short chain branches per thousand carbon atoms, or from 0.1 to 6 short chain branches per thousand carbon atoms, or from 0.5 to 6 short chain branches per thousand carbon atoms.

In some embodiments, the first ethylene polymer contains 0 short chain branches per thousand carbon atoms.

The short chain branching (i.e., the short chain branching per thousand carbon atoms) is the branching due to the presence of the optional at least one α-olefin in the first ethylene polymer and, if present, will for example have two carbon atoms for butene-1, or four carbon atoms for a hexene-1, or six carbon atoms for a octene-1, etc.

In an embodiment of the disclosure, the first ethylene polymer has a weight average molecular weight, M_{w} of from 70 kg/mol to 250 kg/mol, or from 70 kg/mol to 200 kg/mol, or from 70 kg/mol to 180 kg/mol, or from 70 kg/mol to 160 kg/mol, or from 75 kg/mol to 160 kg/mol, or from 80 kg/mol to 160 kg/mol, or from 85 kg/mol to 160 kg/mol, or from 90 kg/mol to 160 kg/mol, or from 100 kg/mol to 160 kg/mol.

In some embodiments of the disclosure, the upper limit on the weight percent of the first ethylene polymer in the ethylene polymer composition (i.e., the weight percent of the first ethylene polymer based on the total weight of the ethylene polymer composition) is about 70 weight percent, or about 65 weight percent, or about 60 weight percent, or about 55 weight percent, or about 52 weight percent, or about 50 weight percent. In some embodiments of the disclosure, the lower limit on the weight percent of the first ethylene polymer in the ethylene polymer composition is about 30 weight percent, or about 35 weight percent, or about 40 weight percent, or about 45 weight percent, or about 50 percent. In an embodiment, the first ethylene polymer is present in the ethylene polymer composition in an amount from 30 to 70 weight percent. In another embodiment, the ethylene homopolymer is present in the ethylene polymer composition in an amount from to 60 weight percent. In yet another embodiment, the ethylene homopolymer is present in the ethylene polymer composition in an amount from 35 to 50 weight percent.

### Second Ethylene Interpolymer

The second ethylene interpolymer comprises ethylene and at least one α-olefin. In embodiments of the disclosure, the at least one α-olefin which may be polymerized with ethylene to make the second ethylene interpolymer may be selected from the group comprising propene-1, butene-1, pentene-1, hexene-1 and octene-1 and mixtures thereof.

In an embodiment of the disclosure, the second ethylene interpolymer is a second ethylene interpolymer.

In an embodiment of the disclosure, the second ethylene interpolymer is a second ethylene/octene-1 interpolymer.

In an embodiment of the disclosure, the second ethylene interpolymer is a second homogeneously branched ethylene interpolymer.

In an embodiment of the disclosure, the second ethylene interpolymer is made with a second homogeneous catalyst, non-limiting examples of which include phosphinimine catalysts and bridged metallocene catalysts, all of which are well known in the art.

In an embodiment of the disclosure, the second ethylene interpolymer is made with a second homogeneous catalyst, having hafnium, Hf, as the active metal center (i.e., the catalyst is a hafnocene catalyst).

In an embodiment of the disclosure, the second ethylene interpolymer is made with a bridged metallocene catalyst.

In an embodiment of the disclosure, the second ethylene interpolymer is made with a bridged metallocene catalyst having the Formula (I):

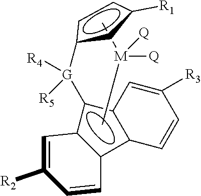

In Formula (I): M is a group 4 metal selected from titanium, zirconium or hafnium; G is a group 14 element selected from carbon, silicon, germanium, tin or lead; R₁ is a hydrogen atom, a C₁₋₂₀ hydrocarbyl radical, a C₁₋₂₀ alkoxy radical or a C₆₋₁₀ aryl oxide radical; R₂ and R₃ are independently selected from a hydrogen atom, a C₁₋₂₀ hydrocarbyl radical, a C₁₋₂₀ alkoxy radical or a C₆₋₁₀ aryl oxide radical; R₄ and R₅ are independently selected from a hydrogen atom, an unsubstituted C₁₋₂₀ hydrocarbyl radical, a substituted C₁₋₂₀ hydrocarbyl radical, a C₁₋₂₀ alkoxy radical or a C₆₋₁₀ aryl oxide radical; and Q is independently an activatable leaving group ligand.

In an embodiment, R₄ and R₅ are independently an aryl group.

In an embodiment, R₄ and R₅ are independently a phenyl group or a substituted phenyl group.

In an embodiment, R₄ and R₅ are a phenyl group.

In an embodiment, R₄ and R₅ are independently a substituted phenyl group.

In an embodiment, R₄ and R₅ are a substituted phenyl group, wherein the phenyl group is substituted with a substituted silyl group.

In an embodiment, R₄ and R₅ are a substituted phenyl group, wherein the phenyl group is substituted with a trialkyl silyl group.

In an embodiment, R₄ and R₅ are a substituted phenyl group, wherein the phenyl group is substituted at the para position with a trialkylsilyl group. In an embodiment, R₁ and R₂ are a substituted phenyl group, wherein the phenyl group is substituted at the para position with a trimethylsilyl group. In an embodiment, R₁ and R₂ are a substituted phenyl group, wherein the phenyl group is substituted at the para position with a triethylsilyl group.

In an embodiment, R₄ and R₅ are independently an alkyl group.

In an embodiment, R₄ and R₅ are independently an alkenyl group.

In an embodiment, R₁ is hydrogen.

In an embodiment, R₁ is an alkyl group.

In an embodiment, R₁ is an aryl group.

In an embodiment, R₁ is an alkenyl group.

In an embodiment, R₂ and R₃ are independently a hydrocarbyl group having from 1 to 30 carbon atoms.

In an embodiment, R₂ and R₃ are independently an aryl group.

In an embodiment, R₂ and R₃ are independently an alkyl group.

In an embodiment, R₂ and R₃ are independently an alkyl group having from 1 to 20 carbon atoms.

In an embodiment, R₂ and R₃ are independently a phenyl group or a substituted phenyl group.

In an embodiment, R₂ and R₃ are a tert-butyl group.

In an embodiment, R₂ and R₃ are hydrogen.

In an embodiment, M is hafnium, Hf.

In an embodiment of the disclosure, the second ethylene interpolymer is made with a bridged metallocene catalyst having the Formula (Ia):

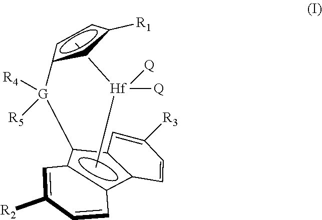

In Formula (Ia): G is a group 14 element selected from carbon, silicon, germanium, tin or lead; R₁ is a hydrogen atom, a C₁₋₂₀ hydrocarbyl radical, a C₁₋₂₀ alkoxy radical or a C₆₋₁₀ aryl oxide radical; R₂ and R₃ are independently selected from a hydrogen atom, a C₁₋₂₀hydrocarbyl radical, a C₁₋₂₀ alkoxy radical or a C₆₋₁₀ aryl oxide radical; R₄ and R₅ are independently selected from a hydrogen atom, an unsubstituted C₁₋₂₀ hydrocarbyl radical, a substituted C₁₋₂₀ hydrocarbyl radical, a C₁₋₂₀ alkoxy radical or a C₆₋₁₀ aryl oxide radical; and Q is independently an activatable leaving group ligand.

In the current disclosure, the term “activatable”, means that the ligand Q may be cleaved from the metal center M via a protonolysis reaction or abstracted from the metal center M by suitable acidic or electrophilic catalyst activator compounds (also known as “co-catalyst” compounds) respectively, examples of which are described below. The activatable ligand Q may also be transformed into another ligand which is cleaved or abstracted from the metal center M (e.g., a halide may be converted to an alkyl group). Without wishing to be bound by any single theory, protonolysis or abstraction reactions generate an active “cationic” metal center which can polymerize olefins.

In embodiments of the present disclosure, the activatable ligand, Q is independently selected from the group consisting of a hydrogen atom; a halogen atom; a C₁₋₂₀ hydrocarbyl radical, a C₁₋₂₀ alkoxy radical, and a C₆₋₁₀ aryl or aryloxy radical, where each of the hydrocarbyl, alkoxy, aryl, or aryl oxide radicals may be un-substituted or further substituted by one or more halogen or other group; a C₁₋₈ alkyl; a C₁₋₈ alkoxy; a C₆₋₁₀aryl or aryloxy; an amido or a phosphido radical, but where Q is not a cyclopentadienyl. Two Q ligands may also be joined to one another and form for example, a substituted or unsubstituted diene ligand (e.g., 1,3-butadiene); or a delocalized heteroatom containing group such as an acetate or acetamidinate group. In a convenient embodiment of the disclosure, each Q is independently selected from the group consisting of a halide atom, a C₁₋₄ alkyl radical and a benzyl radical. Particularly suitable activatable ligands Q are monoanionic such as a halide (e.g., chloride) or a hydrocarbyl (e.g., methyl, benzyl).

In an embodiment of the disclosure, the second homogeneous catalyst used to make the second ethylene interpolymer is diphenylmethylene(cyclopentadienyl)(2,7-di-t-butylfluorenyl)hafnium dichloride having the molecular formula:

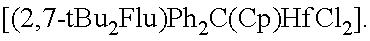

In an embodiment of the disclosure the second homogeneous catalyst used to make the second ethylene interpolymer is diphenylmethylene(cyclopentadienyl)(2,7-di-t-butylfluorenyl)hafnium dimethyl having the molecular formula:

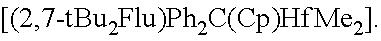

In an embodiment of the disclosure, the second homogeneous catalyst is a phosphinimine catalyst represented by formula (II):

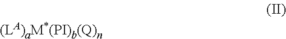

wherein (L^{A}) represents a bulky ligand; M* represents a metal atom; PI represents a phosphinimine ligand; Q is independently an activatable leaving group ligand; a is 0 or 1; b is 1 or 2; (a+b)=2; n is 1 or 2; and the sum of (a+b+n) equals the valance of the metal M*.

In an embodiment of the disclosure, L^{A} is selected from the group consisting of unsubstituted cyclopentadienyl, substituted cyclopentadienyl, unsubstituted indenyl, substituted indenyl, unsubstituted fluorenyl and substituted fluorenyl.

In an embodiment of the disclosure, M* is a metal selected from the group consisting of titanium, hafnium and zirconium.

In further non-limiting embodiments of the disclosure, the bulky ligand L^{A} in formula (II) includes unsubstituted or substituted cyclopentadienyl ligands or cyclopentadienyl-type ligands, heteroatom substituted and/or heteroatom containing cyclopentadienyl-type ligands. In additional non-limiting embodiments, the bulky ligand L^{A} in formula (II) includes cyclopentaphenanthreneyl ligands, unsubstituted or substituted indenyl ligands, benzindenyl ligands, unsubstituted or substituted fluorenyl ligands, octahydrofluorenyl ligands, cyclooctatetraendiyl ligands, cyclopentacyclododecene ligands, azenyl ligands, azulene ligands, pentalene ligands, phosphoyl ligands, phosphinimine, pyrrolyl ligands, pyrozolyl ligands, carbazolyl ligands, borabenzene ligands and the like, including hydrogenated versions thereof, for example tetrahydroindenyl ligands. In other embodiments, L^{A} may be any other ligand structure capable of η-bonding to the metal M*, such embodiments include both η³-bonding and η⁵-bonding to the metal M*. In other embodiments, L^{A} may comprise one or more heteroatoms, for example, nitrogen, silicon, boron, germanium, sulfur and phosphorous, in combination with carbon atoms to form an open, acyclic, or a fused ring, or ring system, for example, a heterocyclopentadienyl ancillary ligand. Other non-limiting embodiments for L^{A} include bulky amides, phosphides, alkoxides, aryloxides, imides, carbolides, borollides, porphyrins, phthalocyanines, corrins and other polyazomacrocycles.

In an embodiment of the disclosure, the metal M* is titanium, Ti.

The phosphinimine ligand, PI, is defined by formula (III):

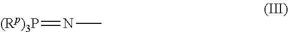

wherein the R^{p} groups are independently selected from: a hydrogen atom; a halogen atom; C₁₋₂₀ hydrocarbyl radicals which are unsubstituted or substituted with one or more halogen atom(s); a C₁₋₈ alkoxy radical; a C₆₋₁₀ aryl radical; a C₆₋₁₀ aryloxy radical; an amido radical; a silyl radical of formula —Si(R^{s})₃, wherein the R^{s} groups are independently selected from, a hydrogen atom, a C₁₋₈ alkyl or alkoxy radical, a C₆₋₁₀ aryl radical, a C₆₋₁₀ aryloxy radical, or a germanyl radical of formula —Ge(R^{G})₃, wherein the R^{G} groups are defined as R^{s} is defined in this paragraph.

In addition to the second homogeneous catalyst molecule per se, an active homogeneous catalyst system may further comprise one or more of the following: an alkylaluminoxane co-catalyst and an ionic activator. The homogenous catalyst system may also optionally comprise a hindered phenol.

Although the exact structure of alkylaluminoxane is uncertain, subject matter experts generally agree that it is an oligomeric species that contain repeating units of the general formula:

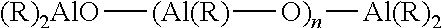

where the R groups may be the same or different linear, branched or cyclic hydrocarbyl radicals containing 1 to 20 carbon atoms and n is from 0 to about 50. A non-limiting example of an alkylaluminoxane is methylaluminoxane (or MAO) wherein each R group is a methyl radical.

In an embodiment of the disclosure, R of the alkylaluminoxane, is a methyl radical and m is from 10 to 40.

In an embodiment of the disclosure, the co-catalyst is modified methylaluminoxane (MMAO).

It is well known in the art, that the alkylaluminoxane can serve dual roles as both an alkylator and an activator. Hence, an alkylaluminoxane co-catalyst is often used in combination with activatable ligands such as halogens.

In general, ionic activators are comprised of a cation and a bulky anion; wherein the latter is substantially non-coordinating. Non-limiting examples of ionic activators are boron ionic activators that are four coordinate with four ligands bonded to the boron atom. Non-limiting examples of boron ionic activators include the following formulas shown below:

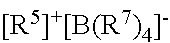

where B represents a boron atom, R₅ is an aromatic hydrocarbyl (e.g., triphenyl methyl cation) and each R₇ is independently selected from phenyl radicals which are unsubstituted or substituted with from 3 to 5 substituents selected from fluorine atoms, C₁₋₄ alkyl or alkoxy radicals which are unsubstituted or substituted by fluorine atoms; and a silyl radical of formula —Si(R₉)₃, where each R₉ is independently selected from hydrogen atoms and C₁₋₄ alkyl radicals, and

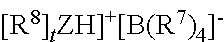

where B is a boron atom, H is a hydrogen atom, Z is a nitrogen or phosphorus atom, t is 2 or 3 and R₈ is selected from C₁₋₈ alkyl radicals, phenyl radicals which are unsubstituted or substituted by up to three C₁₋₄ alkyl radicals, or one R₈ taken together with the nitrogen atom may form an anilinium radical and R₇ is as defined above.

In both formula, a non-limiting example of R₇ is a pentafluorophenyl radical. In general, boron ionic activators may be described as salts of tetra(perfluorophenyl)boron; non-limiting examples include anilinium, carbonium, oxonium, phosphonium and sulfonium salts of tetra(perfluorophenyl)boron with anilinium and trityl (or triphenylmethylium). Additional non-limiting examples of ionic activators include: triethylammonium tetra(phenyl)boron, tripropylammonium tetra(phenyl)boron, tri(n-butyl)ammonium tetra(phenyl)boron, trimethylammonium tetra(p-tolyl)boron, trimethylammonium tetra(o-tolyl)boron, tributylammonium tetra(pentafluorophenyl)boron, tripropylammonium tetra(o,p-dimethylphenyl)boron, tributylammonium tetra(m,m-dimethylphenyl)boron, tributylammonium tetra(p-trifluoromethylphenyl)boron, tributylammonium tetra(pentafluorophenyl)boron, tri(n-butyl)ammonium tetra(o-tolyl)boron, N,N-dimethylanilinium tetra(phenyl)boron, N,N-diethylanilinium tetra(phenyl)boron, N,N-diethylanilinium tetra(phenyl) n-butylboron, N,N-2,4,6-pentamethylanilinium tetra(phenyl)boron, di-(isopropyl) ammonium tetra(pentafluorophenyl)boron, dicyclohexylammonium tetra(phenyl)boron, triphenylphosphonium tetra(phenyl)boron, tri(methylphenyl)phosphonium tetra(phenyl)boron, tri(dimethylphenyl)phosphonium tetra(phenyl)boron, tropillium tetrakispentafluorophenyl borate, triphenylmethylium tetrakispentafluorophenyl borate, benzene(diazonium)tetrakispentafluorophenyl borate, tropillium tetrakis(2,3,5,6-tetrafluorophenyl)borate, triphenylmethylium tetrakis(2,3,5,6-tetrafluorophenyl)borate, benzene(diazonium) tetrakis(3,4,5-trifluorophenyl)borate, tropillium tetrakis(3,4,5-trifluorophenyl)borate, benzene(diazonium) tetrakis(3,4,5-trifluorophenyl)borate, tropillium tetrakis(1,2,2-trifluoroethenyl)borate, triphenylmethylium tetrakis(1,2,2-trifluoroethenyl)borate, benzene(diazonium) tetrakis(1,2,2-trifluoroethenyl)borate, tropillium tetrakis(2,3,4,5-tetrafluorophenyl)borate, triphenylmethylium tetrakis(2,3,4,5-tetrafluorophenyl)borate, and benzene(diazonium) tetrakis(2,3,4,5 tetrafluorophenyl)borate. Readily available commercial ionic activators include N,N-dimethylanilinium tetrakispentafluorophenyl borate, and triphenylmethylium tetrakispentafluorophenyl borate.

Non-limiting example of hindered phenols include butylated phenolic antioxidants, butylated hydroxytoluene, 2,6-di-tertiarybutyl-4-ethyl phenol, 4,4′-methylenebis(2,6-di-tertiary-butylphenol), 1,3, 5-trimethyl-2,4,6-tris(3,5-di-tert-butyl-4-hydroxybenzyl)benzene and octadecyl-3-(3′,5′-di-tert-butyl-4′-hydroxyphenyl) propionate.

To produce an active homogeneous catalyst system the quantity and mole ratios of the three or four components: the first homogenous catalyst, the alkylaluminoxane, the ionic activator, and the optional hindered phenol are optimized.

In an embodiment of the disclosure, the second homogeneous catalyst used to make the second ethylene interpolymer produces no long chain branches, and/or the second ethylene interpolymer will contain no measurable amounts of long chain branches.

In an embodiment of the disclosure, the second homogeneous catalyst used to make the second ethylene interpolymer produces long chain branches, and the second ethylene interpolymer will contain long chain branches, hereinafter “LCB”. LCB is a well-known structural phenomenon in ethylene polymers and well known to those of ordinary skill in the art.

In an embodiment of the disclosure, the second ethylene interpolymer contains long chain branching characterized by the LCBF disclosed herein. In embodiments of the disclosure, the upper limit on the LCBF of the second ethylene interpolymer may be about 0.5, in other cases about 0.4 and in still other cases about 0.3 (dimensionless). In embodiments of the disclosure, the lower limit on the LCBF of the second ethylene interpolymer may be about 0.001, in other cases about 0.0015 and in still other cases about 0.002 (dimensionless).

In some embodiments of the disclosure, the upper limit of the molecular weight distribution (M_{w}/Mₙ) of the second ethylene interpolymer is about 2.3, or about 2.2, or about 2.1, or about 2.0. In some embodiments of the disclosure, the lower limit of the molecular weight distribution (M_{w}/Mₙ) of the second ethylene interpolymer is about 1.7, or about 1.8, or about 1.9.

In some embodiments of the disclosure, the second ethylene interpolymer has a molecular weight distribution (M_{w}/Mₙ) of ≤2.3, or <2.3, or ≤2.2, or <2.2, or ≤2.1, or <2.1. In some embodiments of the disclosure, the second ethylene interpolymer has a molecular weight distribution (M_{w}/Mₙ) of from about 1.7 to about 2.3, or from about 1.8 to about 2.3, or from about 1.8 to about 2.2.

In an embodiment, the second ethylene interpolymer has a number of short chain branches per thousand carbon atoms of from 25 to 55. In further embodiments, the second ethylene interpolymer has from 30 to 50 short chain branches per thousand carbon atoms, or from 30 to 45 short chain branches per thousand carbon atoms, or from 30 to 40 short chain branches per thousand carbon atoms, or from 31 to 55 short chain branches per thousand carbon atoms, or from 31 to 50 short chain branches per thousand carbon atoms, or from 33 to 45 short chain branches per thousand carbon atoms, or from 33 to 40 short chain branches per thousand carbon atoms. In still further embodiments, the second ethylene interpolymer has from 25 to 50 short chain branches per thousand carbon atoms, or from 27 to 48 short chain branches per thousand carbon atoms, or from 27 to 45 short chain branches per thousand carbon atoms.

It is recognized by those skilled in the art that the short chain branching (i.e., the short chain branching per thousand carbon atoms) is the branching due to the presence of the at least one α-olefin in the second ethylene interpolymer and will for example have two carbon atoms for butene-1, or four carbon atoms for a hexene-1, or six carbon atoms for a octene-1, etc.

In an embodiment of the disclosure, the second ethylene interpolymer has a weight average molecular weight, M_{w} of from 20 kg/mol to 75 kg/mol, or from 20 kg/mol to 70 kg/mol, or from 30 kg/mol to 65 kg/mol, or from 35 kg/mol to 60 kg/mol, or from kg/mol to 60 kg/mol, or from 40 kg/mol to 55 kg/mol.

The weight average molecular weight of the second ethylene interpolymer is less than the weight average molecular weight of the first ethylene polymer. In some embodiments, a ratio of the weight average molecular weight of the first ethylene polymer and the weight average molecular weight of the second ethylene interpolymer is greater than or equal to 1.5 and less than or equal to 6. In some embodiments, a ratio of the weight average molecular weight of the first ethylene polymer and the weight average molecular weight of the second ethylene interpolymer is greater than or equal to 2 and less than or equal to 4. In some embodiments, a ratio of the weight average molecular weight of the first ethylene polymer and the weight average molecular weight of the second ethylene interpolymer is greater than or equal to 2.5 and less than or equal to 4.0. In some embodiments, a ratio of the weight average molecular weight of the first ethylene polymer and the weight average molecular weight of the second ethylene interpolymer is greater than or equal to 2 and less than or equal to 3.

In an embodiment of the disclosure, the second ethylene interpolymer has a number average molecular weight, Mₙ of from 10 kg/mol to 40 kg/mol, or from 15 kg/mol to 40 kg/mol, or from 15 kg/mol to 34 kg/mol, or from 15 kg/mol to 30 kg/mol.

In some embodiments of the disclosure, the upper limit on the weight percent of the second ethylene interpolymer in the ethylene polymer composition (i.e., the weight percent of the second ethylene interpolymer based on the total weight of the ethylene polymer composition) is about 70 weight percent, or about 65 weight percent, or about 60 weight percent, or about 55 weight percent, or about 52 weight percent, or about 50 weight percent. In some embodiments of the disclosure, the lower limit on the weight percent of the second ethylene interpolymer in the ethylene polymer composition is about weight percent, or about 35 weight percent, or about 40 weight percent, or about 45 weight percent, or about 50 percent. In an embodiment, the second ethylene interpolymer is present in the ethylene polymer composition in an amount from 30 to 70 weight percent. In another embodiment, the second ethylene interpolymer is present in the ethylene polymer composition in an amount from 40 to 60 weight percent. In yet another embodiment, the second ethylene interpolymer is present in the ethylene polymer composition in an amount from 50 to 65 weight percent.

### Third Ethylene Interpolymer

The third ethylene interpolymer comprises ethylene and at least one α-olefin. In embodiments of the disclosure, the at least one α-olefin which is polymerized with ethylene to make the third ethylene interpolymer may be selected from the group comprising propene-1, butene-1, pentene-1, hexene-1 and octene-1 and mixtures thereof.

In an embodiment of the disclosure, the third ethylene interpolymer is a third ethylene/octene-1 interpolymer.

In an embodiment of the disclosure, the third ethylene interpolymer is a third homogeneously branched ethylene interpolymer.

In an embodiment of the disclosure, the third ethylene interpolymer is made with a third homogeneous catalyst, non-limiting examples of which include phosphinimine catalysts and bridged metallocene catalysts, all of which are well known in the art.

In an embodiment of the disclosure, the third ethylene interpolymer is made with a third homogeneous catalyst, having hafnium, Hf, as the active metal center (i.e., the catalyst is a hafnocene catalyst).

In an embodiment of the disclosure, the third ethylene interpolymer is made with a bridged metallocene catalyst.

In an embodiment of the disclosure, the third ethylene interpolymer is made with a bridged metallocene catalyst having the Formula (I):

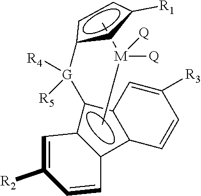

In Formula (I): M is a group 4 metal selected from titanium, zirconium or hafnium; G is a group 14 element selected from carbon, silicon, germanium, tin or lead; R₁ is a hydrogen atom, a C₁₋₂₀ hydrocarbyl radical, a C₁₋₂₀ alkoxy radical or a C₆₋₁₀ aryl oxide radical; R₂ and R₃ are independently selected from a hydrogen atom, a C₁₋₂₀ hydrocarbyl radical, a C₁₋₂₀ alkoxy radical or a C₆₋₁₀ aryl oxide radical; R₄ and R₅ are independently selected from a hydrogen atom, an unsubstituted C₁₋₂₀ hydrocarbyl radical, a substituted C₁₋₂₀ hydrocarbyl radical, a C₁₋₂₀ alkoxy radical or a C₆₋₁₀ aryl oxide radical; and Q is independently an activatable leaving group ligand.

In an embodiment, R₄ and R₅ are independently an aryl group.

In an embodiment, R₄ and R₅ are independently a phenyl group or a substituted phenyl group.

In an embodiment, R₄ and R₅ are a phenyl group.

In an embodiment, R₄ and R₅ are independently a substituted phenyl group.

In an embodiment, R₄ and R₅ are a substituted phenyl group, wherein the phenyl group is substituted with a substituted silyl group.

In an embodiment, R₄ and R₅ are a substituted phenyl group, wherein the phenyl group is substituted with a trialkyl silyl group.

In an embodiment, R₄ and R₅ are a substituted phenyl group, wherein the phenyl group is substituted at the para position with a trialkylsilyl group. In an embodiment, R¹ and R² are a substituted phenyl group, wherein the phenyl group is substituted at the para position with a trimethylsilyl group. In an embodiment, R¹ and R² are a substituted phenyl group, wherein the phenyl group is substituted at the para position with a triethylsilyl group.

In an embodiment, R₄ and R₅ are independently an alkyl group.

In an embodiment, R₄ and R₅ are independently an alkenyl group.

In an embodiment, R₁ is hydrogen.

In an embodiment, R₁ is an alkyl group.

In an embodiment, R₁ is an aryl group.

In an embodiment, R₁ is an alkenyl group.

In an embodiment, R₂ and R₃ are independently a hydrocarbyl group having from 1 to 30 carbon atoms.

In an embodiment, R₂ and R₃ are independently an aryl group.

In an embodiment, R₂ and R₃ are independently an alkyl group.

In an embodiment, R₂ and R₃ are independently an alkyl group having from 1 to 20 carbon atoms.

In an embodiment, R₂ and R₃ are independently a phenyl group or a substituted phenyl group.

In an embodiment, R₂ and R₃ are a tert-butyl group.

In an embodiment, R₂ and R₃ are hydrogen.

In an embodiment, M is hafnium, Hf.

In an embodiment of the disclosure, the third ethylene interpolymer is made with a bridged metallocene catalyst having the Formula (Ia):

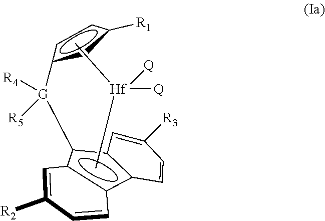

In Formula (Ia): G is a group 14 element selected from carbon, silicon, germanium, tin or lead; R₁ is a hydrogen atom, a C₁₋₂₀ hydrocarbyl radical, a C₁₋₂₀ alkoxy radical or a C₆₋₁₀ aryl oxide radical; R₂ and R₃ are independently selected from a hydrogen atom, a C₁₋₂₀ hydrocarbyl radical, a C₁₋₂₀ alkoxy radical or a C₆₋₁₀ aryl oxide radical; R₄ and R₅ are independently selected from a hydrogen atom, an unsubstituted C₁₋₂₀ hydrocarbyl radical, a substituted C₁₋₂₀ hydrocarbyl radical, a C₁₋₂₀ alkoxy radical or a C₆₋₁₀ aryl oxide radical; and Q is independently an activatable leaving group ligand.

In the current disclosure, the term “activatable”, means that the ligand Q may be cleaved from the metal center M via a protonolysis reaction or abstracted from the metal center M by suitable acidic or electrophilic catalyst activator compounds (also known as “co-catalyst” compounds) respectively, examples of which are described below. The activatable ligand Q may also be transformed into another ligand which is cleaved or abstracted from the metal center M (e.g., a halide may be converted to an alkyl group). Without wishing to be bound by any single theory, protonolysis or abstraction reactions generate an active “cationic” metal center which can polymerize olefins.

In embodiments of the present disclosure, the activatable ligand, Q is independently selected from the group consisting of a hydrogen atom; a halogen atom; a C₁₋₂₀ hydrocarbyl radical, a C₁₋₂₀ alkoxy radical, and a C₆₋₁₀ aryl or aryloxy radical, where each of the hydrocarbyl, alkoxy, aryl, or aryl oxide radicals may be un-substituted or further substituted by one or more halogen or other group; a C₁₋₈ alkyl; a C₁₋₈ alkoxy; a C₆₋₁₀ aryl or aryloxy; an amido or a phosphido radical, but where Q is not a cyclopentadienyl. Two Q ligands may also be joined to one another and form for example, a substituted or unsubstituted diene ligand (e.g., 1,3-butadiene); or a delocalized heteroatom containing group such as an acetate or acetamidinate group. In a convenient embodiment of the disclosure, each Q is independently selected from the group consisting of a halide atom, a C₁₋₄ alkyl radical and a benzyl radical. Particularly suitable activatable ligands Q are monoanionic such as a halide (e.g., chloride) or a hydrocarbyl (e.g., methyl, benzyl).

In an embodiment of the disclosure, the third homogeneous catalyst used to make the third ethylene interpolymer is diphenylmethylene(cyclopentadienyl)(2,7-di-t-butylfluorenyl)hafnium dichloride having the molecular formula:

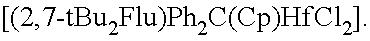

In an embodiment of the disclosure the third homogenous catalyst used to make the third ethylene interpolymer is diphenylmethylene(cyclopentadienyl)(2,7-di-t-butylfluorenyl)hafnium dimethyl having the molecular formula:

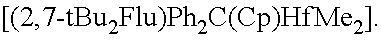

In an embodiment of the disclosure, the third homogeneous catalyst is a phosphinimine catalyst represented by formula (II):

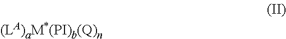

wherein (L^{A}) represents a bulky ligand; M* represents a metal atom; PI represents a phosphinimine ligand; Q is independently an activatable leaving group ligand; a is 0 or 1; bis 1 or 2; (a+b)=2; n is 1 or 2; and the sum of (a+b+n) equals the valance of the metal M*.

In an embodiment of the disclosure, L^{A} is selected from the group consisting of unsubstituted cyclopentadienyl, substituted cyclopentadienyl, unsubstituted indenyl, substituted indenyl, unsubstituted fluorenyl and substituted fluorenyl.

In an embodiment of the disclosure, M* is a metal selected from the group consisting of titanium, hafnium and zirconium.

In further non-limiting embodiments of the disclosure, the bulky ligand L^{A} in formula (II) includes unsubstituted or substituted cyclopentadienyl ligands or cyclopentadienyl-type ligands, heteroatom substituted and/or heteroatom containing cyclopentadienyl-type ligands. In additional non-limiting embodiments, the bulky ligand L^{A} in formula (II) includes cyclopentaphenanthreneyl ligands, unsubstituted or substituted indenyl ligands, benzindenyl ligands, unsubstituted or substituted fluorenyl ligands, octahydrofluorenyl ligands, cyclooctatetraendiyl ligands, cyclopentacyclododecene ligands, azenyl ligands, azulene ligands, pentalene ligands, phosphoyl ligands, phosphinimine, pyrrolyl ligands, pyrozolyl ligands, carbazolyl ligands, borabenzene ligands and the like, including hydrogenated versions thereof, for example tetrahydroindenyl ligands. In other embodiments, L^{A} may be any other ligand structure capable of η-bonding to the metal M″, such embodiments include both η³-bonding and η⁵-bonding to the metal M*. In other embodiments, L^{A} may comprise one or more heteroatoms, for example, nitrogen, silicon, boron, germanium, sulfur and phosphorous, in combination with carbon atoms to form an open, acyclic, or a fused ring, or ring system, for example, a heterocyclopentadienyl ancillary ligand. Other non-limiting embodiments for L^{A} include bulky amides, phosphides, alkoxides, aryloxides, imides, carbolides, borollides, porphyrins, phthalocyanines, corrins and other polyazomacrocycles.

In an embodiment of the disclosure, the metal M* is titanium, Ti.

The phosphinimine ligand, PI, is defined by formula (III):

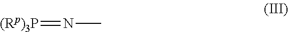

wherein the R^{p} groups are independently selected from: a hydrogen atom; a halogen atom; C₁₋₂₀ hydrocarbyl radicals which are unsubstituted or substituted with one or more halogen atom(s); a C₁₋₈ alkoxy radical; a C₆₋₁₀ aryl radical; a C₆₋₁₀ aryloxy radical; an amido radical; a silyl radical of formula —Si(R^{s})₃, wherein the R^{s} groups are independently selected from, a hydrogen atom, a C₁₋₈ alkyl or alkoxy radical, a C₆₋₁₀ aryl radical, a C₆₋₁₀ aryloxy radical, or a germanyl radical of formula —Ge(R^{G})₃, wherein the R^{G} groups are defined as R^{s} is defined in this paragraph.

In addition to the first homogeneous catalyst molecule per se, an active homogeneous catalyst system may further comprise one or more of the following: an alkylaluminoxane co-catalyst and an ionic activator. The homogenous catalyst system may also optionally comprise a hindered phenol.

Although the exact structure of alkylaluminoxane is uncertain, subject matter experts generally agree that it is an oligomeric species that contain repeating units of the general formula:

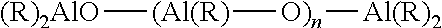

where the R groups may be the same or different linear, branched or cyclic hydrocarbyl radicals containing 1 to 20 carbon atoms and n is from 0 to about 50. A non-limiting example of an alkylaluminoxane is methylaluminoxane (or MAO) wherein each R group is a methyl radical.

In an embodiment of the disclosure, R of the alkylaluminoxane, is a methyl radical and m is from 10 to 40.

In an embodiment of the disclosure, the co-catalyst is modified methylaluminoxane (MMAO).

It is well known in the art, that the alkylaluminoxane can serve dual roles as both an alkylator and an activator. Hence, an alkylaluminoxane co-catalyst is often used in combination with activatable ligands such as halogens.

In general, ionic activators are comprised of a cation and a bulky anion; wherein the latter is substantially non-coordinating. Non-limiting examples of ionic activators are boron ionic activators that are four coordinate with four ligands bonded to the boron atom. Non-limiting examples of boron ionic activators include the following formulas shown below:

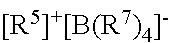

where B represents a boron atom, R⁵ is an aromatic hydrocarbyl (e.g., triphenyl methyl cation) and each R⁷ is independently selected from phenyl radicals which are unsubstituted or substituted with from 3 to 5 substituents selected from fluorine atoms, C₁₋₄ alkyl or alkoxy radicals which are unsubstituted or substituted by fluorine atoms; and a silyl radical of formula —Si(R⁹)₃, where each R⁹ is independently selected from hydrogen atoms and C₁₋₄ alkyl radicals, and

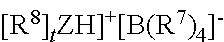

where B is a boron atom, H is a hydrogen atom, Z is a nitrogen or phosphorus atom, t is 2 or 3 and R⁸ is selected from C₁₋₈ alkyl radicals, phenyl radicals which are unsubstituted or substituted by up to three C₁₋₄ alkyl radicals, or one R⁸ taken together with the nitrogen atom may form an anilinium radical and R⁷ is as defined above.

In both formula, a non-limiting example of R⁷ is a pentafluorophenyl radical. In general, boron ionic activators may be described as salts of tetra(perfluorophenyl)boron; non-limiting examples include anilinium, carbonium, oxonium, phosphonium and sulfonium salts of tetra(perfluorophenyl)boron with anilinium and trityl (or triphenylmethylium). Additional non-limiting examples of ionic activators include: triethylammonium tetra(phenyl)boron, tripropylammonium tetra(phenyl)boron, tri(n-butyl)ammonium tetra(phenyl)boron, trimethylammonium tetra(p-tolyl)boron, trimethylammonium tetra(o-tolyl)boron, tributylammonium tetra(pentafluorophenyl)boron, tripropylammonium tetra(o,p-dimethylphenyl)boron, tributylammonium tetra(m,m-dimethylphenyl)boron, tributylammonium tetra(p-trifluoromethylphenyl)boron, tributylammonium tetra(pentafluorophenyl)boron, tri(n-butyl)ammonium tetra(o-tolyl)boron, N,N-dimethylanilinium tetra(phenyl)boron, N,N-diethylanilinium tetra(phenyl)boron, N,N-diethylanilinium tetra(phenyl) n-butylboron, N,N-2,4,6-pentamethylanilinium tetra(phenyl)boron, di-(isopropyl) ammonium tetra(pentafluorophenyl)boron, dicyclohexylammonium tetra(phenyl)boron, triphenylphosphonium tetra(phenyl)boron, tri(methylphenyl)phosphonium tetra(phenyl)boron, tri(dimethylphenyl)phosphonium tetra(phenyl)boron, tropillium tetrakispentafluorophenyl borate, triphenylmethylium tetrakispentafluorophenyl borate, benzene(diazonium)tetrakispentafluorophenyl borate, tropillium tetrakis(2,3,5,6 -tetrafluorophenyl)borate, triphenylmethylium tetrakis(2,3,5,6-tetrafluorophenyl)borate, benzene(diazonium) tetrakis(3,4,5-trifluorophenyl)borate, tropillium tetrakis(3,4,5-trifluorophenyl)borate, benzene(diazonium) tetrakis(3,4,5-trifluorophenyl)borate, tropillium tetrakis(1,2,2-trifluoroethenyl)borate, triphenylmethylium tetrakis(1,2,2-trifluoroethenyl)borate, benzene(diazonium) tetrakis(1,2,2-trifluoroethenyl)borate, tropillium tetrakis(2,3,4,5-tetrafluorophenyl)borate, triphenylmethylium tetrakis(2,3,4,5-tetrafluorophenyl)borate, and benzene(diazonium) tetrakis(2,3,4,5 tetrafluorophenyl)borate. Readily available commercial ionic activators include N,N-dimethylanilinium tetrakispentafluorophenyl borate, and triphenylmethylium tetrakispentafluorophenyl borate.

Non-limiting example of hindered phenols include butylated phenolic antioxidants, butylated hydroxytoluene, 2,6-di-tertiarybutyl-4-ethyl phenol, 4,4′-methylenebis(2,6-di-tertiary-butylphenol), 1,3, 5-trimethyl-2,4,6-tris(3,5-di-tert-butyl-4-hydroxybenzyl)benzene and octadecyl-3-(3′,5′-di-tert-butyl-4′-hydroxyphenyl) propionate.

To produce an active homogeneous catalyst system the quantity and mole ratios of the three or four components: the first homogenous catalyst, the alkylaluminoxane, the ionic activator, and the optional hindered phenol are optimized.

In an embodiment of the disclosure, the third homogeneous catalyst used to make the third ethylene interpolymer produces no long chain branches, and/or the third ethylene interpolymer will contain no measurable amounts of long chain branches.

In an embodiment of the disclosure, the third homogeneous catalyst used to make the third ethylene interpolymer produces long chain branches, and the third ethylene interpolymer will contain long chain branches, hereinafter “LCB”. LCB is a well-known structural phenomenon in ethylene polymers and well known to those of ordinary skill in the art.

In an embodiment of the disclosure, the third ethylene interpolymer contains long chain branching characterized by the LCBF disclosed herein. In embodiments of the disclosure, the upper limit on the LCBF of the third ethylene interpolymer may be about 0.5, in other cases about 0.4 and in still other cases about 0.3 (dimensionless). In embodiments of the disclosure, the lower limit on the LCBF of the third ethylene interpolymer may be about 0.001, in other cases about 0.0015 and in still other cases about 0.002 (dimensionless).

In some embodiments of the disclosure, the upper limit of the molecular weight distribution (M_{w}/Mₙ) of the third ethylene interpolymer is about 2.3, or about 2.2, or about 2.1, or about 2.0. In some embodiments of the disclosure, the lower limit of the molecular weight distribution (M_{w}/Mₙ) of the third ethylene interpolymer is about 1.7, or about 1.8, or about 1.9.

In some embodiments of the disclosure, the third ethylene interpolymer has a molecular weight distribution (M_{w}/Mₙ) of ≤2.3, or <2.3, or ≤2.2, or <2.2, or ≤2.1, or <2.1. In some embodiments of the disclosure, the third ethylene interpolymer has a molecular weight distribution (M_{w}/Mₙ) of from about 1.7 to about 2.3, or from about 1.8 to about 2.3, or from about 1.8 to about 2.2.

In an embodiment, the third ethylene interpolymer has a number of short chain branches per thousand carbon atoms of from 25 to 50. In further embodiments, the third ethylene interpolymer has from 30 to 50 short chain branches per thousand carbon atoms, or from 30 to 45 short chain branches per thousand carbon atoms, or from 30 to 40 short chain branches per thousand carbon atoms, or from 31 to 55 short chain branches per thousand carbon atoms, or from 31 to 50 short chain branches per thousand carbon atoms, or from 33 to 45 short chain branches per thousand carbon atoms, or from 33 to 40 short chain branches per thousand carbon atoms. In still further embodiments, the third ethylene interpolymer has from 25 to 55 short chain branches per thousand carbon atoms, or from 27 to 48 short chain branches per thousand carbon atoms, or from 27 to 45 short chain branches per thousand carbon atoms.

It is recognized by those skilled in the art that the short chain branching (i.e., the short chain branching per thousand carbon atoms) is the branching due to the presence of the at least one α-olefin in the third ethylene interpolymer and will for example have two carbon atoms for butene-1, or four carbon atoms for a hexene-1, or six carbon atoms for a octene-1, etc.

In embodiments of the disclosure, the third ethylene interpolymer has a number of short chain branches per thousand carbon atoms which is greater than the number of short chain branches of the second ethylene interpolymer—i.e., the number of short chain branches per thousand carbon atoms of the third ethylene interpolymer (SCB³) and the number of short chain branches per thousand carbon atoms of the second ethylene interpolymer (SCB²) satisfy the inequality SCB³>SCB².

In an embodiment of the disclosure, the third ethylene interpolymer has a weight average molecular weight, M_{w} of from 20 kg/mol to 50 kg/mol, or from 20 kg/mol to 48 kg/mol, or from 20 kg/mol to 46 kg/mol, or from 23 kg/mol to 48 kg/mol, or from 24 kg/mol to 46 kg/mol, or from 25 kg/mol to 45 kg/mol.

In some embodiments, the third ethylene interpolymer has a weight average molecular weight which is less than the weight average molecular weight of the first ethylene polymer and the weight average molecular weight of the second ethylene interpolymer—i.e., the weight-average molecular weights of the first ethylene polymer, the second ethylene interpolymer and the third ethylene interpolymer (M_{w}¹, M_{w}², and M_{w}³, respectively) satisfy the inequalities M_{w}³<M_{w}¹ and M_{w}³<M_{w}².

In some embodiments of the disclosure, the upper limit on the weight percent of the third ethylene interpolymer in the ethylene polymer composition (i.e., the weight percent of the third ethylene interpolymer based on the total weight of the ethylene polymer composition) is about 20 weight percent, or about 15 weight percent, or about 12 weight percent, or about 10 weight percent, or about 8 weight percent, or about 5 weight percent. In some embodiments of the disclosure, the lower limit on the weight percent of the third ethylene interpolymer in the ethylene polymer composition is 0 weight percent, or greater than 0 weight percent, or about 1 weight percent, or about 3 weight percent, or about 5 weight percent. In an embodiment, the third ethylene interpolymer is present in the ethylene polymer composition in an amount from 0 to 20 weight percent. In another embodiment, the third ethylene interpolymer is present in the ethylene polymer composition in an amount from greater than (>) 0 to 20 weight percent. In another embodiment, the third ethylene interpolymer is present in the ethylene polymer composition in an amount from 0 to 10 weight percent. In yet another embodiment, the third ethylene interpolymer is present in the ethylene polymer composition in an amount from greater than (>) 0 to 10 weight percent.

### Ethylene Polymer Composition

The ethylene polymer compositions disclosed herein is a reactor blend of a first ethylene polymer, a second ethylene interpolymer and optionally a third ethylene interpolymer. The term “reactor blend” refers to a blend which is formed while polymerization is occurring and is herein distinguished from a physical post-reactor blend. The term “post-reactor blend” refers to a blend formed by combining two or more than two blend components wherein each one of the blend components is already polymerized and recovered from the polymerization process—the recovery operations can include catalyst deactivation, phase separation, devolatilizing unreacted monomers and/or process solvent, pelletization, etc.—before being combined with the other blend component(s).

In an embodiment, the ethylene polymer composition of the present disclosure is made using a first homogeneous catalyst in a first reactor to give a first ethylene polymer, and a second homogeneous catalyst is used in a second reactor to give a second ethylene interpolymer.

In an embodiment, the ethylene polymer composition of the present disclosure is made using a first homogeneous catalyst in a first reactor to give a first ethylene polymer, a second homogeneous catalyst is used in a second reactor to give a second ethylene interpolymer, and a third homogeneous catalyst is used in a third reactor to give a third ethylene interpolymer.

In an embodiment, the ethylene polymer composition of the present disclosure is made by forming a first ethylene polymer in a first reactor by polymerizing ethylene and optionally at least one α-olefin with a first homogeneous catalyst; and forming a second ethylene interpolymer in a second reactor by polymerizing ethylene and at least one α-olefin with a second homogeneous catalyst.

In an embodiment, the ethylene polymer composition of the present disclosure is made by forming a first ethylene homopolymer in a first reactor by polymerizing ethylene with a first homogeneous catalyst; and forming a second ethylene interpolymer in a second reactor by polymerizing ethylene and at least one α-olefin with a second homogeneous catalyst.

In an embodiment, the ethylene polymer composition of the present disclosure is made by forming a first ethylene homopolymer in a first reactor by polymerizing ethylene with a first homogeneous catalyst; and forming a second ethylene interpolymer in a second reactor by polymerizing ethylene and at least one α-olefin with a second homogeneous catalyst.

In an embodiment, the ethylene polymer composition of the present disclosure is made by forming a first ethylene interpolymer in a first reactor by polymerizing ethylene and at least one α-olefin with a first homogeneous catalyst; and forming a second ethylene interpolymer in a second reactor by polymerizing ethylene and at least one α-olefin with a second homogeneous catalyst.

In an embodiment, the ethylene polymer composition of the present disclosure is made by forming a first ethylene polymer in a first reactor by polymerizing ethylene and optionally at least one α-olefin with a first homogenous catalyst; forming a second ethylene interpolymer in a second reactor by polymerizing ethylene and at least one α-olefin with a second homogeneous catalyst and forming a third ethylene interpolymer in a third reactor by polymerizing ethylene and at least one α-olefin with a third homogeneous catalyst.

In an embodiment, the ethylene polymer composition of the present disclosure is made by forming a first ethylene homopolymer in a first reactor by polymerizing ethylene with a first homogenous catalyst; forming a second ethylene interpolymer in a second reactor by polymerizing ethylene and at least one α-olefin with a second homogeneous catalyst and forming a third ethylene interpolymer in a third reactor by polymerizing ethylene and at least one α-olefin with a third homogeneous catalyst.

In an embodiment, the ethylene polymer composition of the present disclosure is made by forming a first ethylene polymer in a first solution phase polymerization reactor by polymerizing ethylene and optionally at least one-olefin with a first homogeneous catalyst; and forming a second ethylene interpolymer in a second solution phase polymerization reactor by polymerizing ethylene and at least one α-olefin with a second homogeneous catalyst.

In an embodiment, the ethylene polymer composition of the present disclosure is made by forming a first ethylene homopolymer in a first solution phase polymerization reactor by polymerizing ethylene with a first homogeneous catalyst; and forming a second ethylene interpolymer in a second solution phase polymerization reactor by polymerizing ethylene and at least one α-olefin with a second homogeneous catalyst.

In an embodiment, the ethylene polymer composition of the present disclosure is made by forming a first ethylene polymer in a first solution phase polymerization reactor by polymerizing ethylene and optionally at least one α-olefin with a first homogeneous catalyst; forming a second ethylene interpolymer in a second solution phase polymerization reactor by polymerizing ethylene and at least one α-olefin with a second homogenous catalyst, and forming a third ethylene interpolymer in a third solution phase polymerization reactor by polymerizing ethylene and at least one α-olefin with a third homogeneous catalyst.

In an embodiment, the ethylene polymer composition of the present disclosure is made by forming a first ethylene homopolymer in a first solution phase polymerization reactor by polymerizing ethylene with a first homogeneous catalyst; forming a second ethylene interpolymer in a second solution phase polymerization reactor by polymerizing ethylene and at least one α-olefin with a second homogenous catalyst, and forming a third ethylene interpolymer in a third solution phase polymerization reactor by polymerizing ethylene and at least one α-olefin with a third homogeneous catalyst.

In an embodiment, the ethylene polymer composition of the present disclosure is made by forming a first ethylene polymer in a first solution phase polymerization reactor by polymerizing ethylene and optionally at least one α-olefin with a first homogeneous catalyst; and forming a second ethylene interpolymer in a second solution phase polymerization reactor by polymerizing ethylene and at least one α-olefin with a second homogeneous catalyst, where the first and second solution phase polymerization reactors are configured in series with one another.

In an embodiment, the ethylene polymer composition of the present disclosure is made by forming a first ethylene homopolymer in a first solution phase polymerization reactor by polymerizing ethylene with a first homogeneous catalyst; and forming a second ethylene interpolymer in a second solution phase polymerization reactor by polymerizing ethylene and at least one α-olefin with a second homogeneous catalyst, where the first and second solution phase polymerization reactors are configured in series with one another.

In an embodiment, the ethylene polymer composition of the present disclosure is made by forming a first ethylene polymer in a first solution phase polymerization reactor by polymerizing ethylene and optionally at least one α-olefin with a first homogeneous catalyst; and forming a second ethylene interpolymer in a second solution phase polymerization reactor by polymerizing ethylene and at least one α-olefin with a second homogeneous catalyst, where the first and second solution phase polymerization reactors are configured in parallel with one another.

In an embodiment, the ethylene polymer composition of the present disclosure is made by forming a first ethylene homopolymer in a first solution phase polymerization reactor by polymerizing ethylene with a first homogeneous catalyst; and forming a second ethylene interpolymer in a second solution phase polymerization reactor by polymerizing ethylene and at least one α-olefin with a second homogeneous catalyst, where the first and second solution phase polymerization reactors are configured in parallel with one another.

In an embodiment, the ethylene polymer composition of the present disclosure is made by forming a first ethylene polymer in a first solution phase polymerization reactor by polymerizing ethylene and optionally at least one α-olefin with a first homogeneous catalyst; forming a second ethylene interpolymer in a second solution phase polymerization reactor by polymerizing ethylene and at least one α-olefin with a second homogenous catalyst, and forming a third ethylene interpolymer in a third solution phase polymerization reactor by polymerizing ethylene and at least one α-olefin with a third homogeneous catalyst, where the first and second solution phase polymerization reactors are configured in series with one another.

In an embodiment, the ethylene polymer composition of the present disclosure is made by forming a first ethylene homopolymer in a first solution phase polymerization reactor by polymerizing ethylene with a first homogeneous catalyst; forming a second ethylene interpolymer in a second solution phase polymerization reactor by polymerizing ethylene and at least one α-olefin with a second homogenous catalyst, and forming a third ethylene interpolymer in a third solution phase polymerization reactor by polymerizing ethylene and at least one α-olefin with a third homogeneous catalyst, where the first and second solution phase polymerization reactors are configured in series with one another.

In an embodiment, the ethylene polymer composition of the present disclosure is made by forming a first ethylene polymer in a first solution phase polymerization reactor by polymerizing ethylene and optionally at least one α-olefin with a first homogeneous catalyst; forming a second ethylene interpolymer in a second solution phase polymerization reactor by polymerizing ethylene and at least one α-olefin with a second homogenous catalyst, and forming a third ethylene interpolymer in a third solution phase polymerization reactor by polymerizing ethylene and at least one α-olefin with a third homogeneous catalyst, where at least two of the first, second and third solution phase polymerization reactors are configured in series with one another.

In an embodiment, the ethylene polymer composition of the present disclosure is made by forming a first ethylene homopolymer in a first solution phase polymerization reactor by polymerizing ethylene with a first homogeneous catalyst; forming a second ethylene interpolymer in a second solution phase polymerization reactor by polymerizing ethylene and at least one α-olefin with a second homogenous catalyst, and forming a third ethylene interpolymer in a third solution phase polymerization reactor by polymerizing ethylene and at least one α-olefin with a third homogeneous catalyst, where at least two of the first, second and third solution phase polymerization reactors are configured in series with one another.

In an embodiment, the ethylene polymer composition of the present disclosure is made by forming a first ethylene polymer in a first solution phase polymerization reactor by polymerizing ethylene and optionally at least one α-olefin with a first homogeneous catalyst; forming a second ethylene interpolymer in a second solution phase polymerization reactor by polymerizing ethylene and at least one-olefin with a second homogenous catalyst, and forming a third ethylene interpolymer in a third solution phase polymerization reactor by polymerizing ethylene and at least one α-olefin with a third homogeneous catalyst, where the first, second and third solution phase polymerization reactors are configured in series with one another.

In an embodiment, the ethylene polymer composition of the present disclosure is made by forming a first ethylene homopolymer in a first solution phase polymerization reactor by polymerizing ethylene with a first homogeneous catalyst; forming a second ethylene interpolymer in a second solution phase polymerization reactor by polymerizing ethylene and at least one α-olefin with a second homogenous catalyst, and forming a third ethylene interpolymer in a third solution phase polymerization reactor by polymerizing ethylene and at least one α-olefin with a third homogeneous catalyst, where the first, second and third solution phase polymerization reactors are configured in series with one another.

In an embodiment, the ethylene polymer composition of the present disclosure is made by forming a first ethylene polymer in a first solution phase polymerization reactor by polymerizing ethylene and optionally at least one α-olefin with a first homogeneous catalyst; forming a second ethylene interpolymer in a second solution phase polymerization reactor by polymerizing ethylene and at least one α-olefin with a second homogenous catalyst, and forming a third ethylene interpolymer in a third solution phase polymerization reactor by polymerizing ethylene and at least one α-olefin with a third homogeneous catalyst, where each of the first, second and third solution phase polymerization reactors are configured in series to one another.

In an embodiment, the ethylene polymer composition of the present disclosure is made by forming a first ethylene polymer in a first solution phase polymerization reactor by polymerizing ethylene and optionally at least one α-olefin with a first homogeneous catalyst; forming a second ethylene interpolymer in a second solution phase polymerization reactor by polymerizing ethylene and at least one α-olefin with a second homogenous catalyst, and forming a third ethylene interpolymer in a third solution phase polymerization reactor by polymerizing ethylene and at least one α-olefin with a third homogeneous catalyst, where each of the first, second and third solution phase polymerization reactors are configured in parallel to one another.

In an embodiment, the ethylene polymer composition of the present disclosure is made by forming a first ethylene homopolymer in a first solution phase polymerization reactor by polymerizing ethylene with a first homogeneous catalyst; forming a second ethylene interpolymer in a second solution phase polymerization reactor by polymerizing ethylene and at least one α-olefin with a second homogenous catalyst, and forming a third ethylene interpolymer in a third solution phase polymerization reactor by polymerizing ethylene and at least one α-olefin with a third homogeneous catalyst, where each of the first, second and third solution phase polymerization reactors are configured in parallel to one another.

In an embodiment, the ethylene polymer composition of the present disclosure is made by forming a first ethylene polymer in a first solution phase polymerization reactor by polymerizing ethylene and optionally at least one α-olefin with a first homogeneous catalyst; forming a second ethylene interpolymer in a second solution phase polymerization reactor by polymerizing ethylene and at least one α-olefin with a second homogenous catalyst, and forming a third ethylene interpolymer in a third solution phase polymerization reactor by polymerizing ethylene and at least one α-olefin with a third homogeneous catalyst, where the first and second solution phase reactors are configured in series to one another, and the third solution phase reactor is configured in parallel to the first and second reactors.

In an embodiment, the ethylene polymer composition of the present disclosure is made by forming a first ethylene homopolymer in a first solution phase polymerization reactor by polymerizing ethylene with a first homogeneous catalyst; forming a second ethylene interpolymer in a second solution phase polymerization reactor by polymerizing ethylene and at least one α-olefin with a second homogenous catalyst, and forming a third ethylene interpolymer in a third solution phase polymerization reactor by polymerizing ethylene and at least one α-olefin with a third homogeneous catalyst, where the first and second solution phase reactors are configured in series to one another, and the third solution phase reactor is configured in parallel to the first and second reactors.

In an embodiment, the solution phase polymerization reactor used as a first solution phase reactor, a second solution phase reactor, or a third solution phase reactor is a continuously stirred tank reactor or a tubular reactor.

In an embodiment, the solution phase polymerization reactor used as a first solution phase reactor, a second solution phase reactor, or a third solution phase reactor is a continuously stirred tank reactor.

In an embodiment, the solution phase polymerization reactor used as a first solution phase reactor, a second solution phase reactor, or a third solution phase reactor is a tubular reactor.

In an embodiment, the solution phase polymerization reactor used as a first solution phase reactor and a second solution phase reactor is a continuously stirred tank reactor, and the solution phase polymerization reactor used as a third solution phase reactor is a tubular reactor.

In solution polymerization, the monomers are dissolved/dispersed in the solvent either prior to being fed to the reactor (or for gaseous monomers the monomer may be fed to the reactor so that it will dissolve in the reaction mixture). Prior to mixing, the solvent and monomers are generally purified to remove potential catalyst poisons such as water, oxygen or metal impurities. The feedstock purification follows standard practices in the art, e.g. molecular sieves, alumina beds and oxygen removal catalysts are used for the purification of monomers. The solvent itself as well (e.g., methyl pentane, cyclohexane, hexane or toluene) is preferably treated in a similar manner.

The feedstock may be heated or cooled prior to feeding to the reactor.

Generally, the catalyst components may be premixed in the solvent for the reaction or fed as separate streams to the reactor. In some instances, premixing it may be desirable to provide a reaction time for the catalyst components prior to entering the reaction. Such an “in line mixing” technique is described in a number of patents in the name of DuPont Canada Inc. (e.g., U.S. Pat. No. 5,589,555 issued Dec. 31, 1996).

Solution polymerization processes for the polymerization or copolymerization of ethylene are well known in the art (see for example U.S. Pat. Nos. 6,372,864 and 6,777,509). These processes are conducted in the presence of an inert hydrocarbon solvent. In a solution phase polymerization reactor, a variety of solvents may be used as the process solvent; non-limiting examples include linear, branched or cyclic C₅ to C₁₂ alkanes. Non-limiting examples of α-olefins include propene-1, butene-1, pentene-1, hexene-1 and octene-1. Suitable catalyst component solvents include aliphatic and aromatic hydrocarbons. Non-limiting examples of aliphatic catalyst component solvents include linear, branched or cyclic C₅₋₁₂ aliphatic hydrocarbons, e.g. pentane, methyl pentane, hexane, heptane, octane, cyclohexane, cyclopentane, methylcyclohexane, hydrogenated naphtha or combinations thereof. Non-limiting examples of aromatic catalyst component solvents include benzene, toluene (methylbenzene), ethylbenzene, o-xylene (1,2-dimethylbenzene), m-xylene (1,3-dimethylbenzene), p-xylene (1,4-dimethylbenzene), mixtures of xylene isomers, hemellitene (1,2,3-trimethylbenzene), pseudocumene (1,2,4-trimethylbenzene), mesitylene (1,3,5-trimethylbenzene), mixtures of trimethylbenzene isomers, prehenitene (1,2,3,4-tetramethylbenzene), durene (1,2,3,5-tetramethylbenzene), mixtures of tetramethylbenzene isomers, pentamethylbenzene, hexamethylbenzene and combinations thereof.

The polymerization temperature in a conventional solution process may be from about 80° C. to about 300° C. In an embodiment of the disclosure the polymerization temperature in a solution process is from about 120° C. to about 250° C. The polymerization pressure in a solution process may be a “medium pressure process”, meaning that the pressure in the reactor is less than about 6,000 psi (about 42,000 kiloPascals or kPa). In an embodiment of the disclosure, the polymerization pressure in a solution process may be from about 10,000 to about 40,000 kPa, or from about 14,000 to about 22,000 kPa (i.e. from about 2,000 psi to about 3,000 psi).

In an embodiment of the disclosure, the ethylene polymer composition has at least 1 mole percent of at least one α-olefin.

In an embodiment of the disclosure, the ethylene polymer composition has at least 3 mole percent of at least one α-olefin.

In an embodiment of the disclosure, the ethylene polymer composition has from about 1 to about 10 mole percent of at least one α-olefin.

In an embodiment of the disclosure, the ethylene polymer composition has from about 3 to about 10 mole percent of at least one α-olefin.

In an embodiment of the disclosure, the ethylene polymer composition has from about 3 to about 8 mole percent of at least one α-olefin.

In an embodiment of the disclosure, the ethylene polymer composition comprises ethylene and at least one α-olefin selected from the group comprising butene-1, hexene-1, octene-1 and mixtures thereof.

In an embodiment of the disclosure, the ethylene polymer composition comprises ethylene and at least one α-olefin selected from the group comprising hexene-1, octene-1 and mixtures thereof.

In an embodiment of the disclosure, the ethylene polymer composition comprises ethylene and octene-1.

In an embodiment of the disclosure, the ethylene polymer composition comprises ethylene and at least 1 mole percent octene-1.

In an embodiment of the disclosure, the ethylene polymer composition comprises ethylene and from 1 to 10 mole percent of octene-1.

In an embodiment of the disclosure, the ethylene polymer composition comprises ethylene and from 3 to 8 mole percent of octene-1.

In some embodiments of the disclosure, the ethylene polymer composition has a density which is from about 0.900 g/cm³ to about 0.920 g/cm³, or from about 0.902 g/cm³ to about 0.919 g/cm³. In some preferred embodiments, the ethylene polymer composition has a density of from 0.903 to 0.916 g/cm³, preferably from 0.903 to 0.914 g/cm³, preferably from 0.905 to 0.912 g/cm³, preferably from 0.905 to 0.910 g/cm³.

In some embodiments of the disclosure, the melt index (12) of the ethylene polymer composition is from about 0.1 dg/min to about 10.0 dg/min, or from about 0.3 dg/min to about 10.0 dg/min, or from about 0.5 dg/min to about 10.0 dg/min, or from about 0.7 dg/min to about 10.0 dg/min, or from about 1.0 dg/min to about 8.0 dg/min, or from about 1.5 dg/min to about 6.0 dg/min, or from about 2.0 dg/min to about 5.0 dg/min, or from 2.0 dg/min to about 6.0 dg/min, or from about 2.0 dg/min to about 8.0 dg/min, or from about 2.0 dg/min to about 10.0 dg/min, or from about 2.5 dg/min to about 10.0 dg/min, or from about 3.0 dg/min to about 10.0 dg/min, or from about 3.0 dg/min to about 8.0 dg/min, or from about 3.0 dg/min to about 6.0 dg/min, or from about 3.0 dg/min to about 5.0 dg/min.

In some embodiments, the high load melt index (I₂₁) of the ethylene polymer composition is from about 10 dg/min to about 10,000 dg/min, or from about 10 dg/min to about 1000 dg/min, or from about 10 dg/min to about 500 dg/min, or from about dg/min to about 250 dg/min, or from about 10 dg/min to about 150 g/10 min. In some embodiments, the melt flow ratio (I₂₁/I₂) of the ethylene polymer composition is from about 15 to about 1,000, or from about 15 to about 100, or from about to about 75, or from about 15 to about 50, or from about 15 to about 40, or from about 18 to about 50, or from about 20 to about 75, or from about 20 to about 50, or from about to about 45, or from about 20 to about 40, or from about 20 to about 38, or from about to about 35, or from about 24 to about 48, or from about 27 to about 45, or from about to about 42. In some embodiments, the melt flow ratio (I₂₁/I₂) of the ethylene polymer composition is from 20 to 50. In some embodiments, the melt flow ratio (I₂₁/I₂) of the ethylene polymer composition is less than about 45, or less than about 40, or less than about 35.

In some embodiments, the ethylene polymer composition has a weight average molecular weight (M_{w}) of from about 50 kg/mol to about 200 kg/mol, or from about 50 kg/mol to about 180 kg/mol, or from about 60 kg/mol to about 160 kg/mol, or from about 65 kg/mol to about 100 kg/mol, or from about 70 kg/mol to about 100 kg/mol, or from about 70 kg/mol to about 95 kg/mol, or from about 70 kg/mol to about 90 kg/mol.

In some embodiments, the ethylene polymer composition has a number average molecular weight (M_{w}) of from about 5 kg/mol to about 35 kg/mol, or from about kg/mol to about 35 kg/mol, or from about 10 kg/mol to about 30 kg/mol, or from about kg/mol to about 30 kg/mol, or from about 15 kg/mol to about 25 kg/mol.

In embodiments of the disclosure, the ethylene polymer composition has a lower limit molecular weight distribution (M_{w}/Mₙ) of 2.3, or 2.4, or 2.5, or 2.6. In embodiments of the disclosure, the ethylene polymer composition has an upper limit molecular weight distribution (M_{w}/Mₙ) of 6.0, or 5.5, or 5.0, or 4.5, or 4.0, or 3.75, or 3.5. In embodiments of the disclosure, the ethylene polymer composition has a molecular weight distribution (M_{w}/Mₙ) of from 2.3 to 6.0, or from 2.3 to 5.5, or from 2.3 to 5.0, or from 2.3 to 4.5, or from 2.3 to 4.0, or from 2.3 to 3.75, or from 2.3 to 3.5, or from 2.4 to 5.5, or from 2.4 to 5.0, or from 2.4 to 4.5, or from 2.4 to 4.0, or from 2.4 to 3.75, or from 2.4 to 3.5, or from 2.5 to 5.5, or from 2.5 to 5.0, or from 2.5 to 4.5, or from 2.5 to 4.0, or from 2.5 to 3.75, or from 2.5 to 3.5, or from 2.6 to 3.3. In some embodiments, the ethylene polymer composition has a molecular weight distribution (M_{w}/Mₙ) of from 2.3 to 5.0.

In embodiments of the disclosure, the ethylene polymer composition has a z-average molecular weight distribution, M_{z}/M_{w} of ≤4.0, or <4.0, or ≤3.5, or ≤3.5, or ≤3.0, or <3.0, or ≤2.75, or <2.75, or ≤2.50, or <2.50. In embodiments of the disclosure, the ethylene polymer composition has a z-average molecular weight distribution, M_{z}/M_{w} of from 1.5 to 4.0, or from 1.5 to 3.5, or from 1.75 to 3.5, or from 1.75 to 3.0, or from 1.75 to 2.5, or from 2.0 to 4.0, or from 2.0 to 3.5, or from 2.0 to 3.0, or from 2.0 to 2.75.

In an embodiment of the disclosure, the ethylene polymer composition has a unimodal profile in a gel permeation chromatograph generated according to the method of ASTM D6474-99. The term “unimodal” is herein defined to mean there will be only one significant peak or maximum evident in the GPC curve. A unimodal profile includes a broad unimodal profile. In contrast, the use of the term “bimodal” is meant to convey that in addition to a first peak, there will be a secondary peak or shoulder which represents a higher or lower molecular weight component (i.e., the molecular weight distribution, can be said to have two maxima in a molecular weight distribution curve). Alternatively, the term “bimodal” connotes the presence of two maxima in a molecular weight distribution curve generated according to the method of ASTM D6474-99. The term “multi-modal” denotes the presence of two or more, typically more than two, maxima in a molecular weight distribution curve generated according to the method of ASTM D6474-99.

In an embodiment of the disclosure, the ethylene polymer composition has a normal comonomer distribution profile as measured using GPC-FTIR. As used herein, if the comonomer incorporation monotonically decreases with molecular weight, as measured using GPC-FTIR, the distribution is described as “normal”.

In an embodiment of the disclosure, the ethylene polymer composition has a partially normal comonomer distribution profile as measured using GPC-FTIR. As used herein, if the comonomer incorporation decreases with increasing molecular weight and then rises with increasing molecular weight, as measured using GPC-FTIR, the distribution is described as “partially normal”. A partially normal comonomer distribution will exhibit a minimum.

In an embodiment of the disclosure, the ethylene polymer composition has a partially reverse comonomer distribution profile as measured using GPC-FTIR. As used herein, if the comonomer incorporation increases with increasing molecular weight and then declines with increasing molecular weight, as measured using GPC-FTIR, the distribution is described as “partially reverse”. A partially reverse comonomer distribution will exhibit a maximum.

The terms “normal” and “reverse” are used herein in contradistinction from the term “flat”. If the comonomer incorporation is approximately constant with molecular weight, as measured using GPC-FTIR, the comonomer distribution is described as “flat” or “uniform”.

In an embodiment, the ethylene polymer composition has a comonomer distribution profile in a GPC-FTIR analysis, wherein the comonomer distribution profile has a secant slope of greater than or equal (≥) to −55 short chain branches per 1000 carbons and less than or equal to (≥)−20 short chain branches per 1000 carbons. The secant slope is defined herein as the number of short chain branches per 1000 carbons at a molecular weight of 300,000 g/mol minus the number of short chain branches per 1000 carbons at a molecular weight of 30,000 g/mol. In further embodiments of the disclosure, the ethylene polymer composition has a comonomer distribution profile in a GPC-FTIR analysis, wherein the comonomer distribution profile has a secant slope of greater than or equal (≥) to −50 short chain branches per 1000 carbons and less than or equal to (≥)−20 short chain branches per 1000 carbons, or of greater than or equal (≥) to −45 short chain branches per 1000 carbons and less than or equal to (≥)−20 short chain branches per 1000 carbons, or of greater than or equal (≥) to −40 short chain branches per 1000 carbons and less than or equal to (≥)−20 short chain branches per 1000 carbons, or of greater than or equal (≥) to −35 short chain branches per 1000 carbons and less than or equal to (≥)−25 short chain branches per 1000 carbons.

In an embodiment of the disclosure, the ethylene polymer composition has a stress exponent, defined as log₁₀ (I₆/I₂)/log₁₀ (6.48/2.16), which is ≤1.60. In further embodiments of the disclosure, the ethylene polymer composition has a stress exponent, log₁₀ (I₆/I₂)/log₁₀ (6.48/2.16), of less than 1.55, or less than 1.50, or less than 1.45, or less than 1.40.

In some embodiments, the ethylene polymer composition has a dimensionless long chain branching factor (LCBF) of greater than or equal to (≥)0.001.

In some embodiments, the ethylene polymer composition has a dimensionless long chain branching factor (LCBF) of greater than or equal to (≥)0.001 and less than or equal to (≤)0.01.

In some alternative embodiments, the ethylene polymer composition has a VICAT softening temperature as measured using ASTM 1525-17 (Aug. 1, 2017) of greater than 85° C., or greater than 88° C.

### Flexible Manufactured Articles

The ethylene polymer compositions disclosed herein may be converted into flexible manufactured articles such as monolayer or multilayer films.

A non-limiting example of a process to prepare monolayer or multilayer films includes blown processes.

In the blown film extrusion process, an extruder heats, melts, mixes and conveys a thermoplastic or a blend of thermoplastics. Once molten, the thermoplastic is forced through an annular die to produce a thermoplastic tube. In the case of coextrusion, multiple extruders are employed to produce a multilayer thermoplastic tube. The temperature of the extrusion process is primarily determined by the thermoplastic or thermoplastic blend being processed, for example the melting temperature or glass transition temperature of the thermoplastic and the desired viscosity of the melt. In the case of polyolefins, typical extrusion temperatures are from 330° F. to 550° F. (166° C. to 288° C.). Upon exit from the annular die, the thermoplastic tube is inflated with air, cooled, solidified and pulled through a pair of nip rollers. Due to air inflation, the tube increases in diameter forming a bubble of desired size. Due to the pulling action of the nip rollers the bubble is stretched in the machine direction. Thus, the bubble is stretched in two directions: the transverse direction (TD) where the inflating air increases the diameter of the bubble; and the machine direction (MD) where the nip rollers stretch the bubble. As a result, the physical properties of blown films are typically anisotropic, i.e., the physical properties differ in the MD and TD directions; for example, film tear strength and tensile properties typically differ in the MD and TD. In some prior art documents, the terms “cross direction” or “CD” is used; these terms are equivalent to the terms “transverse direction” or “TD” used in this disclosure.

In the blown film process, air is also blown on the external bubble circumference to cool the thermoplastic as it exits the annular die. The final width of the film is determined by controlling the inflating air or the internal bubble pressure; in other words, increasing or decreasing bubble diameter. Film thickness is controlled primarily by increasing or decreasing the speed of the nip rollers to control the draw-down rate. After exiting the nip rollers, the bubble or tube is collapsed and may be slit in the machine direction thus creating sheeting. Each sheet may be wound into a roll of film. Each roll may be further slit to create film of the desired width. Each roll of film is further processed into a variety of consumer products as described below.

Another example of a process to prepare monolayer or multilayer films includes cast film processes.

The cast film process is similar in that a single or multiple extruder(s) may be used; however, the various thermoplastic materials are metered into a flat die and extruded into a monolayer or multilayer sheet, rather than a tube. In the cast film process, the extruded sheet is solidified on a chill roll.

In the cast film process, films are extruded from a flat die onto a chilled roll or a nipped roll, optionally, with a vacuum box and/or air-knife. The cast films may be monolayer or coextruded multi-layer films obtained by various extrusion through a single or multiple dies. The resultant films may be used as-is or may be laminated to other films or substrates, for example by thermal, adhesive lamination or direct extrusion onto a substrate. The resultant films and laminates may be subjected to other forming operations such as embossing, stretching, thermoforming. Surface treatments such as corona may be applied and the films may be printed.

Further examples of processes to prepare monolayer or multilayer films include laminations and coatings, wherein mono or multilayer films containing the disclosed ethylene polymer composition are extrusion laminated or adhesively laminated or extrusion coated. In extrusion lamination or adhesive lamination, two or more substrates are bonded together with a thermoplastic or an adhesive, respectively. In extrusion coating, a thermoplastic is applied to the surface of a substrate. These processes are well known to those skilled in the art. Frequently, adhesive lamination or extrusion lamination are used to bond dissimilar materials, non-limiting examples include the bonding of a paper web to a thermoplastic web, or the bonding of an aluminum foil containing web to a thermoplastic web, or the bonding of two thermoplastic webs that are chemically incompatible, e.g., the bonding of a ethylene interpolymer product containing web to a polyester or polyamide web. Prior to lamination, the web containing the disclosed ethylene interpolymer product(s) may be monolayer or multilayer. Prior to lamination the individual webs may be surface treated to improve the bonding, a non-limiting example of a surface treatment is corona treating. A primary web or film may be laminated on its upper surface, its lower surface, or both its upper and lower surfaces with a secondary web. A secondary web and a tertiary web could be laminated to the primary web; wherein the secondary and tertiary webs differ in chemical composition. As non-limiting examples, secondary or tertiary webs may include: polyamide, polyester and polypropylene, or webs containing barrier resin layers such as EVOH. Such webs may also contain a vapor deposited barrier layer; for example, a thin silicon oxide (SiOₓ) or aluminum oxide (AlOₓ) layer. Multilayer webs (or films) may contain three, five, seven, nine, eleven or more layers.

Depending on the end-use application, the disclosed ethylene polymer composition may be converted into monolayer or multilayer films that span a wide range of thicknesses. Non-limiting examples include food packaging films, where thicknesses may range from about 0.5 mil to about 10 mil.

The ethylene polymer composition disclosed herein may be used in monolayer films; where the monolayer film may contain more than one ethylene polymer composition as described herein and/or additional ethylene or non-ethylene polymers. The lower limit on the weight percent of the ethylene polymer composition in a monolayer film may be about 3 wt %, in other cases about 10 wt % and in still other cases about 30 wt %. The upper limit on the weight percent of the ethylene polymer composition in the monolayer film may be 100 wt %, in other cases about 90 wt % and in still other cases about 70 wt %.

The ethylene polymer composition disclosed herein may also be used in one or more layers of a multilayer film structure; non-limiting examples of multilayer films include three, five, seven, nine, eleven or more layers. The thickness of a specific layer (containing the ethylene polymer composition) within a multilayer film structure may be about 5%, in other cases about 13.5%, in other cases about 15%, in other cases about 20%, and in still other cases about 25% of the total multilayer film thickness. In other embodiments, the thickness of a specific layer (containing the ethylene polymer composition) within a multilayer film structure may be about 95%, in other cases about 80% and in still other cases about 65% of the total multilayer film structure thickness. Each individual layer of a multilayer film structure may contain more than one ethylene polymer composition and/or additional polyethylenes.

The ethylene polymer composition disclosed herein can be used in a wide range of manufactured articles comprising one or more films or film layers (monolayer or multilayer). A non-limiting example of such manufactured articles include food packaging films (fresh and frozen foods, liquids, powder and granular foods).

The films used in the manufactured articles described in this section may optionally include, depending on its intended use, additives and adjuvants. Non-limiting examples of additives and adjuvants include, anti-blocking agents, antioxidants, heat stabilizers, slip agents, processing aids, anti-static additives, colorants, dyes, filler materials, light stabilizers, light absorbers, lubricants, pigments, plasticizers, nucleating agents and combinations thereof.

An embodiment of the disclosure is an all polyethylene film layer comprising the ethylene polymer composition described herein.

In an embodiment, an all polyethylene film layer comprises greater than or equal to 90%, or 93%, or 95%, or 97%, or 99%, or 100% of one or more than one ethylene polymer based on the total weight of the film layer.

In an embodiment, an all polyethylene film layer is a blown film.

In an embodiment, an all polyethylene film layer is a cast film.

In embodiment, an all polyethylene film layer has a thickness of from 0.5 to mil.

In embodiment, an all polyethylene film layer further comprises a linear low density polyethylene LLDPE having a density of from 0.910 g/cm³ to 0.940 g/cm³ and a melt index I₂ of from 0.1 to 10 dg/min.

In embodiment, an all polyethylene film layer comprises from 10 to 40 weight percent of a linear low density polyethylene LLDPE and from 60 to 90 weight percent of the ethylene polymer composition described herein.

In an embodiment of the present disclosure a linear low density polyethylene LLDPE is an ethylene interpolymer comprising at least one α-olefin.

In embodiments of the disclosure, a linear low density polyethylene is an ethylene interpolymer comprising at least one C₃-C₂₀ α-olefins.

In embodiments of the disclosure, a linear low density polyethylene is an ethylene interpolymer comprising at least one of butene-1, hexene-1 and octene-1.

In an embodiment of the disclosure, a linear low density polyethylene is an ethylene interpolymer of ethylene and octene-1.

In embodiments of the disclosure, a linear low density polyethylene is an ethylene interpolymer of ethylene and at least one C₃-C₂₀ α-olefins and comprises at least 70 weight percent of ethylene, or at least 80 weight percent of ethylene, or at least 90 weight percent of ethylene.

In embodiments of the disclosure, a linear low density polyethylene is an ethylene interpolymer of ethylene and octene-1 and comprises at least 70 weight percent of ethylene, or at least 80 weight percent of ethylene, or at least 90 weight percent of ethylene.

In embodiments of the disclosure, a linear low density polyethylene has a density of from 0.910 g/cm³ to 0.940 g/cm³, or from 0.910 g/cm³ to 0.939 g/cm³, or from 0.910 g/cm³ to 0.936 g/cm³, or from 0.910 g/cm³ to 0.932 g/cm³, or from 0.912 g/cm³ to 0.940 g/cm³, or from 0.912 g/cm³ to 0.939 g/cm³, or from 0.912 g/cm³ to 0.936 g/cm³, or from 0.912 g/cm³ to 0.932 g/cm³, or from 0.914 g/cm³ to 0.930 g/cm³, or from 0.914 g/cm³ to 0.939 g/cm³, or from 0.914 g/cm³ to 0.936 g/cm³, or from 0.914 g/cm³ to 0.932 g/cm³, or from 0.916 g/cm³ to 0.940 g/cm³, or from 0.916 g/cm³ to 0.939 g/cm³, or from 0.916 g/cm³ to 0.936 g/cm³, or from 0.916 g/cm³ to 0.932 g/cm³, or from 0.910 g/cm³ to 0.930 g/cm³, or from 0.910 g/cm³ to 0.928 g/cm³, or from 0.910 g/cm³ to 0.926 g/cm³, or from 0.910 g/cm³ to 0.924 g/cm³, or from 0.912 g/cm³ to 0.930 g/cm³, or from 0.912 g/cm³ to 0.928 g/cm³, or from 0.912 g/cm³ to 0.926 g/cm³, or from 0.912 g/cm³ to 0.924 g/cm³, or from 0.914 g/cm³ to 0.930 g/cm³, or from 0.914 g/cm³ to 0.928 g/cm³, or from 0.914 g/cm³ to 0.926 g/cm³, or from 0.914 g/cm³ to 0.924 g/cm³.

In embodiments of the disclosure, a linear low density polyethylene has a melt index, I₂ of from 0.01 dg/min to 100 dg/min, or from 0.1 dg/min to 50 dg/min, or from 0.1 dg/min to 10 dg/min, or from 0.1 dg/min to 5 dg/min, or from 0.5 dg/min to 5 dg/min, or from 0.1 dg/min to 3 dg/min, or from 0.5 dg/min to 3 dg/min.

In embodiments, the linear low density polyethylene of the current disclosure can be a homogeneous ethylene interpolymer or heterogeneous ethylene interpolymer.

In embodiments of the disclosure, the linear low density polyethylene can be unimodal or multimodal.

In embodiments of the disclosure, the linear low density polyethylene has a molecular weight distribution, M_{w}/Mₙ of less titan 10.0, or less than 9.0, or less than 7.0, or less than 6.0, or less than 5.5, or less than 5.0, or less than 4.5, or less than 4.0, or less than 3.8. In some embodiments of the disclosure, the linear low density polyethylene has a M_{w}/Mₙ ratio of from 2.0 to 10.0, or from 2.0 to 8.0, or from 2.0 to 6.0, or from 2.0 to 5.5, or from 2.0 to 5.0, or from 2.0 to 4.5, or from 2.0 to 4.0, or from 2.2 to 6.0, or from 22 to 5.5, or from 2.2 to 5.0, or from 2.2 to 4.5, or from 2.2 to 4.0, or from 2.5 to 6.0, or from 2.5 to 5.5, or from 2.5 to 5.0, or from 2.5 to 4.5, or from 2.5 to 4.0. In still further embodiments of the disclosure, the linear low density polyethylene has a M_{w}/Mₙ ratio of from 3.0 to 5.5, or from 3.0 to 4.5, or from 3.0 to 4.0, or from 3.2 to 5.5, or from 3.2 to 5.0.

In embodiments of the disclosure, the linear low density polyethylene has a z-average molecular weight distribution, M_{z}/M_{w} of from 1.5 to 6.0. In further embodiments of the disclosure, the linear low density polyethylene has a M_{z}/Mₙ of from 1.5 to 5.5, or from 1.5 to 5.0, or from 1.5 to 4.0, or from 1.5 to 3.5, or from 1.5 to 3.0, or from 1.5 to 2.5.

In embodiments of the disclosure, the linear low density polyethylene can be made using a gas-phase, a solution-phase, or a slurry polymerization processes, or any combination thereof, using any type of reactor or reactor configuration known in the art, e.g., fluidized bed gas phase reactors, loop reactors, stirred tank reactors, batch reactors in parallel, series, and/or any combinations thereof.

In an embodiment of the disclosure, the linear low density polyethylene is made in a solution phase polymerization process.

In an embodiment of the disclosure, the linear low density polyethylene is made with a Ziegler-Natta catalyst.

In an embodiment of the disclosure, the linear low density polyethylene is made with a Ziegler-Natta catalyst in a solution phase polymerization process.

In embodiments of the disclosure, the linear low density polyethylene may contain conventional type additives, including (1) primary antioxidants (such as for example, hindered phenols, including vitamin E); (2) secondary antioxidants (such as for example, phosphites and phosphonites); and (3) process aids (such as for example, fluoroelastomer and/or polyethylene glycol bound process aid).

Still other additives that may be added to the linear low density polyethylene in embodiments of the disclosure include nitrones, antacids, UV absorbers, metal deactivators, pigments, dyes, fillers and reinforcing agents, nano-scale organic or inorganic materials, antistatic agents, lubricating agents such as calcium stearates, and slip additives such as erucimide and behenamide.

An embodiment of the disclosure is an all polyethylene multilayer film structure comprising at least one skin layer A comprising the ethylene polymer composition described herein.

In an embodiment, an all polyethylene multilayer film structure comprises greater than or equal to 90%, or 93%, or 95%, or 97%, or 99%, or 100% of one or more than one ethylene polymer based on the total weight of the multilayer film structure excluding the non-thermoplastic layers (if present).

In an embodiment, an all polyethylene multilayer film structure comprises a sublayer B adjacent to the skin layer A; the sublayer B comprising a high density polyethylene HDPE having a density of at least 0.945 g/cm³ and a melt index I₂ of from 0.1 to 10 dg/min.

In embodiments of the disclosure, a high density polyethylene has a density of greater than 0.940 g/cm³, or at least 0.941 g/cm³, or at least 0.945 g/cm³, or at least 0.949 g/cm³, or at least 0.950 g/cm³, or at least 0.955 g/cm³, or at least 0.960 g/cm³, or at least 0.965 g/cm³.

In embodiments of the disclosure, a high density polyethylene has a density of from 0.945 to 0.975 g/cm³, or from 0.945 to 0.970 g/cm³, or from 0.945 to 0.967 g/cm³, or from 0.949 to 0.975 g/cm³, or from 0.949 to 0.970 g/cm³, or from 0.949 to 0.967 g/cm³, or from 0.950 to 0.975 g/cm³, or from 0.950 to 0.970 g/cm³, or from 0.950 to 0.967 g/cm³, or from 0.955 to 0.975 g/cm³, or from 0.955 to 0.970 g/cm³, or from 0.955 to 0.967 g/cm³, or from 0.960 to 0.975 g/cm³, or from 0.960 to 0.970 g/cm³, or from 0.960 to 0.967 g/cm³.

In embodiments of the disclosure, a high density polyethylene has a melt index, I₂ of from 0.01 to 100 dg/min, or from 0.1 to 50 dg/min, or from 0.1 to 10 dg/min, or from 0.1 to 8 dg/min, or from 0.5 to 10 dg/min, or from 0.8 to 8 dg/min, or from 0.5 to 8 dg/min, or from 0.1 to 5 dg/min, or from 0.5 to 5 dg/min.

In embodiments of the disclosure, the high density polyethylene can be unimodal or multimodal.

In an embodiment of the disclosure, a high density polyethylene has a molecular weight distribution, M_{w}/Mₙ of from about 3.0 to about 20.0.

In an embodiment of the disclosure, a high density polyethylene has a molecular weight distribution, M_{w}/Mₙ of from about 7.0 to about 18.0.

In embodiments of the disclosure, a high density polyethylene can be made using any of the well-known catalysts capable of generating high density polyethylene, such as chromium catalysts, Ziegler-Natta catalysts and so called “homogeneous catalysts” such as but not limited to metallocene catalysts, constrained geometry catalysts, and phosphinimine catalysts.

In embodiments of the disclosure, the high density polyethylene can be made using a gas-phase, a solution-phase, or a slurry polymerization processes, or any combination thereof, using any type of reactor or reactor configuration known in the art, e.g., fluidized bed gas phase reactors, loop reactors, stirred tank reactors, batch reactors in parallel, series, and/or any combinations thereof.

In an embodiment of the disclosure, a high density polyethylene comprises from greater than 0 weight percent to 1 weight percent of a nucleating agent or a mixture of nucleating agents.

In an embodiment of the disclosure, a high density polyethylene comprises from 100 ppm (parts per million) to 3,000 ppm (parts per million) of a nucleating agent or a mixture of nucleating agents.

In an embodiment, a high density polyethylene HDPE is a blend of at least two ethylene homopolymer blend components; the blend comprising: from 30 to 95 weight percent of a first ethylene homopolymer blend component having a density of from 0.950 to 0.975 g/cm³; and from 5 to 70 weight parent of a second ethylene homopolymer blend component having a density of from 0.950 to 0.975 g/cm³; wherein the ratio of the melt index I₂ of the second ethylene homopolymer blend component to the melt index I₂ of the first ethylene homopolymer blend component is at least 10.

In an embodiment, the at least one skin layer A further comprises a linear low density polyethylene LLDPE having a density of from 0.910 g/cm³ to 0.940 g/cm³ and a melt index I₂ of from 0.1 to 10 dg/min.

In an embodiment, the at least one skin layer A comprises from 10 to 40 weight percent of an LLDPE and from 60 to 90 weight percent of the ethylene polymer composition described herein.

In an embodiment, an all polyethylene multilayer film structure has a seal initiation temperature of from greater than or equal to 70° C. to 115° C., wherein the seal initiation temperature is the minimum sealing temperature at which the film structure has a seal strength of greater than 3.4 N per 25.4 mm of seal width.

In some embodiments, the film structure has a seal strength of from 3.4 to 15.0 N per 25.4 mm of seal width at a sealing temperature of from SIT to SIT+40° C.

In some embodiments, the film structure has a seal strength of from 3.4 to 15.0 N per 25.4 mm of seal width at a sealing temperature of from SIT to SIT+25° C.

### General Testing Procedures

Prior to testing, each specimen was conditioned for at least 24 hours at 23±2° C. and 50±10% relative humidity and subsequent testing was conducted at 23=2° C. and 50=10% relative humidity. Herein, the term “ASTM conditions” refers to a laboratory that is maintained at 23±2° C. and 50±10% relative humidity; and specimens to be tested were conditioned for at least 24 hours in this laboratory prior to testing. ASTM refers to the American Society for Testing and Materials.

### Density

Ethylene polymer composition density in the solid state was determined using ASTM D792-13 (Nov. 1, 2013).

### Melt Index

Ethylene polymer composition melt index was determined using ASTM D1238 (Aug. 1, 2013). Melt indexes, I₂ was measured at 190° C., using a weight of 2.16 kg.

### VICAT Softening Temperature

The VIACT softening temperature of the disclosed Examples and Comparative Examples was measured using ASTM 1525-17 (Aug. 1, 2017) under a load of 10±0.2 N and at a heating rate of 120±10° C./h. Initial temperature of heat transfer medium (DOW Corning 710) was 20-23° C. In the present disclosure, unless indicated to the contrary, the VICAT softening temperature measurements were performed on compression molded specimens molded at 140° C. and at a cooling rate of 15 degrees per minute.

### Melt Strength

The melt strength is measured on Rosand RH-7 capillary rheometer (barrel diameter=15 mm) with a flat die of 2-mm Diameter, L/D ratio 10:1 at 190° C. Pressure Transducer: 10,000 psi (68.95 MPa). Piston Speed: 5.33 mm/min. Haul-off Angle: 52°. Haul-off incremental speed: 50-80 m/min2 or 65±15 m/min². A polymer melt sample is extruded through a capillary die under a constant rate and then the polymer strand is drawn at an increasing haul-off speed until it ruptures. The maximum steady value of the force in the plateau region of a force versus time curve is defined as the melt strength for the polymer.

### Differential Scanning Calorimetry

Melting endotherms were obtained using differential scanning calorimetry (DSC) as follows: the instrument was first calibrated with indium; after the calibration, a polymer specimen is equilibrated at 0° C. and then the temperature was increased to 200° C. at a heating rate of 10° C./min; the melt was then kept isothermally at 200° C. for five minutes; the melt was then cooled to 0° C. at a cooling rate of 10° C./min and kept at 0° C. for five minutes; the specimen was then heated to 200° C. at a heating rate of 10° C./min. The obtained heat flow signal during the second heating cycle was then plotted as a function of temperature.

### Small Amplitude Oscillatory Shear Rheology

Oscillatory shear measurements under small-strain amplitudes were carried out to obtain linear viscoelastic functions at 190° C. under nitrogen atmosphere, at a strain amplitude of 10% and over a frequency range of 0.02-126 rad/s at 5 points per decade. Frequency sweep experiments were performed with a TA Instruments DHR3 stress-controlled rheometer using cone-plate geometry with a cone angle of 5°, a truncation of 137 μm and a diameter of 25 mm. In this experiment a sinusoidal strain wave was applied, and the stress response was analyzed in terms of linear viscoelastic functions. The zero-shear rate viscosity (no) based on the small amplitude oscillatory shear measurements was determined by fitting a four-parameter Carreau-Yasuda (CY) viscosity model into the complex viscosity versus angular frequency defined by:

$$\vert {η}^{*} \vert = {{η}_{0} [ 1 + {( {τ}_{c} ω )}^{a} ]}^{\frac{n - 1}{a}} \qquad eq . ( 1 )$$

in which |η*| is complex viscosity measured as a function of angular frequency Ω, a (or CY-a as referred to in the EXAMPLES section) is a parameter determining the breadth of transition from a Newtonian plateau to shear-thinning region with a slope of n−1 in a log-log plot. In the present disclosure the parameter n is set to a constant value of 2/11 and rest of model parameters were fitted by a least square method.

### Long Chain Branching Factor (LCBF)

The LCBF (dimensionless) was determined for the ethylene polymer composition using the method described in U.S. Pat. Appl. Pub. No. 2018/0305531 which is incorporated herein by reference.

In the present disclosure, a long chain branch has a molecular weight equal to, or greater than, the entanglement molecular weight, Me. Me is a well-known concept in polymer physics (e.g., reported to be about 1 kg/mol for polyethylenes, see Fetters et al., Macromolecules 1999, 32, 6847). In this disclosure, long chain branches were characterized as “rheologically active”. The term “rheologically active” means the presence of long chain branches in a sample was evident after comparing rheological test results with a comparative sample that did not contain long chain branches. Non-limiting examples of rheological test results include, flow activation energy (Eₐ), shear thinning or viscosity ratios, melt flow ratios (I₂₁/I₂, I₁₀/I₂, etc.), melt strength and long chain branching factor (LCBF), etc.

LCBF calculation involved calculating a polydispersity corrected zero-shear viscosity (ZSV_{c}) and a SCB corrected intrinsic viscosity (IV_{c}). The polydispersity correction applied to the zero-shear viscosity, ZSV_{c}, had dimensions of Poise, and was performed as shown in equation eq. (2):

$${ZSV}_{c} = \frac{1.8389 \times {η}_{0}}{2.411 {0}^{Ln ( Pd )}} \qquad eq . ( 2 )$$

in which η₀, the zero-shear viscosity (Poise), was measured by a dynamic mechanical analysis test procedure (see the testing procedure under the heading “Small Amplitude Oscillatory Shear Rheology”); Pd was the dimensionless polydispersity (i.e., M_{w}/Mₙ) as measured using conventional SEC (see the testing procedure under the heading “Conventional Size Exclusion Chromatography”); 1.8389 and 2.4110 were dimensionless constants.

Calculation of the SCB-corrected intrinsic viscosity IV_{c} (having dimensions of dL/g) was performed as shown in equation eq. (3),

$${IV}_{c} = [ η ] + \frac{A \times SCB \times {M}_{v}^{0.725}}{1000000} \qquad eq . ( 3 )$$

in which the intrinsic viscosity [η] (dL/g) was measured using 3D-SEC (see the testing procedure under the heading “Triple Detection Size Exclusion Chromatography”), SCB having dimensions of (CH₃/1000 C) which was determined using FTIR (see the testing procedure under the heading “Comonomer Cotent: Fourier Transform Infrared Spectroscopy”), and the viscosity average molar mass Mv (g/mole) was determined using 3D-SEC (see testing procure under the heading “Triple Detection Size Exclusion Chromatography”). The comonomer dependent constant A was defined above in the context of eq. (3). In the case of an ethylene homopolymer no correction is required for the Mark-Houwink constant, i.e., SCB is zero.

Non-long chain branched ethylene polymer compositions (i.e., ethylene polymer compositions which do not contain LCB or undetectable levels of LCB) fall on a “reference line” as defined by the following equation.

$$Log ( {IV}_{c} ) = 0.2100 \times Log ( {ZSV}_{c} ) - 0 \text{.7879} \qquad eq . ( 4 )$$

The calculation of the LCBF was based on horizontal (Sₕ) and vertical (Sᵥ) shifts from the above-described linear reference line, as laid out by the following equations:

$${S}_{h} = Log ( {ZSV}_{c} ) - 4.7619 \times Log ( {IV}_{c} ) - 3 \text{.7519} \qquad eq . ( 5 )$$

$${S}_{v} = 0.2100 \times Log ( {ZSV}_{c} ) - Log ( {IV}_{c} ) - 0.7879 \qquad eq . ( 6 )$$

In eq. (5) and eq. (6), it was required that the polydispersity corrected zero-shear viscosity ZSV_{c} and the SCB corrected intrinsic viscosity IV_{c} have dimensions of Poise and dL/g, respectively. The horizontal shift factor (Sₕ) was a shift in ZSV_{c} at a constant IV_{c}. If one removes the Log function its physical meaning is apparent, i.e., a ratio of two ZSV_{c}s, i.e., the ZSV_{c} of the sample under test relative to the ZSV_{c} of a linear ethylene polymer composition having the same IV_{c}. The horizontal shift factor (Sₕ) was dimensionless.

The vertical shift (Sᵥ) was a shift in IV_{c} at a constant ZSV_{c}. Again, if one removes the Log function its physical meaning is apparent, i.e., a ratio of two IVes of a linear ethylene polymer compositipn having the same ZSV_{c} relative to the IV_{c} of the sample under test. The vertical shift factor (Sᵥ) was dimensionless.

Finally, in the present disclosure a dimensionless long chain branching factor (LCBF) was defined by eq. (7):

$$LCBF = \frac{{S}_{h} \times {S}_{v}}{2} \qquad eq . ( 7 )$$

### Comonomer Content: Fourier Transform Infrared (FTIR) Spectroscopy

The quantity of comonomer in an ethylene polymer composition was determined by FTIR and reported as the Short Chain Branching (SCB) content having dimensions of CH₃/1000 C (number of methyl branches per 1000 carbon atoms). This test was completed according to ASTM D6645-01 (2001), employing a compression molded polymer plaque and a Thermo-Nicolet 750 Magna-IR Spectrophotometer. The polymer plaque was prepared using a compression molding device (Wabash-Genesis Series press) according to ASTM D4703-16 (April 2016).

### Triple Detection Size Exclusion Chromatography (3D-SEC)

Polymer solutions (1 to 3 mg polymer/mL) were prepared by heating the ethylene polymer composition sample in 1,2,4-trichlorobenzene (TCB) and rotating on a wheel for 4 hours at 150° C. in an oven. An antioxidant, 2,6-di-tert-butyl-4-methylphenol (BHT), was added to the mixture to stabilize the polymer sample against oxidative degradation. The BHT concentration was 250 ppm. Sample solutions were chromatographed at 140° C. on a PL 220 high temperature chromatography unit equipped with a differential refractive index (DRI) detector, a dual-angle light scattering detector (15 and 90 degree) and a differential viscometer. The SEC columns used were either four SHODEX® columns (HT803, HT804, HT805 and HT806), or four PL Mixed ALS or BLS columns. TCB was the mobile phase with a flow rate of 1.0 mL/minute, BHT was added to the mobile phase at a concentration of 250 ppm to protect SEC columns from oxidative degradation. The sample injection volume was 200 μL. The SEC raw data were processed with the CIRRUS® GPC software, to produce absolute molar masses and intrinsic viscosity ([η]) and viscosity average molar mass (Mv). The term “absolute” molar mass was used to distinguish 3D-SEC determined absolute molar masses from the molar masses determined by conventional SEC. The viscosity average molar mass (Mv) and intrinsic viscosity ([η]) determined by 3D-SEC were used in calculations to determine the long chain branching factor (LCBF).

### Conventional Size Exclusion Chromatography (SEC)

Polymer solutions (1 to 3 mg/mL) were prepared by heating the polymer in 1,2,4-trichlorobenzene (TCB) and rotating on a wheel for 4 hours at 150° C. in an oven. An antioxidant, 2,6-di-tert-butyl-4-methylphenol (BHT), was added to the mixture in order to stabilize the polymer against oxidative degradation. The BHT concentration was 250 ppm. Polymer solutions were chromatographed at 140° C. on a PL 220 high-temperature chromatography unit equipped with four Shodex columns (HT803, HT804, HT805 and HT806) using TCB as the mobile phase with a flow rate of 1.0 mL/minute, with a differential refractive index (DRI) as the concentration detector. BHT was added to the mobile phase at a concentration of 250 ppm to protect GPC columns from oxidative degradation. The sample injection volume was 200 μL. The GPC columns were calibrated with narrow distribution polystyrene standards. The polystyrene molecular weights were converted to polyethylene molecular weights using the Mark-Houwink equation, as described in the ASTM standard test method D6474-12 (December 2012). The GPC raw data were processed with the CIRRUS GPC software, to produce molar mass averages (Mₙ, M_{w}, M_{z}) and molar mass distribution (e.g., Polydispersity, M_{w}/Mₙ). In the polyethylene art, a commonly used term that is equivalent to SEC is GPC, i.e., Gel Permeation Chromatography.

### GPC-FTIR

Polymer solutions were prepared by heating 2 to 4 mg/mL of the ethylene polymer composition sample in 1,2,4-trichlorobenzene (TCB) and rotating on a wheel for 4 hours at 150° in an oven. The antioxidant 2,6-di-tert-butyl-4-methylphenol (BHT) was added to the mixture in order to stabilize the polymer against oxidative degradation. The BHT concentration was 250 ppm. Sample solutions were chromatographed at 140° C. on a Waters GPC 150C chromatography unit equipped with four SHODEX columns (HT803, HT804, HT805 and HT806) using TCB as the mobile phase with a flow rate of 1.0 mL/minute, with a FTIR spectrometer and a heated FTIR flow through cell coupled with the chromatography unit through a heated transfer line as the detection system. BHT was added to the mobile phase at a concentration of 250 ppm to protect SEC columns from oxidative degradation. The sample injection volume was 300 μL. The raw FTIR spectra were processed with OPUS FTIR software, and the polymer concentration and methyl content were calculated in real time with the Chemometric Software (PLS technique) associated with the OPUS. Then the polymer concentration and methyl content were acquired and baseline-corrected with the CIRRUS GPC software. The SEC columns were calibrated with narrow distribution polystyrene standards. The polystyrene molecular weights were converted to polyethylene molecular weights using the Mark-Houwink equation, as described in the ASTM standard test method D6474. The comonomer content was calculated based on the polymer concentration and methyl content predicted by the PLS technique as described in Paul J. DesLauriers, Polymer 43, pages 159-170 (2002); herein incorporated by reference.

The GPC-FTIR method measures total methyl content, which includes the methyl groups located at the ends of each macromolecular chain, i.e., methyl end groups. Thus, the raw GPC-FTIR data must be corrected by subtracting the contribution from methyl end groups. To be clear, the raw GPC-FTIR data overestimates the amount of short chain branching (SCB) and this overestimation increases as molecular weight decreases. In this disclosure, raw GPC-FTIR data was corrected using the 2-methyl correction. At a given molecular weight (M), the number of methyl end groups (NE) was calculated using the following equation; NE=28000/M, and NE (M dependent) was subtracted from the raw GPC-FTIR data to produce the SCB per 1000 carbon atoms (2-Methyl corrected) GPC-FTIR data.

The slope of the comonomer distribution is determined using GPC-FTIR and is defined by SCB per 1000 Cs at a molecular weight of 300,000 (g/mol)—SCB per 1000 Cs at a molecular weight of 30,000 g/mol where “−” is a minus sign, SCB per 1000 Cs is the 2-methyl corrected comonomer content determined as the number of short chain branches per thousand carbons at the corresponding molecular weight (i.e., the absolute molecular weight) on a GPC-FTIR chromatograph.

### Film Heat Seal Strength

In this disclosure, the “Heat Seal Strength Test” (also known as “the cold seal test”) was performed as follows. Heat seal data was generated using a conventional Instron Tensile Tester. In this test, two film samples are sealed over a range of temperatures in which the two film samples were cut from the same roll. The following parameters were used in the Heat Seal Strength (or cold seal) Test: film specimen width, 1 inch (25.4 mm); film sealing time, 0.5 second; film sealing pressure, 40 psi (0.28 N/mm²); temperature range, 212° F. to 302° F. (100° C. to 150° C.) and temperature increment, 9° F. (5° C.). After aging for at least 24 hours at ASTM conditions, seal strength was determined using the following tensile parameters: pull (crosshead) speed; 12 inch/min (2.54 cm/min); direction of pull 90° to seal; and 5 samples of film were tested at each temperature increment.

### EXAMPLES

### Solution Polymerization Process

The reactor blend ethylene polymer compositions in Examples 1-3 were each made in a pilot-scale “in-series” multi-reactor solution polymerization process where the ethylene polymer composition was made by forming first ethylene polymer in a first reactor (R1); forming a second ethylene interpolymer in a second reactor (R2); and forming a third ethylene interpolymer in a third reactor (R3), where R1, R2 and R3 were configured in series with one another. An “in series” “multi-reactor, solution phase polymerization process has been described in U.S. Pat. Appl. Pub. No. 2019/0135958.

In an “in-series” reactor system the exit stream from a first polymerization reactor (R1) flows directly into a second polymerization reactor (R2). The R1 pressure was from about 14 MPa to about 18 MPa; while R2 was operated at a lower pressure to facilitate continuous flow from R1 to R2. Both R1 and R2 were continuously stirred reactors (CSTRs). The third reactor, R3 was a tubular reactor configured in series with the second reactor, R2 (i.e., the contents of reactor 2 flowed into reactor 3). The process was operated continuously by feeding fresh process solvent, ethylene, octene-1 and hydrogen to the first and second reactors and in the removal of product. Methylpentane was used as the process solvent (a commercial blend of methylpentane isomers). The volume of the first CSTR reactor (R1) was 3.2 gallons (12 L), and the volume of the second CSTR reactor (R2) was 5.8 gallons (22 L). The volume of the tubular reactor (R3) was 4.755 gallons (18 L). Monomer (ethylene) and comonomer (octene-1) were purified prior to addition to the reaction using conventional feed preparation systems (such as contact with various absorption media to remove impurities such as water, oxygen and polar contaminants). The reactor feeds were pumped to the reactors at the ratios shown in Table 1.

Table 1 shows the reactor conditions used to make each of the ethylene polymer compositions in Examples 1-3. Table 1 includes process parameters, such as the ethylene and octene-1 splits between the reactors (R1, R2 and R3), the reactor temperatures, the ethylene conversions, the amounts of hydrogen, ethylene and octene-1 concertation in the fresh feed to reactors, fresh feed total solution rates, CSTR reactors (R1 and R2) agitation speeds, etc.

In Examples 1 and 2, the following unbridged single site catalyst components were used to prepare the first ethylene polymer in the first CSTR reactor (R1): component C, cyclopentadienyl tri(tertiary butyl)phosphinimine titanium dichloride {Cp[(t-Bu)₃PN]TiCl₂}; component M, methylaluminoxane (MMAO-07); component B, trityl tetrakis(pentafluoro-phenyl)borate, and; component P, 2,6-di-tert-butyl-4-ethylphenol. The following catalyst component solvents were used: methylpentane for components M and P; and xylene for component C and B. The efficiency of the unbridged single site catalyst formulation was optimized by adjusting the quantity of component C added to R1 [R1 catalyst (ppm) as recited in Table 1], the mole ratios of the catalyst components—i.e., [M]/[C], [P]/[M] and [B]/[C] as tabulated in Table 1—and the R1 catalyst inlet temperature.

In Examples 1 and 2, the following bridged metallocene catalyst components were used to prepare the second ethylene interpolymer in the second CSTR reactor (R2): component A, diphenylmethylene(cyclopentadienyl)(2,7-di-t-butylfuorenyl)hafnium dimethide [(2,7-tBu₂Flu)Ph₂C(Cp)HfMe₂]; component M, methylaluminoxane (MMAO-07); component B, trityl tetrakis(pentafluoro-phenyl)borate (trityl borate); and component P, 2,6-di-tert-butyl-4-ethylphenol (BHEB). Methylaluminoxane (MMAO-07); and 2,6-di-tert-butyl-4-ethylphenol are premixed in-line and then combined with diphenylmethylene(cyclopentadienyl)(2,7-di-t-butylfuorenyl)hafnium dimethide and trityl tetrakis(pentafluoro-phenyl)borate just before entering the polymerization reactor (R2). The following catalyst component solvents were used: methylpentane for components M and P; and xylene for component A and B. The efficiency of the bridged metallocene catalyst formulation was optimized by adjusting the quantity of component A added to R2 [R2 catalyst (ppm) as recited in Table 1], the mole ratios of the catalyst components—i.e., [M]/[A], [P]/[M] and [B]/[A] as tabulated in Table 1—and the R2 catalyst inlet temperature.

In Example 3, the following bridged metallocene catalyst components were used to prepare the first ethylene polymer in the first CSTR reactor (R1) and to prepare the second ethylene interpolymer in the second CSTR reactor (R2): component A, diphenylmethylene(cyclopentadienyl)(2,7-di-t-butylfuorenyl)hafnium dimethide [(2,7-tBu₂Flu)Ph₂C(Cp)HfMe₂]; component M, methylaluminoxane (MMAO-07); component B, trityl tetrakis(pentafluoro-phenyl)borate (trityl borate); and component P, 2,6-di-tert-butyl-4-ethylphenol (BHEB). Methylaluminoxane (MMAO-07); and 2,6-di-tert-butyl-4-ethylphenol are premixed in-line and then combined with diphenylmethylene(cyclopentadienyl)(2,7-di-t-butylfuorenyl)hafnium dimethide and trityl tetrakis(pentafluoro-phenyl)borate just before entering the polymerization reactors (R1 and R2). The following catalyst component solvents were used: methylpentane for components M and P; and xylene for component A and B. The efficiency of the bridged metallocene catalyst formulation was optimized by adjusting the quantity of component A added to R1 and R2 [R1 catalyst (ppm) and R2 catalyst (ppm) as recited in Table 1], the mole ratios of the catalyst components—i.e., [M]/[A], [P]/[M] and [B]/[A] as tabulated in Table 1—and the R1 and R2 catalyst inlet temperatures.

In operating the continuous solution polymerization process shown in Table 1, the total amount of ethylene supplied to the process were portioned or split between the three reactors R1, R2 and R3. In Table 1, this operational variable was called the ethylene split (ES), i.e., ES^{R1}, ES^{R2} and ES^{R3} referred to the weight percent of ethylene injected in R1, R2 and R3, respectively; with the proviso that ES^{R1}+ES^{R2}+ES^{R3}=100%. Octene-1 was also added to the continuous solution polymerization process and was proportioned or split between R1, R2 and R3. In Table 1, this operational variable was called the octene-1 split (OS), i.e., OS^{R1}, OS^{R2} and OS^{R3} referred to the weight percent of octene-1 comonomer that was injected in R1, R2 and R3, respectively; with the proviso that OS^{R1}+OS^{R2}+OS^{R3}=100%.

In Examples 1-3, no fresh ethylene, octene-1, hydrogen and catalyst were pumped into the third reactor—e.g., ES^{R3} and OS^{R3} were zero. The residual ethylene, residual octene-1 and residual active catalyst(s) entering the third reactor (R3), from upstream reactors R1 and R2, formed the third ethylene interpolymer in these Examples.

In operating the continuous solution polymerization process shown in Table 1, the total amount of ethylene converted in each reactor is monitored. The term Q^{R1} referred to the percent of the ethylene added to R1 that was converted into a first ethylene polymer by the catalyst formulation. Similarly, Q^{R2} and Q^{R3} represented the percent of the ethylene added to R2 and residual ethylene flown into R3 from R1 and R2 that were converted into the second and third ethylene interpolymer, respectively.

In Table 1, the term Q^{T} represented the total or overall ethylene conversion across the entire continuous solution polymerization plant; i.e., Q^{T}=100×[weight of ethylene in the ethylene polymer composition]/([weight of ethylene in the ethylene polymer composition]+[weight of unreacted ethylene]).

Polymerization in the continuous solution polymerization process was terminated by adding a catalyst deactivator to the third exit stream exiting the tubular reactor (R3). The catalyst deactivator used was octanoic acid (caprylic acid), commercially available from P&G Chemicals, Cincinnati, OH, U.S.A. The catalyst deactivator was added such that the moles of fatty acid added were 50% of the total molar amount of catalytic metal and aluminum added to the polymerization process; to be clear, the moles of octanoic acid added=0.5×(moles hafnium+moles aluminum).

A two-stage devolatilization process was employed to recover the ethylene polymer composition from the process solvent, i.e., two vapor/liquid separators were used, and the second bottom stream (from the second V/L separator) was passed through a gear pump/pelletizer combination. The gear pump was a Vacorex 45/45 pump with 191 liter per hour capacity which was steam jacketed with 270 #steam. The ethylene polymer composition leaving the gear pump was then passed through a 4″ diameter static mixer before entering the pelletizer where the ethylene polymer composition was forced through the holes in the die plate top down. There were 32 holes on the die with a hole diameter of 0.125″. The aspect ratio (i.e., length-to-diameter ratio) for each hole was 6.3:1 and the die had a thickness of 1.63″ and a diameter of 12″. There were 6 cutter knives-8.6878″ OD sweep and 6.2418 ID sweep-located on the side of the die that faced the cooling water system. There were internal heating channels within the die plate and die body and plate were heated with 600 #or 270 #steam. Cooling water system had a temperature range of from 10 to 80° C. and a flow of 7500-9500 kg/h.

DHT-4V (hydrotalcite), supplied by Kyowa Chemical Industry Co. LTD, Tokyo, Japan may be used as a passivator, or acid scavenger, in the continuous solution process. A slurry of DHT-4V in process solvent may be added prior to the first V/L separator.

Prior to pelletization, the ethylene polymer composition was stabilized by adding 500 ppm of IRGANOX® 1076 (a primary antioxidant) and 500 ppm of IRGAFOS® 168 (a secondary antioxidant), based on weight of the ethylene polymer composition. Antioxidants were dissolved in process solvent and added between the first and second V/L separators.

The M_{w}, Mₙ, M_{w}/Mₙ, weight percent, the SCB per 1000 carbon atoms of each component made in R1, R2 and R3 were calculated and shown in Table 2a using a reactor model simulation using the input conditions which were employed for actual pilot scale run conditions. For references on relevant reactor modeling methods, see “Copolymerization” by A. Hamielec, J. MacGregor, and A. Penlidis in Comprehensive Polymer Science and Supplements, volume 3, Chapter 2, page 17, Elsevier, 1996 and “Copolymerization of Olefins in a Series of Continuous Stirred-Tank Slurry-Reactors using Heterogeneous Ziegler-Natta and Metallocene Catalysts. I. General Dynamic Mathematical Model” by J. B. P Soares and A. E Hamielec in Polymer Reaction Engineering, 4 (2&3), p 153, 1996.

The model takes for input the flow of several reactive species (e.g., catalyst, monomer such as ethylene, comonomer such as octene-1, hydrogen, and solvent) going to each reactor, the temperature (in each reactor), and the conversion of monomer (in each reactor) and calculates the polymer properties (of the polymer made in each reaction zone) using a terminal kinetic model for continuously stirred tank reactors (CSTRs) connected in series. The “terminal kinetic model” assumes that the kinetics depend upon the monomer unit within the polymer chain on which the active catalyst site is located—see “Copolymerization” by A. Hamielec, J. MacGregor, and A. Penlidis in Comprehensive Polymer Science and Supplements, Volume 3, Chapter 2, page 17, Elsevier, 1996. In the model, the copolymer chains are assumed to be of reasonably large molecular weight to ensure that the statistics of monomer/comonomer unit insertion at the active catalyst center is valid and that monomers/comonomers consumed in routes other than propagation are negligible. This is known as the “long chain” approximation.

The terminal kinetic model for polymerization includes reaction rate equations for activation, initiation, propagation, chain transfer, and deactivation pathways. This model solves the steady-state conservation equations (e.g., the total mass balance and heat balance) for the reactive fluid which comprises the reactive species identified above. The total mass balance for a generic CSTR with a given number of inlets and outlets is given by:

$$0 = {\sum }_{i} {\dot{m}}_{i} \qquad ( eq . 8 )$$

where \dot{m}ᵢ represents the mass flow rate of individual streams with index i indicating the inlet and outlet streams. Equation 8 can be further expanded to show the individual species and reactions:

$$0 = \frac{{Σ}_{i} m {\dot{x}}_{ι j} / {M}_{i}}{{ρ}_{mix} V} + {R}_{j} / {ρ}_{mix} \qquad ( eq . 9 )$$

where Mᵢ is the average molar weight of the fluid inlet or outlet i, xᵢⱼ is the mass fraction of species j in stream i, ρₘᵢₓ is the molar density of the reactor mixture, V is the reactor volume, Rⱼ is the reaction rate for species j, which has units of kmol/m³s. The total heat balance is solved for an adiabatic reactor and is given by:

$$0 = ( \sum {\dot{m}}_{i} Δ {H}_{i} + {q}_{R x} V + \dot{W} - \dot{Q} ) \qquad ( eq . 10 )$$

where, \dot{m}ᵢ is the mass flow rate of stream i (inlet or outlet), ΔHᵢ is the difference in enthalpy of stream i versus a reference state, q_{Rx} is the heat released by reaction(s), V is the reactor volume, Ŵ is the work input (i.e., agitator), \dot{Q} is the heat input/loss. The catalyst concentration input to each reactor is adjusted to match the experimentally determined ethylene conversion and reactor temperature values in order solve the equations of the kinetic model (e.g., propagation rates, heat balance and mass balance). The H₂ concentration input to each reactor may be likewise adjusted so that the calculated molecular weight distribution of a polymer made over all reactors (and, hence, the molecular weight of polymer made in each reactor) matches that which is observed experimentally.

Reported weight percent values shown in Table 2a are such that the sum of the weight percent of the material made in R1, R2 and R3 is at 100 percent.

The degree of polymerization (dpₙ) for a polymerization reaction is given by the ratio of the rate of chain propagation reactions over the rate of chain transfer/termination reactions:

$${dp}_{n} = \frac{{k}_{p 11} {ϕ}_{1} [ {m}_{1} ] + {k}_{p 12} {ϕ}_{1} [ {m}_{2} ] + {k}_{p 21} {ϕ}_{2} [ {m}_{2} ]}{\begin{matrix}{k}_{tm 11} [ {m}_{1} ] {ϕ}_{1} + {k}_{tm 12} [ {m}_{2} ] {ϕ}_{1} + \\ {k}_{tm 21} [ {m}_{2} ] {ϕ}_{2} + {k}_{ts 1} {ϕ}_{1} + {k}_{ts 2} {ϕ}_{2} + {k}_{tH 1} [ H ] + {k}_{tH 2} [ H ]\end{matrix}} = \frac{{R}_{p}}{{R}_{t}} \qquad ( eq . 11 )$$

where kₚ₁₂ is the propagation rate constant for adding monomer 2 (octene-1) to a growing polymer chain ending with monomer 1 (ethylene), [m₁] is the molar concentration of monomer 1 in the reactor, [m₂] is the molar concentration of monomer 2 in the reactor, kₜₘ₁₂ the termination rate constant for chain transfer to monomer 2 for a growing chain ending with monomer 1, kₜₛ₁ is rate constant for the spontaneous chain termination for a chain ending with monomer 1, k_{tH1} is the rate constant for the chain termination by hydrogen for a chain ending with monomer 1. φ₁ and φ₂ and the fraction of catalyst sites occupied by a chain ending with monomer 1 or monomer 2 respectively.

TABLE 1
Continuous Solution Polymerization Process
Parameters for Examples 1-3.

| | Ex. 1 | Ex. 2 | Ex. 3 |
|---|---|---|---|
| R1 catalyst (ppm) | 0.11 | 0.17 | 0.26 |
| R1 catalyst | PIC* | PIC* | CpF^{†} |
| R1 ([M]/[A]) mole ratio | — | — | 51 |
| R1 ([P]/[M]) mole ratio | — | — | 0.43 |
| R1 ([B]/[A]) mole ratio | — | — | 1.31 |
| R1 ([M]/[C]) mole ratio | 50 | 50 | — |
| R1 ([P]/[M]) mole ratio | 0.54 | 0.49 | — |
| R1 ([B]/[C]) mole ratio | 1.30 | 1.31 | — |
| R1 catalyst diluent temperature (° C.) | 29.6 | 34.1 | 36.3 |
| R2 catalyst (ppm) | 0.86 | 0.78 | 0.56 |
| R2 catalyst | CpF^{†} | CpF^{†} | CpF^{†} |
| R2 ([M]/[A]) mole ratio | 50 | 50 | 50 |
| R2 ([P]/[M]) mole ratio | 0.3 | 0.40 | 0.40 |
| R2 ([B]/[A]) mole ratio | 1.30 | 1.30 | 1.30 |
| R2 catalyst diluent temperature (° C.) | 38.4 | 35.8 | 37.8 |
| ES^{R1} (%) | 45.0 | 45.0 | 45.0 |
| ES^{R2} (%) | 55.0 | 55.0 | 55.0 |
| R1 ethylene concentration (wt %) | 11.2 | 10.6 | 10.8 |
| R2 ethylene concentration (wt %) | 12.5 | 11.3 | 11.9 |
| Octene-1 to ethylene ratio R1 (wt. fraction) | 0 | 0 | 0 |
| Octene-1 to ethylene ratio R2 (wt. fraction) | 1.16 | 0.948 | 0.87 |
| Octene-1 to ethylene ratio (wt. fraction, | 0.634 | 0.520 | 0.480 |
| total) | | | |
| Polymer Production Rate (kg/h) | 68.6 | 61.9 | 73.2 |
| R1 total solution rate (kg/h) | 273.8 | 263.9 | 272.7 |
| R2 total solution rate (kg/h) | 276.2 | 286.1 | 277.3 |
| Total solution rate (kg/h) | 550.0 | 550.0 | 550.0 |
| OS^{R1} (%) | 0.0 | 0.0 | 0.0 |
| OS^{R2} (%) | 100.0 | 100.0 | 100.0 |
| H₂ Concentration in R1 (ppm) | 2.50 | 2.50 | 5.00 |
| H₂ Concentration in R2 (ppm) | 1.00 | 1.00 | 1.00 |
| R1 Fresh feed temperature (° C.) | 35.0 | 40.0 | 40.0 |
| R2 Fresh feed temperature (° C.) | 35.0 | 42.0 | 42.4 |
| R1 Mean temp (° C.) | 159.7 | 163.2 | 165.2 |
| R2 Mean temp (° C.) | 184.9 | 175.0 | 180.1 |
| R3 Outlet temperature (° C.) | 192.1 | 184.3 | 190.7 |
| R3 volume (L) | 18 | 18 | 18 |
| Q^{R1} (%) | 89.9 | 89.9 | 90.0 |
| Q^{R2} (%) | 77 | 73.0 | 74.0 |
| Q^{R3} (%) | 50 | 61.9 | 66.2 |
| Q^{T} (%) | 93.1 | 93.9 | 94.8 |
| R1 Agitator speed (rpm) | 325.0 | 325.0 | 646.0 |
| R2 Agitator speed (rpm) | 260.0 | 260.0 | 260.0 |

*Cp[(t-Bu)₃PN]TiCl₂; and ^{†}(2,7-tBu₂Flu)Ph₂C(Cp)HfMe₂.

The number average molecular weight (Mₙ) for a polymer follows from the degree of polymerization and the molecular weight of a monomer unit. From the number average molecular weight of polymer in a given reactor, and assuming a Flory-Schulz distribution for a single site catalyst, the molecular weight distribution is determined for the polymer using the following relationships.

$$w ( n ) = n {τ}^{2} {e}^{- τ n} \qquad ( eq . 12 )$$

where n is the number of monomer units in a polymer chain, w(n) is the weight fraction of polymer chains having a chain length n, and t is calculated using the equation below:

$$τ = \frac{1}{{dp}_{n}} = \frac{{R}_{t}}{{R}_{p}} \qquad ( eq . 13 )$$

where dpₙ is the degree of polymerization, Rₚ is the rate of propagation and Rₜ is the rate of termination. The Flory-Schulz distribution can be transformed into the common log scaled gel permeation chromatography, GPC trace by applying:

$$\frac{dW}{dlog ( M )} = ln ( 10 ) \frac{{n}^{2}}{{dp}_{n} 2} {e}^{( - \frac{n}{{dp}_{n}} )} \qquad ( eq . 14 )$$

where

$$\frac{dW}{dlog ( M W )}$$

is the differential weight fraction of polymer with a chain length

$$n ( n = \frac{M W}{28}$$

where 28 is the molecular weight of the polymer segment corresponding to a C₂H₄ unit) and dpₙ is the degree of polymerization.

Assuming a Flory-Schultz model, different moments of molecular weight distribution can be calculated using the following:

$${μ}_{i} = {\int }_{0}^{∞} {n}^{i} W ( n ) dn \qquad ( eq . 15 )$$

$$thus , {μ}_{0} = 1 , {μ}_{1} = {dp}_{n} , and {μ}_{2} = 2 {dp}_{n}^{2} ; \text{so:}$$

$${M}_{n} = {Mw}_{mo nomer} \frac{{μ}_{1}}{{μ}_{0}} = {Mw}_{monomer} {dp}_{n} \\ {M}_{w} = {Mw}_{monomer} \frac{{μ}_{2}}{{μ}_{1}} = 2 {Mw}_{monomer} {dp}_{n} \qquad ( eq . 16 )$$

where Mwₘₒₙₒₘₑᵣ is the molecular weight of the polymer segment corresponding to a C₂H₄ unit of monomer. Finally, when a single site catalyst produces long chain branching, the molecular weight distribution is determined for the polymer using the following relationships (see “Polyolefins with Long Chain Branches Made with Single-Site Coordination Catalysts: A Review of Mathematical Modeling Techniques for Polymer Microstructure” by J. B. P Soares in Macromolecular Materials and Engineering, volume 289, Issue 1, Pages 70-87, Wiley-VCH, 2004 and “Polyolefin Reaction Engineering” by J. B. P Soares and T. F. L. McKenna Wiley-VCH, 2012).

$$w ( n ) = \frac{( 1 - α ) {τ}_{B} {e}^{- {τ}_{B} n}}{( 1 + α )} {I}_{1} ( 2 \frac{{τ}_{B} n \sqrt{α}}{1 + α} ) \qquad ( eq . 17 )$$

where n is the number of monomer units in a polymer chain, w(n) is the weight fraction of polymer chains having a chain length n, and τ_{B} and α are calculated using equations below:

$${τ}_{B} = \frac{1}{{dp}_{n}^{B}} = \frac{{R}_{t} + {R}_{LCB}}{{R}_{p}} \\ α = \frac{{R}_{LCB}}{{R}_{p}} \qquad ( eq . 18 )$$

where

$${dp}_{n}^{B}$$

is degree of porymenzauon, Rₚ is the rate propagation, Rₜ is the rate of termination and R_{LCB} is the rate of long chain branching formation calculated using equation below:

$${R}_{LCB} = {k}_{p 13} {ϕ}_{1} [ {m}_{3} ] \qquad ( eq . 19 )$$

where kₚ₁₃ is the propagation rate constant for adding monomer 3 (macromonomer which formed in the reactor) to a growing polymer chain ending with monomer 1, [m₃] is the molar concentration of macromonomer in the reactor. The weight distribution can be transformed into the common log scaled GPC trace by applying:

$$\frac{dW}{dlog ( M )} = ln ( 10 ) \frac{( 1 - α ) {τ}_{B} {e}^{- {τ}_{B} n}}{( 1 + α ) \sqrt{α}} {I}_{1} ( 2 \frac{{τ}_{B} n \sqrt{α}}{1 + α} ) \qquad ( eq . 20 )$$

where

$$\frac{dW}{dlog ( M W )}$$

is the differential weight fraction of polymer with a chain length

$$n ( n = \frac{M W}{28}$$

where 28 is the molecular weight of the polymer segment corresponding to a C₂H₄ unit). From the weight distribution, different moment of molecular weight distribution can be calculated using the following:

$${M}_{n} = {Mw}_{monomer} {dp}_{n}^{B} \frac{1 + α}{1 - α} \\ {M}_{w} = 2 {Mw}_{monomer} {dp}_{n}^{B} \frac{1 + α}{{( 1 - α )}^{2}} \qquad ( eq . 21 )$$

where

$${dp}_{n}^{B}$$

is a degree of polymerization, and α is calculated as explained.

Assuming that addition of monomer 2 (octene-1) unit to a chain ending in an octene terminal unit is insignificant, the number of octene after ethylene steps will be equivalent to the number of ethylene after octene steps. The branch content of the resultant polymer per thousand backbone carbon atoms (500 monomer units), BrF will be the ratio of the rate of addition of monomer 1 (ethylene) to the rate of the addition of monomer 2 (octene-1).

$$BrF = \frac{rate of addition of monomer 2 after monomer 1}{rate of addition of monomer 1 after monomer 1} \times 500 = \frac{[ {m}_{2} ] {k}_{p 12}}{[ {m}_{1} ] {k}_{p 11}} \times 500 \qquad ( eq . 22 )$$

where kₚ₁₂ is the propagation rate constant for adding monomer 2 (octene-1) to a growing polymer chain ending with monomer 1 (ethylene), kₚ₁₁ is the propagation rate constant for adding monomer 1 (ethylene) to a growing polymer chain ending with monomer 1, [m₁] is the molar concentration of monomer 1 in the reactor, and [m₂] is the molar concentration of monomer 2 in the reactor.

With reference to Table 2a, Example 1 contained 38.9 weight percent of a first ethylene polymer having a weight-average molecular weight M_{w} of 114.2 kg/mol, a commoner content of 0 SCB per 1000 carbons and a polydispersity index M_{w}/Mₙ of 2.00; 56.9 weight percent of a second ethylene interpolymer having a weight-average molecular weight M_{w} of 39.1 kg/mol, a number of short chain branches per thousand carbon atoms of 42, and a polydispersity index M_{w}/Mₙ of 2.06; and 4.2 weight percent of a third ethylene interpolymer having a weight-average molecular weight M_{w} of 25.6 kg/mol, a number of short chain branches per thousand carbon atoms of 47, and a polydispersity index M_{w}/Mₙ of 2.26.

Example 2 contained 41.5 weight percent of a first ethylene polymer having a weight-average molecular weight M_{w} of 110.2 kg/mol, a comonomer content of 0 SCB per 1000 carbons and a polydispersity index M_{w}/Mₙ of 2.00; 53.7 weight percent of a second ethylene interpolymer having a weight-average molecular weight M_{w} of 58.9 kg/mol, a number of short chain branches per thousand carbon atoms of 3, and a polydispersity index M_{w}/Mₙ of 2.04; and 4.8 weight percent of a third ethylene interpolymer having a weight-average molecular weight M_{w} of 43.2 kg/mol, a number of short chain branches per thousand carbon atoms of 32, and a polydispersity index M_{w}/Mₙ of 2.23.

Example 3 contained 39.4 weight percent of a first ethylene polymer having a weight-average molecular weight M_{w} of 142.9 kg/mol, comonomer content of 0 SCB per 1000 carbons and a polydispersity index M_{w}/Mₙ of 2.29; 53.6 weight percent of a second ethylene interpolymer having a weight-average molecular weight M_{w} of 50.3 kg/mol, a number of short chain branches per thousand carbon atoms of 36.3, and a polydispersity index M_{w}/Mₙ of 2.07; and 7.0 weight percent of a third ethylene interpolymer having a weight-average molecular weight M_{w} of 26.0 kg/mol, a number of short chain branches per thousand carbon atoms of 46, and a polydispersity index M_{w}/Mₙ of 2.18.

It is observable that, in Examples 1-3, the second ethylene interpolymer (R2 component) had a weight-average molecular weight which was less than that of the first ethylene polymer (R1 component). The ratio of the weight-average molecular weight of the first ethylene polymer and the weight-average molecular weight of the second ethylene interpolymer was about 2.67, 2.05 and 2.64 for Examples 1, 2 and 3, respectively.

As can be seen from the data in Table 2a, the first ethylene polymer made in the first reactor (R1), was a first ethylene homopolymer. This result was a direct consequence of a applying an OS^{R1} of 0% in Examples 1-3.

It is further noticeable that, in Examples 1-3, the second ethylene interpolymer had a weight-average molecular weight which was less than the weight-average molecular weight of the first ethylene polymer and greater than the weight-average molecular weight of the third ethylene interpolymer.

In Table 2b, R1, R2 and R3 components for simulated Examples S1, S2 and S3 are tabulated in which the octene-1 split ratios of R1 and R2 reactors in experimentally produced Examples 1, 2 and 3 were changed to OS^{R1}=5.0% and OS^{R2}=95.0%. All other polymerization process variables were kept constant between simulated Examples S1-S3 and their corresponding experimentally produced Examples 1-3. To be clear, for example, the R1, R2 and R3 components for the simulated Example S1 were simulated using the same polymerization process variables as those in Example 1 with the only difference being the octene-1 split ratios for the R1 and R2 reactors. As can be seen from the data in Table 2b, in Examples S1-S3, a first ethylene/octene-1 interpolymer was synthesized in the first reactor (R1), i.e., the first ethylene polymer had a comonomer content of from greater than (>) 0 SCB per 1000 carbons and less than and equal to (≤)6 SCB per 1000 carbons.

As shown in Table 3, Examples 1 and 2 contained undetectable levels of long-chain branching as characterized according to a LCBF of less than 0.001. Example 3, on the other hand, contained detectable levels of long-chain branching as characterized according to a LCBF of greater than or equal to 0.001. This latter structural feature of Example 3 relative to Examples 1 and 2 can be further examined by comparing their observed values for I₂₁/I₂, stress exponent, η₀, CY-a and G′ at G″=500 Pa.

As appreciated by those skilled in the art, in Examples 1 and 2, the bridged metallocene catalyst producing the second ethylene interpolymer in the second reactor (abbreviated as CpF in Table 1) would generate long-chain branched species. However, their contribution to the melt rheological measures discussed herein above would be fully masked by the presence of the LCB-free, higher molecular weight first polymer produced in R1 using the unbridged single site catalyst (abbreviated as PIC in Table 1).

TABLE 2a
Deconvolution of Ethylene Polymer Composition of
Examples 1-3 into a First Ethylene Polymer, a Second
Ethylene Interpolymer and a Third Ethylene Interpolymer
made in R1, R2, and R3, respectively.

| | | R1 | R2 | R3 |
|---|---|---|---|---|
| Example | Weight Percent (%) | 38.9 | 56.9 | 4.2 |
| 1 | Mₙ (g/mol) | 57,051 | 18,935 | 11,292 |
| | M_{w} (g/mol) | 114,163 | 39,141 | 25,552 |
| | Polydispersity | 2.00 | 2.06 | 2.26 |
| | (M_{w}/Mₙ) | | | |
| | SCB per 10³ carbons | 0 | 42 | 47 |
| Example | Weight Percent (%) | 41.5 | 53.7 | 4.8 |
| 2 | Mₙ (g/mol) | 55,058 | 28,775 | 19,360 |
| | M_{w} (g/mol) | 110,215 | 58,939 | 43,199 |
| | Polydispersity | 2.00 | 2.04 | 2.23 |
| | (M_{w}/Mₙ) | | | |
| | SCB per 10³ carbons | 0 | 33 | 32 |
| Example | Weight Percent (%) | 39.4 | 53.6 | 7.0 |
| 3 | Mₙ (g/mol) | 62,331 | 24,277 | 11,892 |
| | M_{w} (g/mol) | 142,864 | 50,330 | 25,989 |
| | Polydispersity | 2.29 | 2.07 | 2.18 |
| | (M_{w}/Mₙ) | | | |
| | SCB per 10³ carbons | 0 | 36 | 46 |

TABLE 2b
Deconvolution of Ethylene Polymer Composition of Simulated
Examples S1-S3 into a First Ethylene Polymer, a Second
Ethylene Interpolymer and a Third Ethylene Interpolymer
made in R1, R2, and R3, respectively.

| | | R1 | R2 | R3 |
|---|---|---|---|---|
| Example | Mₙ (g/mol) | 54,781 | 19,005 | 11,335 |
| S1 | M_{w} (g/mol) | 109,677 | 39,315 | 25,756 |
| | Polydispersity | 2.00 | 2.07 | 2.27 |
| | (M_{w}/Mₙ) | | | |
| | SCB per 10³ carbons | 1 | 42 | 46 |
| Example | Mₙ (g/mol) | 53,079 | 28,886 | 19,481 |
| S2 | M_{w} (g/mol) | 106,311 | 59,186 | 43,573 |
| | Polydispersity | 2.00 | 2.05 | 2.24 |
| | (M_{w}/Mₙ) | | | |
| | SCB per 10³ carbons | 1 | 33 | 31 |
| Example | Mₙ (g/mol) | 61,574 | 24,553 | 11,662 |
| S3 | M_{w} (g/mol) | 116,466 | 51,044 | 25,696 |
| | Polydispersity | 2.26 | 2.08 | 2.20 |
| | (M_{w}/Mₙ) | | | |
| | SCB per 10³ carbons | 6 | 35 | 46 |

TABLE 3
Physical, Molecular, Thermal and Melt Rheological
Characteristics of Examples 1-3.

| | Example 1 | Example 2 | Example 3 |
|---|---|---|---|
| Density | 0.9094 | 0.9072 | 0.9080 |
| Melt index I₂ (dg/min) | 3.73 | 3.09 | 3.77 |
| Melt index I₆ (dg/min) | 15.47 | 12.70 | 17.38 |
| Melt index I₂₁ (dg/min) | 107.01 | 84.50 | 124.78 |
| Melt flow ratio I₂₁/I₂ (—) | 28.73 | 27.35 | 33.10 |
| Stress exponent (—) | 1.30 | 1.29 | 1.39 |
| Comonomer content (mol %) | 5.0 | 5.2 | 5.2 |
| Comonomer content (wt. %) | 17.4 | 18.1 | 17.9 |
| Comonomer type | octene-1 | octene-1 | octene-1 |
| Number of SCBs per | 25.0 | 26.1 | 25.9 |
| 1000 carbons | | | |
| Mₙ (kg/mol) | 22.41 | 19.83 | 23.05 |
| M_{w} (kg/mol) | 78.87 | 71.15 | 73.52 |
| M_{z} (kg/mol) | 197.20 | 150.54 | 170.03 |
| M_{w}/Mₙ (—) | 3.52 | 3.59 | 3.19 |
| Conventional GPC MWD | Unimodal | Unimodal | Unimodal |
| Zero-shear viscosity (kPa · s) | 2.79 | 3.60 | 5.40 |
| CY-a | 0.4769 | 0.4415 | 0.2909 |
| τ (ms) | 9.55 | 9.83 | 10.06 |
| G′ at G″ = 500 Pa (Pa) | 31.90 | 35.21 | 74.79 |
| Melt strength (cN) | not tested | 1.40 | 1.51 |
| Stretch ratio (—) | not tested | 1637.8 | 1115.1 |
| LCBF (—) | 4.19 × 10⁻⁴ | 1.68 × 10⁻⁵ | 8.06 × 10⁻³ |
| Low-temperature melting | 76.9 | 75.1 | 78.0 |
| peak, Tₘ^{low} (° C.) | | | |
| High-temperature melting | 129.5 | 128.8 | 125.3 |
| peak, Tₘ^{high} (° C.) | | | |
| GPC-FTIR slope | −31.9 | −31.0 | −28.3 |
| (SCB per 1000 carbons) | | | |
| VICAT Softening | 64.0 | 69.0 | 69.0 |
| Temperature (° C.) | | | |

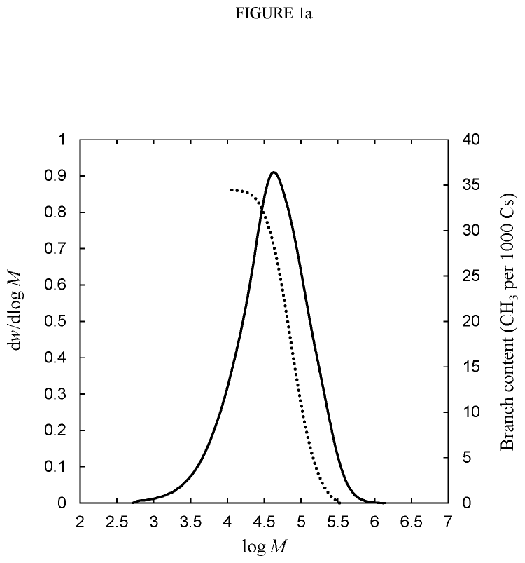

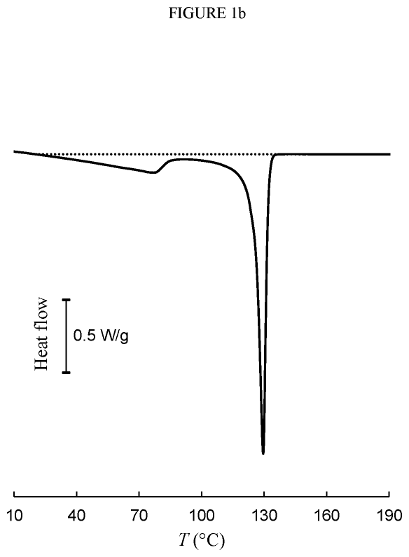

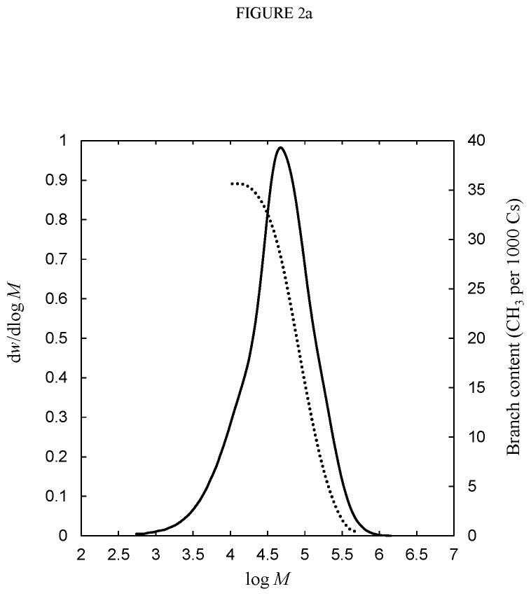

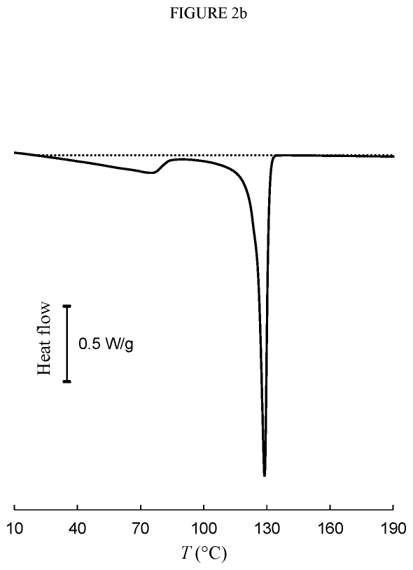

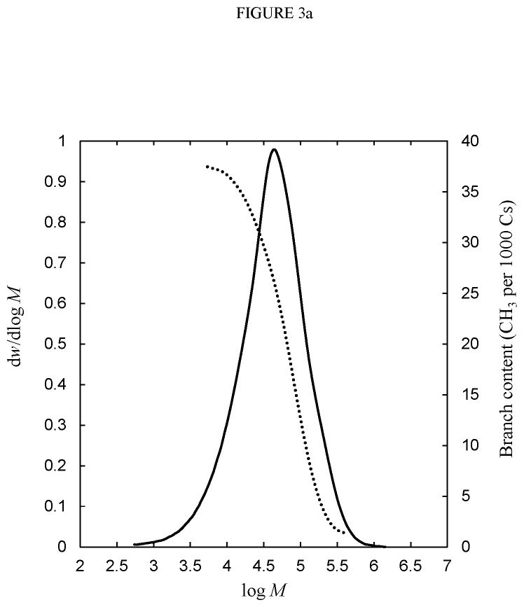

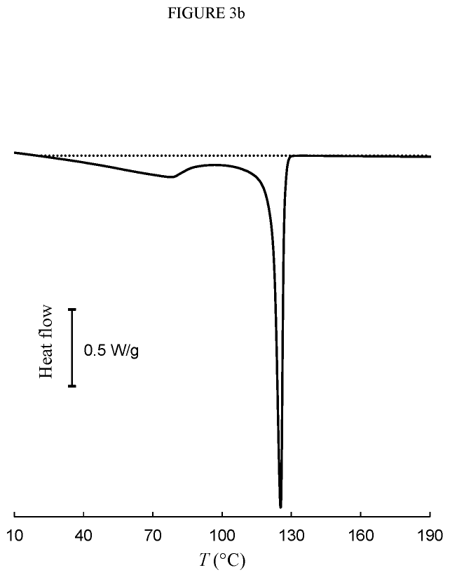

With reference to the GPC-FTIR profiles shown in FIGS. 1a, 2a and 3a, it can be understood that the ethylene polymer compositions prepared in Examples 1-3 had a normal comonomer distribution where the low-MW species contained a short chain branch frequency of greater than about 30 short chain branches per 1000 carbon atoms at MWs less than about 30 kg/mol and the high-MW species had a short chain branch frequency approaching small (nearly zero) SCB contents at MWs greater than about 300 kg/mol. To be specific, the GPC-FTIR comonomer distribution of Example 1 had a slope of −31.9 SCB per 1000 carbons, the GPC-FTIR comonomer distribution of Example 2 had a slope of −31.0 SCB per 1000 carbons, and the GPC-FTIR comonomer distribution of Example 3 had a slope of −28.3 SCB per 1000 carbons.

Based on the DSC second heating thermograms shown in FIGS. 1b, 2b and 3b, and the low-/high-temperature melting peaks tabulated in Table 3, it is recognizable that Examples 1-3 included two distinct melting peaks; a low-temperature melting peak at about 75-78° C. and a high-temperature melting peak at about 125-130° C. In all Examples, the heat flow signal, at a temperature range of from about 85° C. to about 100° C., nearly returned to an imaginary baseline drawn between 20° C. and the end of melting. In the Examples shown in FIGS. 1b, 2b and 3b, the maximum distance between the second heating heat flow curves and the imaginary baseline, at a temperature range of from about 85° C. to about 100° C., was less than 0.07 W/g.

### Peelable, Easy-Opening Film Structures

Examples 1F through 3F were all polyethylene film structures prepared from the ethylene polymer compositions disclosed in Examples 1 through 3 on a three-layer coextrusion film blowing line manufactured by Brampton Engineering at a blow-up ratio of 2.5, a total film thickness of 2.85 mil, a frost line height of 18.0 inch, an output rate of 100.0 pounds per hour and a die gap of 35 mil. Examples 1F-3F had an A/B/C structure with a layer thickness ratio of 20/40/40 and were produced at a melt temperature of 409-413° F., 417-418° F. and 431-432° F. for layers A, B and C, respectively. The sealant layer (the skin layer herein identified as layer A) in film Examples 1F, 2F and 3F was prepared from the ethylene polymer composition disclosed in Examples 1, 2 and 3, respectively. The sealant layer in these film Examples further contained 2.0% (by weight) of a fluoroelastomer type process aid masterbatch commercially available from Ingenia Polymers under the commercial name Ingenia 1150. Ingenia 1150 masterbatch contains 5% (by weight) of 3M DYNAMAR® FX 5920A in an LLDPE carrier resin having a melt index I₂ of 1.0 and a density of 0.920 g/cm³. The skin layer C contained 98% (by weight) of an HDPE homopolymer commercially available from NOVA Chemicals Corporation under the commercial name SCLAIR® 19A and 2.0% (by weight) of Ingenia 1150. SCLAIR 19A is an HDPE homopolymer commercially available from NOVA Chemicals Corporation and has a melt index I₂ of 0.72 dg/min and a density of 0.962 g/cm³. The core layer B was prepared from 100% (by weight) of an HDPE homopolymer commercially available from NOVA Chemicals under the commercial name SURPASS® HPs167-AB. SURPASS HPs167-AB has a nominal melt index I₂ of 1.2 dg/min and a nominal density of 0.967 g/cm³.

The film structure in Example 1FB was an A/B/C multilayer film prepared under identical conditions to those used for the Examples 1F-3F, except that the sealant layer A was prepared from a blend which contained 78% (by weight) of the ethylene polymer composition produced in Example 1, 20% (by weight) of a SCLAIR FP120-C and 2% (by weight) of Ingenia 1150. SCLAIR FP120-C is an ethylene/octene-1 LLDPE copolymer commercially available from NOVA Chemicals Corporation and has a nominal melt index I₂ of 1.0 and a nominal density of 0.920 g/cm³.

The film structure in Example 2FB was an A/B/C multilayer film prepared under identical conditions to those used for the Examples 1F-3F, except that the sealant layer A was prepared from a blend which contained 49% (by weight) of the ethylene polymer composition produced in Example 1, 49% (by weight) of the ethylene polymer composition produced in Example 2 and 2% (by weight) of Ingenia 1150.

The film structure in Comparative Example 1F was an A/B/C multilayer film prepared under identical conditions to those used for the Examples 1F-3F, except that the sealant layer A was prepared from a blend which contained 77% (by weight) of ELVAX® 3165, 20% (by weight) of TOPPYL® PB 8640M and 3% (by weight) Ingenia 1150. ELVAX 3165 is an ethylene vinyl acetate (EVA) copolymer commercially available from Dow Chemical Company which contains 18% by weight of vinyl acetate comonomer and has a nominal melt index I₂ of 0.7 dg/min and a nominal density of 0.94 g/cm³. TOPPYL PB 8640M is a random copolymer of butene-1 with low ethylene content commercially available from LyondellBasell Industries. TOPPYL PB 8640M has a nominal melt index I₂ of 1.0 dg/min and a nominal density of 0.906 g/cm³.

Comparative Example 3F was an A/B/C multilayer film prepared under identical conditions to those used for the Examples 1F-3F, except that the sealant layer A was prepared from a blend contained 70% (by weight) of NOVAPOL® HB-L354-A, 28% (by weight) of QUEO® 8230 and 2% (by weight) of Ingenia 1150. NOVAPOL HB-L354-A is a high density polyethylene (HDPE) commercially available from NOVA Chemicals Corporation which is an ethylene/hexene-1 copolymer and has a nominal melt index I₂ of 0.3 dg/min and a nominal density of 0.955 g/cm³. QUEO 8230 is an ethylene based octene-1 plastomer produced in a solution process using a metallocene catalyst and has a nominal melt index I₂ of 30 dg/min and a nominal density of 0.883 g/cm³. The film blowing process conditions in the case of Comparative Example 3F were further different from those applied in Examples 1F-3F, in that the Comparative Example 3F was produced at a total film thickness of 2.79 mil at a melt temperature of 406° F., 417° F. and 433° F. for layers A, B and C, respectively.

Comparative Example 4F was an A/B/C multilayer film prepared under identical conditions to those used for the Examples 1F-3F, except that the sealant layer A was prepared from a blend contained 70% (by weight) of QUEO 8230, 28% (by weight) of NOVAPOL HB-L354-A and 2% (by weight) of Ingenia 1150. The film blowing process conditions in the case of Comparative Example 4F were further different from those applied in Examples 1F-3F, in that the Comparative Example 4F was produced at a total film thickness of 2.79 mil at a melt temperature of 415° F., 416° F. and 432° F. for layers A, B and C, respectively.

Comparative Example 5F was an A/B/C multilayer film prepared under identical conditions to those used for the Examples 1F-3F, except that the sealant layer A was prepared from a blend contained 70% (by weight) of NOVAPOL HB-W952-A, 28% (by weight) of QUEO 8230 and 2% (by weight) of Ingenia 1150. NOVAPOL HB-W952-A is a high density polyethylene (HDPE) commercially available from NOVA Chemicals Corporation which is an ethylene/hexene-1 copolymer and has a nominal melt index I₂ of 0.08 dg/min and a nominal density of 0.952 g/cm³. The film blowing process conditions in the case of Comparative Example 5F were further different from those applied in Examples 1F-3F, in that the Comparative Example 5F was produced at a total film thickness of 2.70 mil at a melt temperature of 421° F., 417° F. and 432° F. for layers A, B and C, respectively.

Comparative Example 6F was an A/B/C multilayer film prepared under identical conditions to those used for the Examples 1F-3F, except that the sealant layer A was prepared from a blend contained 70% (by weight) of QUEO 8230, 28% (by weight) of NOVAPOL HB-W952-A and 2% (by weight) of Ingenia 1150. The film blowing process conditions in the case of Comparative Example 6F were further different from those applied in Examples 1F-3F, in that the Comparative Example 6F was produced at a total film thickness of 2.77 mil at a melt temperature of 407° F., 419° F. and 432° F. for layers A, B and C, respectively.

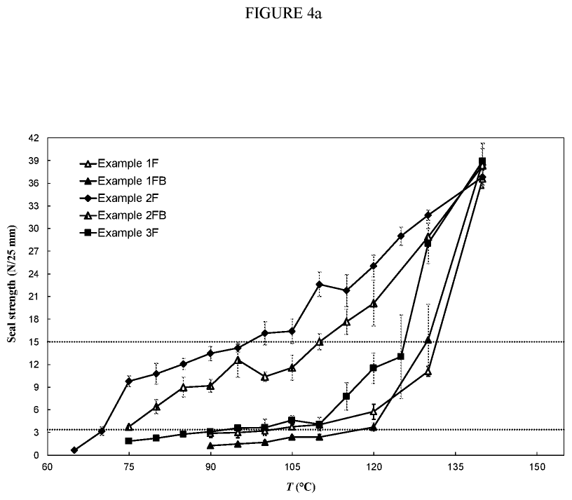

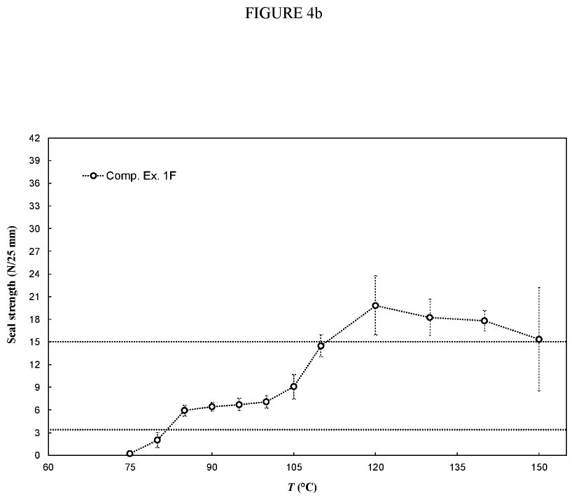

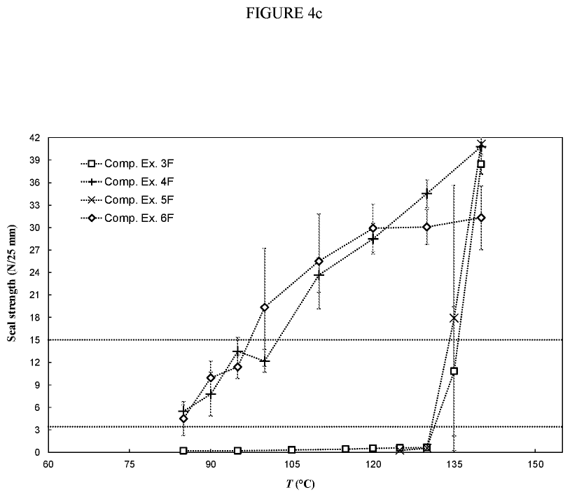

FIGS. 4a through 4c depicts the seal strength profiles as a function of sealing temperature for film structures prepared in Examples 1F-3F and 1FB-2FB, and Comparative Examples 1F and 3F-6F. Those skilled in the art would recognize that, from a design for performance perspective, the all polyethylene film structures prepared in Examples 1F-3F and 2FB provided peelable seals exhibiting a constant (or nearly constant) seal strength values within a seal strength range desired for easy-opening applications (e.g., a seal strength of from about 3.4 N/25 mm to about 15 N/25 mm) over a broad sealing temperature window. To be clear, Example 1F had a SIT of 101.8° C. and had a seal strength of from about 3.4 N/25 mm to about 15 N/25 mm over a temperature range of from SIT to SIT+29.8° C. Example 2F had a SIT of 70.2° C. and had a seal strength of from about 3.4 N/25 mm to about 15 N/25 mm over a temperature range of from SIT to SIT+26.9° C. Example 3F had a SIT of 92.9° C. and had a seal strength of from about 3.4 N/25 mm to about 15 N/25 mm over a temperature range of from SIT to SIT+32.7° C. Example 2FB had a SIT of ~75° C. and had a seal strength of from about 3.4 N/25 mm to about 15 N/25 mm over a temperature range of from SIT to ~SIT+35.0° C. Example 1FB further showed that addition of 20% (by weight) of an LLDPE component did not have a pronounced effect on the observed seal strength-sealing temperature behavior. Comparative Example 1F had a SIT of 81.8° C. and had a seal strength of from about 3.4 N/25 mm to about 15 N/25 mm over a temperature range of from SIT to SIT+29.2° C. In the above described sealing temperature windows, the sealing temperatures corresponding to a seal strength of 3.4 N and/or 15 N were estimated by a linear interpolation routine if they were not part of the experimentally determined data points.

Importantly, the breadth of the sealing temperature window which corresponded to a seal strength of from about 3.4 to about 15 N/25 mm (depicted by the dotted lines in FIGS. 4a-4c) in Examples 1F-3F and 2FB was comparable to or broader than that of the Comparative Example 1F which contained non-polyethylene materials. This latter observation is of particular importance for applications where easy-opening, mono-material packaging systems are desired.

With reference to FIG. 4c, it is noticeable that the above-described advantageous properties are not achievable in the case of film structures prepared in Comparative Examples 3F-6F which, in their sealant layer, contained physical post-reactor blends of a high molecular weight, comonomer-lean blend component (i.e., a low melt index, high density blend component) and a low molecular weight, comonomer-rich blend component (i.e., a high melt index, plastomeric blend component).

Reactor Blend Ethylene Polymer Compositions with Improved VICAT

The reactor blend ethylene polymer compositions in Examples 4-6 were each made in the identical pilot-scale in-series multi-reactor solution polymerization process utilized for Examples 1-3, with adjustment made to the process conditions to achieve reactor blend ethylene polymer compositions having a higher target density than the reactor blend ethylene polymer compositions in Examples 1-3. Table 4 shows the reactor conditions used to make each of the ethylene polymer compositions in Examples 4-6.

TABLE 4
Continuous Solution Polymerization Process
Parameters for Examples 4-6.

| | Ex. 4 | Ex. 5 | Ex. 6 |
|---|---|---|---|
| R1 catalyst (ppm) | 0.24 | 0.26 | 0.24 |
| R1 catalyst | CpF^{†} | CpF^{†} | CpF^{†} |
| R1 ([M]/[A]) mole ratio | 50 | 50 | 50 |
| R1 ([P]/[M]) mole ratio | 0.48 | 0.40 | 0.44 |
| R1 ([B]/[A]) mole ratio | 1.30 | 1.30 | 1.30 |
| R1 catalyst diluent temperature (° C.) | 34.9 | 30.0 | 30.0 |
| R2 catalyst (ppm) | 0.30 | 0.36 | 0.28 |
| R2 catalyst | CpF^{†} | CpF^{†} | CpF^{†} |
| R2 ([M]/[A]) mole ratio | 50 | 52 | 50 |
| R2 ([P]/[M]) mole ratio | 0.40 | 0.40 | 0.40 |
| R2 ([B]/[A]) mole ratio | 1.30 | 1.36 | 1.30 |
| R2 catalyst diluent temperature (° C.) | 33.9 | 30.6 | 31.6 |
| ES^{R1} (%) | 40.0 | 45.0 | 37.0 |
| ES^{R2} (%) | 60.0 | 55.0 | 63.0 |
| R1 ethylene concentration (wt %) | 14.2 | 13.1 | 13.7 |
| R2 ethylene concentration (wt %) | 17.0 | 17.3 | 16.5 |
| Octene-1 to ethylene ratio R1 (wt. fraction) | 0 | 0 | 0 |
| Octene-1 to ethylene ratio R2 (wt. fraction) | 0.589 | 0.728 | 0.623 |
| Octene-1 to ethylene ratio | 0.325 | 0.367 | 0.354 |
| (wt. fraction, total) | | | |
| Polymer Production Rate (kg/h) | 62.7 | 68.2 | 69.2 |
| R1 total solution rate (kg/h) | 220.0 | 272.9 | 228.2 |
| R2 total solution rate (kg/h) | 280.0 | 277.0 | 321.7 |
| Total solution rate (kg/h) | 500.0 | 550.0 | 550.0 |
| OS^{R1} (%) | 0.0 | 0.0 | 0.0 |
| OS^{R2} (%) | 100.0 | 100.0 | 100.0 |
| H₂ Concentration in R1 (ppm) | 8.59 | 8.18 | 7.50 |
| H₂ Concentration in R2 (ppm) | 7.00 | 4.01 | 9.00 |
| R1 Fresh feed temperature (° C.) | 40.0 | 39.9 | 40.0 |
| R2 Fresh feed temperature (° C.) | 45.0 | 45.0 | 45.0 |
| R1 Mean temp (° C.) | 165.2 | 164.8 | 165.2 |
| R2 Mean temp (C) | 178.9 | 178.9 | 179.1 |
| R3 Outlet temperature (° C.) | 188.8 | 188.2 | 189.9 |
| R3 volume (L) | 18 | 18 | 18 |
| Q^{R1} (%) | 91.0 | 91.0 | 91.0 |
| Q^{R2} (%) | 74.0 | 73.6 | 74.0 |
| Q^{R3} (%) | 56.7 | 58.2 | 58.8 |
| Q^{T} (%) | 92.8 | 93.4 | 92.9 |
| R1 Agitator speed (rpm) | 875.0 | 875.0 | 800.0 |
| R2 Agitator speed (rpm) | 260.0 | 270.9 | 260.0 |

^{†}(2,7-tBu₂Flu)Ph₂C(Cp)HfMe₂.

In Examples 4-6, the following bridged metallocene catalyst components were used to prepare the first ethylene polymer in the first CSTR reactor (R1) and to prepare the second ethylene interpolymer in the second CSTR reactor (R2): component A, diphenylmethylene(cyclopentadienyl)(2,7-di-t-butylfuorenyl)hafnium dimethide [(2,7-tBu₂Flu)Ph₂C(Cp)HfMe₂]; component M, methylaluminoxane (MMAO-07); component B, trityl tetrakis(pentafluoro-phenyl)borate (trityl borate); and component P, 2,6-di-tert-butyl-4-ethylphenol (BHEB). Methylaluminoxane (MMAO-07); and 2,6-di-tert-butyl-4-ethylphenol are premixed in-line and then combined with diphenylmethylene(cyclopentadienyl)(2,7-di-t-butylfuorenyl)hafnium dimethide and trityl tetrakis(pentafluoro-phenyl)borate just before entering the polymerization reactors (R1 and R2). The following catalyst component solvents were used: methylpentane for components M and P; and xylene for component A and B. The efficiency of the bridged metallocene catalyst formulation was optimized by adjusting the quantity of component A added to R1 and R2 [R1 catalyst (ppm) and R2 catalyst (ppm) as recited in Table 4], the mole ratios of the catalyst components—i.e., [M]/[A], [P]/[M] and [B]/[A] as tabulated in Table 4—and the R1 and R2 catalyst inlet temperatures.

Based on the reactor model simulation scheme, disclosed herein above, using the input conditions which were employed for actual pilot scale run conditions, Examples 4-6 contained from 30 to 70 weight percent of a first ethylene polymer produced in R1, and from 30 to 70 weight percent of a second ethylene interpolymer produced in R2. In Examples 4-6, the first ethylene polymer contained zero short chain branches per thousand carbon atoms—i.e., the first ethylene polymer was an ethylene homopolymer. The first ethylene polymer in Example 4-6 had a weight-average molecular weight, M_{w}, of about 100 kg/mol and a M_{w}/Mₙ of about 2.0. In examples 4-6, the second ethylene interpolymer contained 26-30 short chain branches per thousand carbon atoms. The second ethylene interpolymer in Example 4-6 had a weight-average molecular weight, M_{w}, of about 50 kg/mol and a M_{w}/Mₙ of about 2.1.

As shown in Table 5, Examples 4-6 contained detectable levels of long-chain branching as characterized according to a LCBF of greater than or equal to 0.001.

TABLE 5
Physical, Molecular, Thermal and Melt Rheological
Characteristics of Examples 4-6.

| | Example 4 | Example 5 | Example 6 |
|---|---|---|---|
| Density | 0.9182 | 0.9167 | 0.9163 |
| Melt index I₂ (dg/min) | 3.58 | 3.68 | 3.41 |
| Melt index I₆ (dg/min) | 15.4 | 15.94 | 14.85 |
| Melt index I₂₁ (dg/min) | 93.6 | 98.67 | 91.17 |
| Melt flow ratio I₂₁/I₂ (—) | 26.18 | 26.78 | 26.74 |
| Stress exponent (—) | 1.33 | 1.33 | 1.34 |
| Comonomer content (mol %) | 3.6 | 3.9 | 3.8 |
| Comonomer content (wt. %) | 13.1 | 14.0 | 13.6 |
| Comonomer type | octene-1 | octene-1 | octene-1 |
| Number of SCBs per | 18.1 | 19.6 | 19.0 |
| 1000 carbons | | | |
| Mₙ (kg/mol) | 28.17 | 27.22 | 28.70 |
| M_{w} (kg/mol) | 69.03 | 79.09 | 69.80 |
| M_{z} (kg/mol) | 127.49 | 152.44 | 135.26 |
| M_{w}/Mₙ (—) | 2.45 | 2.91 | 2.43 |
| Conventional GPC MWD | Unimodal | Unimodal | Unimodal |
| Zero-shear viscosity (kPa · s) | 3.92 | 3.71 | 3.97 |
| CY-a | 0.3524 | 0.3543 | 0.3485 |
| τ (ms) | 7.80 | 7.68 | 7.80 |
| G′ at G″ = 500 Pa (Pa) | 45.33 | 46.01 | 46.52 |
| Melt strength (cN) | 1.43 | 1.37 | 1.46 |
| Stretch ratio (—) | 1182.0 | 1251.1 | 1210.0 |
| LCBF (—) | 1.07 × 10⁻² | 5.41 × 10⁻³ | 6.67 × 10⁻³ |
| Low-temperature melting | 92.5 | 87.2 | 91.61 |
| peak, Tₘ^{low} (° C.) | | | |
| High-temperature melting | 125.7 | 126.3 | 125.36 |
| peak, Tₘ^{high} (° C.) | | | |
| GPC-FTIR slope | −16.2 | −15.1 | −15.4 |
| (SCB per 1000 carbons) | | | |
| VICAT Softening | 89.2 | 85.1 | 88.2 |
| Temperature (° C.) | | | |

With refence to Tables 3 and 5, Examples 4-6 advantageously had increased VICAT softening temperatures relative to Examples 1-3. It will be appreciated by those skilled in the art that the manufacturing process of ethylene polymer compositions having an improved VICAT softening temperature involves lower propensity for pellets clustering in the finishing area of the polymerization plant, and during storage and shipping.

With refence to Tables 3 and 5, GPC-FTIR comonomer distribution of the Examples 4, 5 and 6 had a slope of greater than-22 SCB per 1000 carbons; namely: −16.2, −15.1 and −15.4 SCB per 1000 carbons, respectively.

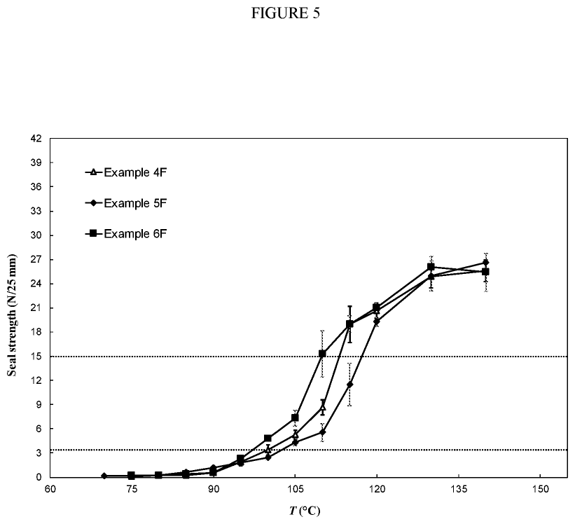

FIG. 5 depicts the seal strength profiles as a function of sealing temperature for all polyethylene film structures 4F through 6F prepared from the reactor blend ethylene polymer compositions disclosed in Examples 4 through 6.

Films produced in Examples 4F through 6F were three-layer coextrusion film blowing line manufactured by Brampton Engineering at a blow-up ratio of 3.0, a total film thickness of 1.54 mil, a frost line height of 20.0 inch, an output rate of 100.0 pounds per hour and a die gap of 35 mil. Examples 4F-6F had an A/B/C structure with a layer thickness ratio of 13.5/65/21.5 and were produced at a melt temperature of 404-407° F., 424-425° F. and 415-417° F. for layers A, B and C, respectively. The sealant layer (the skin layer herein identified as layer A) in film Examples 4F, 5F and 6F was prepared from the ethylene polymer composition disclosed in Examples 4, 5 and 6, respectively. The sealant layer in these film Examples further contained 2.0% (by weight) of a fluoroelastomer type process aid masterbatch commercially available from Ingenia Polymers under the commercial name Ingenia 1150. Ingenia 1150 masterbatch contains 5% (by weight) of 3M DYNAMAR FX 5920A in an LLDPE carrier resin having a melt index I₂ of 1.0 and a density of 0.920 g/cm³. The skin layer C contained 98% (by weight) of an HDPE homopolymer commercially available from NOVA Chemicals Corporation under the commercial name SCALIR 19A and 2.0% (by weight) of Ingenia 1150. SCLAIR 19A is an HDPE homopolymer commercially available from NOVA Chemicals Corporation and has a melt index I₂ of 0.72 dg/min and a density of 0.962 g/cm³.

In Examples 4 and 5, the core layer B was prepared from 78% (by weight) of an HDPE homopolymer commercially available from NOVA Chemicals under the commercial name SURPASS® HPs167-AB blended with 22% (by weight) of SCLAIR 19A. SURPASS HPs167-AB has a nominal melt index I₂ of 1.2 dg/min and a nominal density of 0.967 g/cm³. In Example 6, the core layer B was prepared from 100% (by weight) of SURPASS HPs167-AB.

With refence to FIG. 5, it is observable that, relative to the film structures of Examples 1F-3F and 2FB, film structures prepared in Examples 4F-6F had a narrower sealing temperature window which corresponded to a seal strength of from about 3.4 to about 15 N/25 mm. Without wishing to be limited by any specific theory, this latter observation may be interpreted as a consequence of the reduction in the intensity of the gradient in the GPC-FTIR comonomer distribution observed in Examples 4-6 compared to Examples 1-3.

### INDUSTRIAL APPLICABILITY

The reactor blend ethylene polymer compositions disclosed herein have industrial applicability in a wide range flexible manufactured articles; non-limiting examples include monolayer or multilayer films.

1. A reactor blend ethylene polymer composition, comprising:
from 30 to 70 weight percent of a first ethylene polymer, the first ethylene polymer comprising ethylene and optionally at least one α-olefin, the first ethylene polymer having a weight-average molecular weight M_{w} of from 70 kg/mol to 250 kg/mol, a number of short chain branches per thousand carbon atoms of from 0 to 6, and a polydispersity index M_{w}/Mₙ of from 1.7 to 2.3; and
from 30 to 70 weight percent of a second ethylene interpolymer, the second ethylene interpolymer comprising ethylene and at least one α-olefin, the second ethylene interpolymer having a weight-average molecular weight M_{w} of from 20 kg/mol to 75 kg/mol, a number of short chain branches per thousand carbon atoms of from to 55, and a polydispersity index M_{w}/Mₙ of from 1.7 to 2.3;
wherein the weight-average molecular weight of the second ethylene interpolymer is less than the weight-average molecular weight of the first ethylene polymer; and
wherein the ethylene polymer composition is produced in a continuous solution polymerization process, the continuous solution polymerization process comprising:
forming the first ethylene polymer in a first solution polymerization reactor by polymerizing ethylene and optionally at least one α-olefin with a first homogenous catalyst formulation; and
forming the second ethylene interpolymer in a second solution polymerization reactor by polymerizing ethylene and at least one α-olefin with a second homogeneous catalyst formulation.

2. The ethylene polymer composition of claim 1, wherein the ethylene polymer composition has a comonomer distribution profile in a GPC-FTIR analysis, wherein the comonomer distribution profile has a secant slope of greater than or equal to −55 short chain branches per 1000 carbons and less than or equal to −20 short chain branches per 1000 carbons, wherein the secant slope is defined as the number of short chain branches per 1000 carbons at a molecular weight of 300 kg/mol minus the number of short chain branches per 1000 carbons at a molecular weight of 30 kg/mol.

3. The ethylene polymer composition of claim 2, wherein the comonomer distribution profile is a normal comonomer distribution profile.

4. The ethylene polymer composition of claim 1, wherein one or both of the first homogenous catalyst formulation and the second homogenous catalyst formulation comprises a bridged metallocene catalyst having the Formula (I): 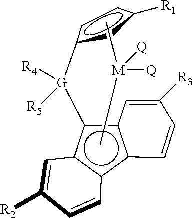
wherein M is a group 4 metal selected from titanium, zirconium or hafnium; G is a group 14 element selected from carbon, silicon, germanium, tin or lead; R₁ is a hydrogen atom, a C₁₋₂₀ hydrocarbyl radical, a C₁₋₂₀ alkoxy radical or a C₆₋₁₀ aryl oxide radical; R₂ and R₃ are independently selected from a hydrogen atom, a C₁₋₂₀ hydrocarbyl radical, a C₁₋₂₀ alkoxy radical or a C₆₋₁₀ aryl oxide radical; R₄ and R₅ are independently selected from a hydrogen atom, an unsubstituted C₁₋₂₀ hydrocarbyl radical, a substituted C₁₋₂₀ hydrocarbyl radical, a C₁₋₂₀ alkoxy radical or a C₆₋₁₀ aryl oxide radical; and Q is independently an activatable leaving group ligand.

5. The ethylene polymer composition of claim 1, wherein one or both of the first homogenous catalyst and the second homogenous catalyst comprises a phosphinimine catalyst.

6. The ethylene polymer composition of claim 1, wherein the first ethylene polymer is a first ethylene homopolymer.

7. The ethylene polymer composition of claim 1, wherein the ethylene polymer composition has a density of from 0.880 g/cm³ to 0.920 g/cm³, as determined according to ASTM D792-13.

8. (canceled)

9. The ethylene polymer composition of claim 1, wherein the ethylene polymer composition has a melt index I₂ of from 2 dg/min to 10 dg/min, as determined according to ASTM D1238-13 at 190° C. using a weight of 2.16 kg.

10. The ethylene polymer composition of claim 1, wherein the ethylene polymer composition has a molecular weight distribution with a polydispersity index M_{w}/Mₙ of from 2.3 to 6.0.

11-12. (canceled)

13. The ethylene polymer composition of claim 1, wherein a ratio of the weight-average molecular weight of the first ethylene polymer and the weight-average molecular weight of the second ethylene interpolymer is greater than or equal to 1.5 and less than or equal to 6.

14. (canceled)

15. The ethylene polymer composition of claim 1, wherein the ethylene polymer composition contains detectable levels of long-chain branches as characterized according to a long chain branching factor, LCBF, of greater than or equal to 0.001.

16. The ethylene polymer composition of claim 1, wherein the second ethylene interpolymer is present in the ethylene polymer composition in an amount of from 50 to 65 weight percent, and wherein the first ethylene polymer is present in the ethylene polymer composition in an amount of from 35 to 50 weight percent.

17. (canceled)

18. The ethylene polymer composition of claim 1, wherein the ethylene polymer composition has a number-average molecular weight Mₙ of from 10 kg/mol to 35 kg/mol.

19. (canceled)

20. The ethylene polymer composition of claim 1, wherein the ethylene polymer composition has a weight-average molecular weight M_{w} of from 65 kg/mol to 100 kg/mol.

21-27. (canceled)

28. The ethylene polymer composition of claim 1, wherein the ethylene polymer composition has a melt flow ratio 121/12 of from 15 to 40, as determined according to ASTM D1238-13 at 190° C. using weights of 2.16 kg and 21.6 kg.

29. The ethylene polymer composition of claim 1, wherein the ethylene polymer composition further comprises from greater than 0 to 20 weight percent of a third ethylene interpolymer comprising ethylene and at least one α-olefin, the third ethylene interpolymer having a polydispersity index M_{w}/Mₙ of from 1.7 to 2.3 and a weight-average molecular weight less than the weight-average molecular weight of the first ethylene polymer and the weight-average molecular weight of the second ethylene interpolymer.

30. The ethylene polymer composition of claim 29, wherein the third ethylene interpolymer has a weight-average molecular weight of from 20 kg/mol to 50 kg/mol and a number of short chain branches per 1000 carbon atoms of from 25 to 50.

31. The ethylene polymer composition of claim 29, wherein the continuous solution polymerization process further comprises a step of forming the third ethylene interpolymer in a third solution polymerization reactor by polymerizing ethylene and at least one α-olefin with a third homogenous catalyst formulation, wherein the first, second and third solution phase polymerization reactors are configured in series with one another.

32. The ethylene polymer composition of claim 31, wherein the third homogeneous catalyst formulation comprises a bridged metallocene catalyst having the Formula (I): 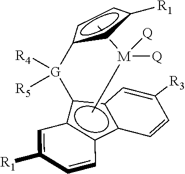
wherein M is a group 4 metal selected from titanium, zirconium or hafnium; G is a group 14 element selected from carbon, silicon, germanium, tin or lead; R₁ is a hydrogen atom, a C₁₋₂₀ hydrocarbyl radical, a C₁₋₂₀ alkoxy radical or a C₆₋₁₀ aryl oxide radical; R₂ and R₃ are independently selected from a hydrogen atom, a C₁₋₂₀ hydrocarbyl radical, a C₁₋₂₀ alkoxy radical or a C₆₋₁₀ aryl oxide radical; R₄ and R₅ are independently selected from a hydrogen atom, an unsubstituted C₁₋₂₀ hydrocarbyl radical, a substituted C₁₋₂₀ hydrocarbyl radical, a C₁₋₂₀ alkoxy radical or a C₆₋₁₀ aryl oxide radical; and Q is independently an activatable leaving group ligand.

33. The ethylene polymer composition of claim 31, wherein the third homogeneous catalyst comprises a phosphinimine catalyst.

34. The ethylene polymer composition of claim 1, wherein the at least one α-olefin is selected from the group consisting of C₃ to C₁₀ α-olefins.

35. The ethylene polymer composition of claim 1, wherein the at least one α-olefin is selected from the group consisting of hexene-1, octene-1, and a mixture of hexene-1 and octene-1.

36. The ethylene polymer composition of claim 1, wherein the at least one α-olefin is octene-1.

37. An all polyethylene film layer comprising the ethylene polymer composition of claim 1.

38-41. (canceled)

42. An all polyethylene multilayer film structure, wherein the film structure has at least one skin layer comprising the ethylene polymer composition of claim 1.

43. The film structure of claim 42, wherein the film structure has a sublayer adjacent to the at least one skin layer; the sublayer comprising a high density polyethylene HDPE having a density of at least 0.945 g/cm³ and a melt index I₂ of from 0.1 to 10 dg/min.

44-49. (canceled)

50. The film structure of claim 42, wherein the film structure comprises between three and nine layers.

51. The film structure of claim 42, wherein the at least one skin layer is a sealant layer.

52. The film structure of claim 51, wherein the film structure has a seal initiation temperature (SIT) of from greater than or equal to 70° C. to 115° C., wherein the seal initiation temperature is the minimum sealing temperature at which the film structure has a seal strength of greater than 3.4 N per 25.4 mm of seal width.

53. The film structure of claim 52, wherein the film structure has a seal strength of from 3.4 to 15.0 N per 25.4 mm of seal width at a sealing temperature of from SIT to SIT +40° C.

54. (canceled)
